(19) United States
(12) Patent Application Publication
(10) Pub. No.: US 2026/0208187 A1
(43) Pub. Date: Jul. 23, 2026

(54) OPTICAL GENOME MAPPING CARTRIDGES

(71) Applicant: Bionano Genomics, Inc., San Diego, CA (US)

(72) Inventor: Gerson Aguirre, San Diego, CA (US)

(21) Appl. No.: 19/142,868

(22) PCT Filed: Dec. 26, 2023
(86) PCT No.: PCT/US2023/085878

§ 371 Date: Jun. 24, 2025

Related U.S. Application Data
(60) Provisional application No. 63/435,272, filed on Dec. 25, 2022.
(60) Provisional application No. 63/516,513, filed on Jul. 29, 2023.

(51) Int. Cl. B01L 3/00; G01N 21/64

(52) U.S. Cl. CPC B01L 3/502715; G01N 21/6428; G01N 21/6452; B01L 2200/027; B01L 2200/0647; B01L 2200/0689; B01L 2200/142; B01L 2300/043; B01L 2300/0645; B01L 2300/12; G01N 2021/6439

(57) ABSTRACT

Provided include components (e.g., consumable components) of optical genome mapping (OGM) systems.

### RELATED APPLICATIONS

The present application is a U.S. national phase application under 35 U.S.C. § 371 of International Application No. PCT/US2023/085878, filed on Dec. 26, 2023 and published as WO 2024/145268 A1 on Jul. 4, 2024, which claims the benefit under 35 U.S.C. § 119(e) of U.S. Provisional Patent Application Ser. No. 63/435,272, filed Dec. 25, 2022; and U.S. Provisional Patent Application Ser. No. 63/516,513, filed Jul. 29, 2023. The content of each of these related applications is incorporated herein by reference in its entirety for all purposes.

### BACKGROUND

The present disclosure generally relates to optical genome mapping (OGM). More specifically, components of OGM systems.

OGM is powerful technique for analyzing biological analytes. In using an OGM system, a biological sample can be loaded into a fluidic device, e.g., a container or a microfluidic cartridge having a fluidic chamber or a more complex fluidic network, and then at least a portion of the fluidic device is imaged to detect one or more analytes in the biological sample. The analytes can be nucleic acids, for example DNA (including high molecular weight genomic DNA (gDNA)). OGM can be used to interrogate genome structural variation (SV) in megabase length DNA molecules outside the detection range of next generation sequencing (NGS). These genome mapping in fluidic channel technologies, such as nick label repair stain chemistry (NLRS) or directly labeled (non-damaging) using the direct label and stain chemistry (DLS) (both from Bionano Genomics, Inc., San Diego, CA), are able to generate structurally accurate genome assemblies for large and complex plant and animal genomes.

### SUMMARY

Disclosed herein include cartridges, such as cartridges for microscopy, such as fluorescent microscopy (e.g., optical genome mapping). In some embodiments, a cartridge comprises a hermetic seal capable of preventing (or minimizing) evaporation of a liquid sample. In some embodiments, the prevention of evaporation can be at least or at least about 24 hours, 48 hours, 72 hours, 100 hours, 150 hours, 200 hours, 300 hours, 400 hours, 500 hours, 600 hours, or more.

In some embodiments, the liquid sample comprises a biological sample. In some embodiments, the biological sample comprises one or more analytes. The analytes can comprise nucleic acid. The nucleic acid can be DNA. In some embodiments, the DNA is high molecular weight DNA, such as DNA that is at least 1 Mb, 1.5 Mb, or 2 Mb in length.

In some embodiments, the cartridge (or one or more components thereof, such as the base and the lid of the cartridge) comprises a polymer, a polycarbonate, a plastic, or a combination thereof. In some embodiments, the cartridge comprises a flow cell and one or more electrodes fluidically connected with the flow cell. For example, (a part of) an electrode can be present in the flow cell which allows (the part of) the electrode to contact the fluid that may be present in the flow cell when the cartridge is in use (or when the flow cell contains liquid). In some embodiments, the one or more electrodes comprise titanium and/or are titanium electrodes. In some embodiments, the one or more electrodes are insert molded.

In some embodiments, the one or more electrodes are fluidically connected (or in fluidic connection) to the flow cell when the cartridge is in a closed configuration. In some embodiments, the one or more electrodes are fluidically connected to the flow cell when the cartridge is in an open configuration. In some embodiments, the one or more electrodes are fluidically connected to the flow cell when the cartridge is both in a closed configuration and an open configuration. In some embodiments, the one or more electrodes are fluidically connected to the flow cell when the cartridge is in a closed configuration and not in an open configuration. In some embodiments, the one or more electrodes prevent (or minimize) evaporation.

In some embodiments, the one or more electrodes allow the liquid sample to be loaded into the flow cell. In some embodiments, the one or more electrodes comprise at least one hollow electrode. In some embodiments, the one or more electrodes are hollow electrodes. In some embodiments, the one or more electrodes are one or more loading ports for the liquid sample. In some embodiments, the one or more electrodes are for (or configured as) one or more loading ports for the liquid sample. In some embodiments, the one or more electrodes are sealed off with a thermoplastic elastomer (TPE) seal (e.g., a Versaflex seal) to prevent (or minimize) evaporation when the cartridge is in a closed configuration.

In some embodiments, the one or more electrodes comprise at least one solid electrode. In some embodiments, the one or more electrodes are solid electrodes. In some embodiments, the cartridge comprises one or more loading ports (which are not or are different from the one or more electrodes) for the liquid sample. In some embodiments, the one or more loading ports are sealed off with a thermoplastic elastomer (TPE) seal to prevent (or minimize) evaporation when the cartridge is in a closed configuration.

In some embodiments, the hermetic seal is formed by contacting the electrodes and a thermoplastic elastomer (TPE) seal. In some embodiments, the hermetic seal is formed by the loading ports and a thermoplastic elastomer (TPE) seal. The TPE seal can be an overmolded seal.

Disclosed herein include cartridges, such as cartridges for microscopy, such as fluorescent microscopy (e.g., optical genome mapping). In some embodiments, a cartridge comprises: a caddy. The cartridge can comprise a flow cell. A caddy can comprise a base (or a body or a lower body or a bottom body) and a lid. The base can comprise a central region (or a central part or a central piece). The central region can comprise one or more loading ports. The central region can comprise one or more electrodes. The one or more electrodes can be fluidically connected (or in fluidic connection) to the flow cell when the cartridge is both in a closed configuration and an open configuration. For example, (a part of) an electrode can be present in the flow cell which allows (the part of) the electrode to contact the fluid that may be present in the flow cell when the cartridge is in use (or when the flow cell contains liquid). The lid can comprise a seal. The seal and the one or more loading ports can form a hermetic seal when the caddy is in a closed configuration. The seal and the one or more loading ports can be capable of forming a hermetic seal when the caddy is in a closed configuration. The cartridge can comprise a flow cell.

Disclosed herein include cartridges, such as cartridges for microscopy, such as fluorescent microscopy (e.g., optical genome mapping). In some embodiments, a cartridge comprises: a caddy. The caddy can comprise a base (or a body or a lower body or a bottom body) and a lid (or a top body). The base can comprise one or more loading ports. The base can comprise one or more electrodes. The lid can comprise a seal. The seal and the one or more loading ports can form a hermetic seal when the cartridge is in a closed configuration. The cartridge can comprise a flow cell. In some embodiments, the base comprises a central region (or a central part of a central piece) comprising the one or more loading ports and the one or more electrodes.

In some embodiments, the lid is connected to the base. In some embodiments, the lid comprises a hinged lid connected to the base. In some embodiments, the lid is not connected to the base. In some embodiments, the lid is in contact with the base when the cartridge is in a closed configuration, not when the cartridge is in an open configuration. In some embodiments, the lid is in contact with the base when the cartridge is in a closed configuration and when the cartridge is in an open configuration.

In some embodiments, the one or more loading ports are for loading a liquid sample. In some embodiments, the seal and the one or more loading ports form a hermetic seal when the caddy is in a closed configuration. The seal and the one or more loading ports are capable of forming a hermetic seal when the caddy is in a closed configuration. The hermetic seal can prevent (or minimize) evaporation of a liquid sample loaded into the flow cell (or a sample loaded into the flow cell, or the content of the flow cell). The hermetic seal can be capable of preventing (or minimizing) evaporation of a liquid sample loaded into the flow cell (or a sample loaded into the flow cell, or the content of the flow cell). In some embodiments, the prevention (or minimization) of evaporation can be at least or at least about 24 hours, 48 hours, 72 hours, 100 hours, 150 hours, 200 hours, 300 hours, 400 hours, 500 hours, 600 hours, or more.

In some embodiments, the liquid sample comprises a biological sample. In some embodiments, the biological sample comprises one or more analytes. The analytes can comprise nucleic acid. The nucleic acid can be DNA. In some embodiments, the DNA is high molecular weight DNA, such as DNA that is at least 1 Mb, 1.5 Mb, or 2 Mb in length.

In some embodiments, the base comprises two rounded edges. The base can comprise two angled edges. The two rounded edges can be at a side of the base closer to the lid when the cartridge is in an open configuration.

In some embodiments, the base comprises a polymer, a polycarbonate, a plastic, or a combination thereof. In some embodiments, the base other than the central region is not clear and/or not see through. In some embodiments, the base other than the central region is made in a first shot, and the central region is made in a second shot.

In some embodiments, the caddy comprises a polymer, a polycarbonate, a plastic, or a combination thereof. In some embodiments, the caddy other than the central region is not clear and/or not see through. In some embodiments, the caddy other than the central region and the seal is not clear and/or not see through. In some embodiments, the caddy other than the central region and the seal is made in a first shot, and the central region is made in a second shot.

In some embodiments, the central region comprises a polymer, a polycarbonate, a plastic, or a combination thereof. In some embodiments, the central region is clear and/or see through. In some embodiments, the central region comprises a groove corresponding to (or of or for) each of the one or more loading ports. The groove can be on a top surface of the central region. The central region can comprises a fillet corresponding to (or of or for) each of the one or more loading ports. The fillet can be on a bottom surface of the central region.

In some embodiments, the one or more loading ports comprise two loading ports. In some embodiments, the two loading ports (or all the loading ports) are identical in size and geometry. In some embodiments, a center of one of the one or more loading ports is on a line formed by the two of the one or more electrodes (on the top surface of the central region). In some embodiments, a center of one of the one or more loading ports (e.g., the inlet port) is not on a line formed by the two of the one or more electrodes (on the top surface of the central region). In some embodiments, a center of one of the one or more loading ports (e.g., the outlet port) has an offset from a line formed by the two of the one or more electrodes (on the top surface of the central region). In some embodiments, two (or each) of the one or more loading ports can be identical in shape (size and geometry). In some embodiments, the one or more loading ports are funnel-shaped. In some embodiments, the one or more loading ports are sample funnels. In some embodiments, the one or more loading ports each has a size and a geometry to accept a pipette tip (e.g., a 5 μL, 10 μL, 15 μL, or 20 μL pipette tip). The one or more loading ports can have a shape to prevent (or minimize) introduction of air bubbles into the flow cell. In some embodiments, the one or more loading ports comprise an inlet port and an outlet port. In some embodiments, a loading port can be connected to a number of fingers, such as 2 or 3 fingers. For example, the inlet port can be connected to 2 fingers. For example, the outlet port can be connected to 3 fingers. In some embodiments, the one or more loading ports extrude over a top surface of the central region. The one or more loading ports can extrude over a top surface of the central region by, for example, (about) 0.1 mm, 0.15 mm, 0.2 mm, 0.25 mm, 0.3 mm, 0.35 mm, 0.4 mm, 0.45 mm, 0.5 mm, or a number or a range between any two of these values.

In some embodiments, the flow cell is formed by the base and a chip (or a flow cell chip). The chip can be inserted into to an opening at a bottom face of the base. The chip can be glued to the base. In some embodiments, the base comprises a chip orientation key on a bottom surface of the base.

In some embodiments, the one or more electrodes comprise two electrodes. In some embodiments, the one or more electrodes comprise one or more pins. In some embodiments, the one or more electrodes do not extrude from a top surface of the central region. In some embodiments, the one or more electrodes comprise titanium and/or are titanium electrodes. In some embodiments, the one or more electrodes are insert molded.

In some embodiments, the one or more electrodes are fluidically connected (or in fluidic connection) to the flow cell when the cartridge is in a closed configuration. In some embodiments, the one or more electrodes are fluidically connected to the flow cell when the cartridge is in an open configuration. In some embodiments, the one or more electrodes are fluidically connected to the flow cell when the cartridge is both in a closed configuration and an open configuration. In some embodiments, the one or more electrodes are fluidically connected to the flow cell when the cartridge is in a closed configuration and not in an open configuration. In some embodiments, the one or more electrodes prevent (or minimize) evaporation.

In some embodiments, the one or more electrodes allow the liquid sample to be loaded into the flow cell. In some embodiments, the one or more electrodes comprise at least one hollow electrode. In some embodiments, the one or more electrodes are hollow electrodes. In some embodiments, the one or more electrodes are the one or more loading ports.

In some embodiments, the one or more electrodes comprises at least one solid electrode. In some embodiments, the one or more electrodes are solid electrodes.

In some embodiments, the seal comprises a thermoplastic elastomer (TPE) seal (e.g., a Versaflex seal). In some embodiments, the seal is overmolded. In some embodiments, the seal is oval in shape. The seal can be rectangular in shape. The seal can have rounded edges. The seal can have a tab.

In some embodiments, the base, the lid, the seal, and the electrodes are one piece. For example, the seal can be overmolded. The electrodes can be insert molded. The base and the lid can be made by the first shot in an injection molding process, and the central region can be made by the second shot in the injection molding process.

In some embodiments, the lid comprises one or more electrical connections for contacting the one or more electrodes. The one or more electrical connections can extrude from a top surface of the lid. The one or more electrical connections may not extrude from a top surface of the lid. The one or more electrical connections may not be exposed at a top surface of the lid. For example, the one or more electrical connections cannot be contacted with electrically at a top surface of the lid. The one or more electrical connections can comprise one or more pins.

In some embodiments, when the cartridge is in an open configuration, the one or more electrical connections are not in contact with the corresponding one or more electrodes. When the cartridge is in a closed configuration, the one or more electrical connections can be in contact with the corresponding one or more electrodes. In some embodiments, when the cartridge is in both an open configuration and a closed configuration, the one or more electrical connections are in contact with the corresponding one or more electrodes. In some embodiments, the one or more electrical connections is each in contact with a wire. The wire can be on or in the lid. The wire can be U-shaped. In some embodiments, the cartridge comprises one or more wires in contact with the one or more electrodes at a bottom surface of the base.

In some embodiments, the cartridge comprises one or more wires in contact with the one or more electrodes. For each of the one or more electrodes, a wire of the cartridge can be in contact with the electrode. Each wire can be in contact with a top of the corresponding electrode. An end of the wire (or the wire towards one end) can be in contact with the corresponding electrode. The other end of the wire (or the wire towards the other end) can be for contacting an electrical source. The other end of the wire (or the wire towards the other end) can for contacting an electrical source at a notch of the base. In some embodiments, each wire is U-shaped. A (vertical) side of the U-shaped wire can be in contact with the corresponding electrode. The other (vertical) side of the U-shaped wire can be for contacting an electrical source, e.g., at a notch of the base. The base can comprise a crevice (e.g., a U-shaped crevice) for embedding the wire (e.g., a U-shaped wire). In some embodiments, the one or more wires comprise stainless steel and/or are stainless steel wires.

In some embodiments, the base comprises one or more notches corresponding to the one or more wires (one notch per wire). The one or more notches can comprise V-notches (or be V-shaped). Each of the one or more notches can be at a different side of the base. Each of two of the one or more notches can be on the opposite sides of the base. The one or more wires can be exposed at the corresponding one or more notches. The one or more wires can be contacted (or contactable) at the corresponding one or more notches.

In some embodiments, the base comprises a latch. The base can comprise a release button. When the cartridge is in a closed configuration, a tip of the lid can be inserted into the latch to secure (or releasably secure) the lid to the base to form the hermetic seal. When the cartridge is in a closed configuration, a tip of the lid can released from the latch when the release button is depressed (or by depressing the release button). The cartridge can change from an open configuration to a closed configuration by inserting a tip of the lid into the latch to secure (or releasably secure) the lid to the base to form the hermetic seal.

In some embodiments, the lid comprises one or more extrusions. An extrusion can be half-moon shaped (or oval shaped or rectangular shape or square shape). When the cartridge is in a closed configuration, each of the one or more extrusions can be in contact with a wire to maintain contact of the wire with the base.

In some embodiments, the base comprises at least three nests. The nests can comprise circular nests. Each of the three nests can comprise at least one extruding retainer (e.g., 1, 2, 3, or more, extruding retainers). In some embodiments, the cartridge comprises a metal ball inserted into each of the nest. In some embodiments, the base comprises a label on a top surface of the base. The label can cover the at least three nests.

In some embodiments, the base is, is about, is at least, is at least about, is at most, or is at most about, 35 mm, 36 mm, 37 mm, 38 mm, 39 mm, 40 mm, 41 mm, 42 mm, 43 mm, 44 mm, 45 mm, 46 mm, 47 mm, 48 mm, 49 mm, 50 mm, 51 mm, 52 mm, 53 mm, 54 mm, 55 mm, 56 mm, 57 mm, 58 mm, 59 mm, 60 mm, 61 mm, 62 mm, 63 mm, 64 mm, 65 mm, 66 mm, 67 mm, 68 mm, 69 mm, 70 mm, 71 mm, 72 mm, 73 mm, 74 mm, 75 mm, or a number or a range between any two of these values, in width. The base can be, be about, be at least, be at least about, be at most, or be at most about, 35 mm, 36 mm, 37 mm, 38 mm, 39 mm, 40 mm, 41 mm, 42 mm, 43 mm, 44 mm, 45 mm, 46 mm, 47 mm, 48 mm, 49 mm, 50 mm, 51 mm, 52 mm, 53 mm, 54 mm, 55 mm, 56 mm, 57 mm, 58 mm, 59 mm, 60 mm, 61 mm, 62 mm, 63 mm, 64 mm, 65 mm, 66 mm, 67 mm, 68 mm, 69 mm, 70 mm, 71 mm, 72 mm, 73 mm, 74 mm, 75 mm, or a number or a range between any two of these values, in length. The base can be, be about, be at least, be at least about, be at most, or be at most about, 4 mm, 4.1 mm, 4.2 mm, 4.3 mm, 4.4 mm, 4.5 mm, 4.6 mm, 4.7 mm, 4.8 mm, 4.9 mm, 5 mm, 5.1 mm, 5.2 mm, 5.3 mm, 5.4 mm, 5.5 mm, 5.6 mm, 5.7 mm, 5.8 mm, 5.9 mm, 6 mm, 6.1 mm, 6.2 mm, 6.3 mm, 6.4 mm, 6.5 mm, 6.6 mm, 6.7 mm, 6.8 mm, 6.9 mm, 7 mm, 7.1 mm, 7.2 mm, 7.3 mm, 7.4 mm, 7.5 mm, 7.6 mm, 7.7 mm, 7.8 mm, 7.9 mm, 8 mm, or a number or a range between any two of these values, in thickness (e.g., thickest part).

In some embodiments, the lid is, is about, is at least, is at least about, is at most, or is at most about, 10 mm, 11 mm, 12 mm, 13 mm, 14 mm, 15 mm, 16 mm, 17 mm, 18 mm, 19 mm, 20 mm, 21 mm, 22 mm, 23 mm, 24 mm, 25 mm, 26 mm, 27 mm, 28 mm, 29 mm, 30 mm, or a number or a range between any two of these values, in width. The lid can be, be about, be at least, be at least about, be at most, or be at most about, 15 mm, 16 mm, 17 mm, 18 mm, 19 mm, 20 mm, 21 mm, 22 mm, 23 mm, 24 mm, 25 mm, 26 mm, 27 mm, 28 mm, 29 mm, 30 mm, 31 mm, 32 mm, 33 mm, 34 mm, 35 mm, 36 mm, 37 mm, 38 mm, 39 mm, 40 mm, 41 mm, 42 mm, 43 mm, 44 mm, 45 mm, 46 mm, 47 mm, 48 mm, 49 mm, 50 mm, 51 mm, 52 mm, 53 mm, 54 mm, 55 mm, or a number or a range between any two of these values, in length. The lid can be, be about, be at least, be at least about, be at most, or be at most about, 1.5 mm, 1.6 mm, 1.7 mm, 1.8 mm, 1.9 mm, 2 mm, 2.1 mm, 2.2 mm, 2.3 mm, 2.4 mm, 2.5 mm, 2.6 mm, 2.7 mm, 2.8 mm, 2.9 mm, 3 mm, 3.1 mm, 3.2 mm, 3.3 mm, 3.4 mm, 3.5 mm, 3.6 mm, 3.7 mm, 3.8 mm, 3.9 mm, 4 mm, 4.1 mm, 4.2 mm, 4.3 mm, 4.4 mm, 4.5 mm, 4.6 mm, 4.7 mm, 4.8 mm, 4.9 mm, 5 mm, 5.1 mm, 5.2 mm, 5.3 mm, 5.4 mm, 5.5 mm, or a number or a range between any two of these values in thickness (e.g., thickest part).

In some embodiments, the seal is, is about, is at least, is at least about, is at most, or is at most about, 5 mm, 6 mm, 7 mm, 8 mm, 9 mm, 10 mm, 11 mm, 12 mm, 13 mm, 14 mm, 15 mm, 16 mm, 17 mm, 18 mm, 19 mm, 20 mm, 21 mm, 22 mm, 23 mm, 24 mm, 25 mm, 26 mm, 27 mm, 28 mm, 29 mm, 30 mm, 31 mm, 32 mm, 33 mm, 34 mm, 35 mm, 36 mm, 37 mm, 38 mm, 39 mm, 40 mm, or a number or a range between any two of these values, in width. The seal can be, be about, be at least, be at least about, be at most, or be at most about, 5 mm, 6 mm, 7 mm, 8 mm, 9 mm, 10 mm, 11 mm, 12 mm, 13 mm, 14 mm, 15 mm, 16 mm, 17 mm, 18 mm, 19 mm, 20 mm, 21 mm, 22 mm, 23 mm, 24 mm, 25 mm, 26 mm, 27 mm, 28 mm, 29 mm, 30 mm, 31 mm, 32 mm, 33 mm, 34 mm, 35 mm, 36 mm, 37 mm, 38 mm, 39 mm, 40 mm, or a number or a range between any two of these values, in length. The seal can be, be about, be at least, be at least about, be at most, or be at most about, 1 mm, 1.1 mm, 1.2 mm, 1.3 mm, 1.4 mm, 1.5 mm, 1.6 mm, 1.7 mm, 1.8 mm, 1.9 mm, 2 mm, 2.1 mm, 2.2 mm, 2.3 mm, 2.4 mm, 2.5 mm, 2.6 mm, 2.7 mm, 2.8 mm, 2.9 mm, 3 mm, 3.1 mm, 3.2 mm, 3.3 mm, 3.4 mm, 3.5 mm, 3.6 mm, 3.7 mm, 3.8 mm, 3.9 mm, 4 mm, 4.1 mm, 4.2 mm, 4.3 mm, 4.4 mm, 4.5 mm, 4.6 mm, 4.7 mm, 4.8 mm, 4.9 mm, 5 mm, or a number or a range between any two of these values, in thickness.

In some embodiments, the hinge is, is about, is at least, is at least about, is at most, or is at most about, 5 mm, 6 mm, 7 mm, 8 mm, 9 mm, 10 mm, 11 mm, 12 mm, 13 mm, 14 mm, 15 mm, 16 mm, 17 mm, 18 mm, 19 mm, 20 mm, 21 mm, 22 mm, 23 mm, 24 mm, 25 mm, 26 mm, 27 mm, 28 mm, 29 mm, 30 mm, 31 mm, 32 mm, 33 mm, 34 mm, 35 mm, 36 mm, 37 mm, 38 mm, 39 mm, 40 mm, or a number or a range between any two of these values, in width. The hinge can be, be about, be at least, be at least about, be at most, or be at most about, 1 mm, 1.1 mm, 1.2 mm, 1.3 mm, 1.4 mm, 1.5 mm, 1.6 mm, 1.7 mm, 1.8 mm, 1.9 mm, 2 mm, 2.1 mm, 2.2 mm, 2.3 mm, 2.4 mm, 2.5 mm, 2.6 mm, 2.7 mm, 2.8 mm, 2.9 mm, 3 mm, 3.1 mm, 3.2 mm, 3.3 mm, 3.4 mm, 3.5 mm, 3.6 mm, 3.7 mm, 3.8 mm, 3.9 mm, 4 mm, 4.1 mm, 4.2 mm, 4.3 mm, 4.4 mm, 4.5 mm, 4.6 mm, 4.7 mm, 4.8 mm, 4.9 mm, 5 mm, or a number or a range between any two of these values, in length, The hinge can be, be about, be at least, be at least about, be at most, or be at most about, *, or a number or a range between any two of these values, 0.2 mm, 0.3 mm, 0.4 mm, 0.5 mm, 0.6 mm, 0.7 mm, 0.8 mm, 0.9 mm, 1 mm, or a number or a range between any two of these values, in thickness (e.g., thickest part).

In some embodiments, the tip inserted into the latch is, is about, is at least, is at least about, is at most, or is at most about, 5 mm, 6 mm, 7 mm, 8 mm, 9 mm, 10 mm, 11 mm, 12 mm, 13 mm, 14 mm, 15 mm, 16 mm, 17 mm, 18 mm, 19 mm, 20 mm, 21 mm, 22 mm, 23 mm, 24 mm, 25 mm, 26 mm, 27 mm, 28 mm, 29 mm, 30 mm, 31 mm, 32 mm, 33 mm, 34 mm, 35 mm, 36 mm, 37 mm, 38 mm, 39 mm, 40 mm, or a number or a range between any two of these values, in width. The tip inserted into the latch can be, be about, be at least, be at least about, be at most, or be at most about, 0.5 mm, 0.6 mm, 0.7 mm, 0.8 mm, 0.9 mm, 1 mm, 1.1 mm, 1.2 mm, 1.3 mm, 1.4 mm, 1.5 mm, 1.6 mm, 1.7 mm, 1.8 mm, 1.9 mm, 2 mm, 3 mm, 4 mm, 5 mm, or a number or a range between any two of these values, in length.

In some embodiments, the latch is, is about, is at least, is at least about, is at most, or is at most about, 5 mm, 6 mm, 7 mm, 8 mm, 9 mm, 10 mm, 11 mm, 12 mm, 13 mm, 14 mm, 15 mm, 16 mm, 17 mm, 18 mm, 19 mm, 20 mm, 21 mm, 22 mm, 23 mm, 24 mm, 25 mm, 26 mm, 27 mm, 28 mm, 29 mm, 30 mm, 31 mm, 32 mm, 33 mm, 34 mm, 35 mm, 36 mm, 37 mm, 38 mm, 39 mm, 40 mm, or a number or a range between any two of these values, in width. The latch can be, be about, be at least, be at least about, be at most, or be at most about, 2.5 mm, 3 mm, 3.5 mm, 4 mm, 4.5 mm, 5 mm, 5.5 mm, 6 mm, 6.5 mm, 7 mm, 7.5 mm, 8 mm, 8.5 mm, 9 mm, 9.5 mm, 10 mm, or a number or a range between any two of these values, in length.

In some embodiments, the nest is, is about, is at least, is at least about, is at most, or is at most about, 2.5 mm, 3 mm, 3.5 mm, 4 mm, 4.5 mm, 5 mm, 5.5 mm, 6 mm, 6.5 mm, 7 mm, 7.5 mm, 8 mm, 8.5 mm, 9 mm, 9.5 mm, 10 mm, or a number or a range between any two of these values, in diameter (or radius). The nest can be, be about, be at least, be at least about, be at most, or be at most about, 2.5 mm, 3 mm, 3.5 mm, 4 mm, 4.5 mm, 5 mm, 5.5 mm, 6 mm, 6.5 mm, 7 mm, 7.5 mm, 8 mm, 8.5 mm, 9 mm, 9.5 mm, 10 mm, 10.5 mm, 11 mm, 11.5 mm, 12 mm, or a number or a range between any two of these values, in depth.

In some embodiments, the offset (from a center of one loading port and a line formed by two electrodes) is, is about, is at least, is at least about, is at most, or is at most about, 1 mm, 1.1 mm, 1.2 mm, 1.3 mm, 1.4 mm, 1.5 mm, 1.6 mm, 1.7 mm, 1.8 mm, 1.9 mm, 2 mm, 2.1 mm, 2.2 mm, 2.3 mm, 2.4 mm, 2.5 mm, 2.6 mm, 2.7 mm, 2.8 mm, 2.9 mm, 3 mm, 3.1 mm, 3.2 mm, 3.3 mm, 3.4 mm, 3.5 mm, 3.6 mm, 3.7 mm, 3.8 mm, 3.9 mm, 4 mm, 4.1 mm, 4.2 mm, 4.3 mm, 4.4 mm, 4.5 mm, 4.6 mm, 4.7 mm, 4.8 mm, 4.9 mm, 5 mm, or a number or a range between any two of these values. Two loading ports can be separated from each other by, by about, by at least, by at least about, by at most, or by at most about, 4 mm, 4.5 mm, 5 mm, 5.5 mm, 6 mm, 6.5 mm, 7 mm, 7.5 mm, 8 mm, 8.5 mm, 9 mm, 9.5 mm, 10 mm, 10.5 mm, 11 mm, 11.5 mm, 12 mm, 12.5 mm, 13 mm, 13.5 mm, 14 mm, 14.5 mm, 15 mm, or a number or a range between any two of these values.

In some embodiments, the groove is, is about, is at least, is at least about, is at most, or is at most about, 3 mm, 3.5 mm, 4 mm, 4.5 mm, 5 mm, 5.5 mm, 6 mm, 6.5 mm, 7 mm, 7.5 mm, 8 mm, 8.5 mm, 9 mm, 9.5 mm, 10 mm, 10.5 mm, 11 mm, 11.5 mm, 12 mm, or a number or a range between any two of these values, in diameter (or radius). The fillet can be, be about, be at least, be at least about, be at most, or be at most about, 1 mm, 1.5 mm, 2 mm, 2.5 mm, 3 mm, 3.5 mm, 4 mm, 4.5 mm, 5 mm, 5.5 mm, 6 mm, 6.5 mm, 7 mm, 7.5 mm, 8 mm, 8.5 mm, 9 mm, or a number or a range between any two of these values, in diameter (or radius) In some embodiments, two electrodes are separated from each other by, by about, by at least, by at least about, by at most, or by at most about, 10 mm, 10.5 mm, 11 mm, 11.5 mm, 12 mm, 12.5 mm, 13 mm, 13.5 mm, 14 mm, 14.5 mm, 15 mm, 15.5 mm, 16 mm, 16.5 mm, 17 mm, 17.5 mm, 18 mm, 18.5 mm, 19 mm, 19.5 mm, 20 mm, 20.5 mm, 21 mm, 21.5 mm, 22 mm, 22.5 mm, 23 mm, 23.5 mm, 24 mm, 24.5 mm, 25 mm, 25.5 mm, 26 mm, 26.5 mm, 27 mm, 27.5 mm, 28 mm, 28.5 mm, 29 mm, 29.5 mm, 30 mm, or a number or a range between any two of these values.

In some embodiments, the chip is, is about, is at least, is at least about, is at most, or is at most about, 10 mm, 11 mm, 12 mm, 13 mm, 14 mm, 15 mm, 16 mm, 17 mm, 18 mm, 19 mm, 20 mm, 21 mm, 22 mm, 23 mm, 24 mm, 25 mm, 26 mm, 27 mm, 28 mm, 29 mm, 30 mm, 31 mm, 32 mm, 33 mm, 34 mm, 35 mm, 36 mm, 37 mm, 38 mm, 39 mm, 40 mm, 41 mm, 42 mm, 43 mm, 44 mm, 45 mm, 46 mm, 47 mm, 48 mm, 49 mm, 50 mm, or a number or a range between any two of these values, in width. The chip can be, be about, be at least, be at least about, be at most, or be at most about, 5 mm, 5.5 mm, 6 mm, 6.5 mm, 7 mm, 7.5 mm, 8 mm, 8.5 mm, 9 mm, 9.5 mm, 10 mm, 10.5 mm, 11 mm, 11.5 mm, 12 mm, 12.5 mm, 13 mm, 13.5 mm, 14 mm, 14.5 mm, 15 mm, 15.5 mm, 16 mm, 16.5 mm, 17 mm, 17.5 mm, 18 mm, 18.5 mm, 19 mm, 19.5 mm, 20 mm, 20.5 mm, 21 mm, 21.5 mm, 22 mm, 22.5 mm, 23 mm, 23.5 mm, 24 mm, 24.5 mm, 25 mm, or a number or a range between any two of these values, in length.

In some embodiments, the opening to which the chip is inserted or glued to is, is about, is at least, is at least about, is at most, or is at most about, 10 mm, 11 mm, 12 mm, 13 mm, 14 mm, 15 mm, 16 mm, 17 mm, 18 mm, 19 mm, 20 mm, 21 mm, 22 mm, 23 mm, 24 mm, 25 mm, 26 mm, 27 mm, 28 mm, 29 mm, 30 mm, 31 mm, 32 mm, 33 mm, 34 mm, 35 mm, 36 mm, 37 mm, 38 mm, 39 mm, 40 mm, 41 mm, 42 mm, 43 mm, 44 mm, 45 mm, 46 mm, 47 mm, 48 mm, 49 mm, 50 mm, or a number or a range between any two of these values, in width. The opening to which the chip is inserted or glued to can be, be about, be at least, be at least about, be at most, or be at most about, 5 mm, 5.5 mm, 6 mm, 6.5 mm, 7 mm, 7.5 mm, 8 mm, 8.5 mm, 9 mm, 9.5 mm, 10 mm, 10.5 mm, 11 mm, 11.5 mm, 12 mm, 12.5 mm, 13 mm, 13.5 mm, 14 mm, 14.5 mm, 15 mm, 15.5 mm, 16 mm, 16.5 mm, 17 mm, 17.5 mm, 18 mm, 18.5 mm, 19 mm, 19.5 mm, 20 mm, 20.5 mm, 21 mm, 21.5 mm, 22 mm, 22.5 mm, 23 mm, 23.5 mm, 24 mm, 24.5 mm, 25 mm, or a number or a range between any two of these values, in length.

In some embodiments, an electrode is, is about, is at least, is at least about, is at most, or is at most about, 2 mm, 2.1 mm, 2.2 mm, 2.3 mm, 2.4 mm, 2.5 mm, 2.6 mm, 2.7 mm, 2.8 mm, 2.9 mm, 3 mm, 3.1 mm, 3.2 mm, 3.3 mm, 3.4 mm, 3.5 mm, 3.6 mm, 3.7 mm, 3.8 mm, 3.9 mm, 4 mm, 4.1 mm, 4.2 mm, 4.3 mm, 4.4 mm, 4.5 mm, 4.6 mm, 4.7 mm, 4.8 mm, 4.9 mm, 5 mm, 5.1 mm, 5.2 mm, 5.3 mm, 5.4 mm, 5.5 mm, 5.6 mm, 5.7 mm, 5.8 mm, 5.9 mm, 6 mm, 6.5 mm, 7 mm, 7.5 mm, 8 mm, 8.5 mm, 9 mm, 9.5 mm, 10 mm, or a number or a range between any two of these values, in length. An electrode can extrude into the flow cell by, by about, by at least, by at least about, by at most, or by at most about, 0.5 mm, 0.6 mm, 0.7 mm, 0.8 mm, 0.9 mm, 1 mm, 1.1 mm, 1.2 mm, 1.3 mm, 1.4 mm, 1.5 mm, 1.6 mm, 1.7 mm, 1.8 mm, 1.9 mm, 2 mm, 2.1 mm, 2.2 mm, 2.3 mm, 2.4 mm, 2.5 mm, 2.6 mm, 2.7 mm, 2.8 mm, 2.9 mm, 3 mm, 3.1 mm, 3.2 mm, 3.3 mm, 3.4 mm, 3.5 mm, 3.6 mm, 3.7 mm, 3.8 mm, 3.9 mm, 4 mm, 4.1 mm, 4.2 mm, 4.3 mm, 4.4 mm, 4.5 mm, or a number or a range between any two of these values.

Disclosed herein include methods for performing microscopy, such as fluorescent microscopy (e.g., optical genome mapping). In some embodiments, a method of performing for microscopy, such as fluorescent microscopy (e.g., optical genome mapping) comprises using a cartridge disclosed herein. Disclosed herein include methods for performing optical genome mapping. In some embodiments, a method of performing optical genome mapping comprises using a cartridge disclosed herein.

### BRIEF DESCRIPTION OF THE DRAWINGS

FIGS. 1A-1I depict a non-limiting embodiment of a cartridge (also referred to herein as a cartridge) with hollow electrodes (e.g., insert molded electrodes) and a seal (which can have an overmolded thermoplastic elastomers (TPE) material, e.g., an overmolded Versaflex seal); an open configuration (FIGS. 1A, 1H, and 1I) and a closed configuration (FIGS. 1B-1G), bottom views showing electrodes (FIGS. 1C-1E), and bottom views showing a bottom cover attached to the cartridge forming a flow cell. When the bottom cover is attached to the cartridge (FIGS. 1F-1H), the electrodes are not seen. The top surface of the bottom cover can include one or more flow channels (FIG. 1I). In the embodiment shown, pins such as pogo pins can be used for electrical connectivity to an instrument, such as an OGM instrument. A cartridge disclosed herein can be used for microscopy, such as fluorescent microscopy (e.g., OGM).

FIGS. 2A-2C depict a non-limiting embodiment of a cartridge with hollow electrodes (e.g., insert molded electrodes) and a seal (which can have an overmolded TPE material, e.g., an overmolded versaflex seal); an open configuration (FIGS. 2A and 2B) and a closed configuration (FIG. 2B), and bottom view showing electrodes (FIG. 2C). In the embodiment shown, wires can be used for electrical connectivity to an instrument, such as an OGM instrument (FIGS. 2B and 2C). A cartridge disclosed herein can be used for microscopy, such as fluorescent microscopy (e.g., OGM).

FIG. 3 depicts a non-limiting embodiment of a hollow electrode described herein. The electrode can be used in the embodiments of a cartridge described herein, such as the embodiments shown in FIGS. 1A-G and FIGS. 2A-2C. The electrode can have a funnel shape. The hollow electrode can be made of, for example, titanium. For example, the hollow electrode can be made of solid titanium.

FIGS. 4A-4K depict bottom and bottom isomeric views (FIGS. 4A, 4D, 4E, 4F, 4G, 4J, and 4K), top and top isometric views (FIGS. 4B and 4C), and exploded top and bottom views (FIGS. 4H and 4I) of a non-limiting embodiment of a cartridge for microscopy, such as fluorescent microscopy (e.g., OGM). The cartridge shown is a multibody part cartridge. A bottom cover (electrodes shown in FIGS. 4F and 4G; electrodes covered by the bottom cover and not seen in FIGS. 4A, 4D, 4E, 4J, and 4K) when attached to the cartridge can form a flow cell. The top surface of the bottom cover can include one or more flow channels (FIG. 4H). In a closed configuration with the bottom cover detached, electrodes can be seen (FIGS. 4A, 4D and 4E); and in an open configuration with the bottom cover detached, electrodes are not seen (FIGS. 4J and 4K). In the embodiment depicted, the electrodes can be solid electrodes (also referred to herein as pins). The cartridge can include a seal, which can have an overmolded TPE material, such as an overmolded versaflex seal (the middle pieces in FIGS. 4H and 4I) FIGS. 5A-5E depict various views of a non-limiting embodiment of a cartridge described herein (such as the embodiment depicted in FIGS. 4A-4K). A cartridge disclosed herein can be used for microscopy, such as fluorescent microscopy (e.g., OGM).

FIGS. 6A-6J show top and top isomeric views (FIGS. 6A, 6C, 6G, and 6I), bottom and bottom isomeric views (FIGS. 6B, 6D, 6H, and 6J), and exploded top and bottom views (FIGS. 6E and 6F) of a non-limiting embodiment of a cartridge for microscopy, such as fluorescent microscopy (e.g., OGM). In a closed configuration with a bottom cover detached (FIGS. 6H and 6J), electrodes can be seen. The top surface of the bottom cover can include one or more flow channels (FIG. 6E). In the embodiment depicted, the electrodes can be solid electrodes (also referred to herein as pins). In the embodiment depicted, the cartridge can include a seal, which can have an overmolded TPE material, such as an overmolded versaflex seal (the middle piece in FIG. 6E, which is shown with electrodes attached).

FIGS. 7A-7O show top and top isomeric views (FIGS. 7A, 7C, 7G, 7I, 7J, 7N, and 7O), bottom and bottom isomeric views (FIGS. 7B, 7D, 7H, and 7K), exploded top and bottom views (FIGS. 7E, 7F, 7L, and 7M), an open configuration (FIGS. 7G-7O), and a closed configuration (FIGS. 7A-7F) of a non-limiting embodiment of a cartridge for microscopy, such as fluorescent microscopy (e.g., OGM). In a closed configuration (FIG. 7E) and an open configuration (FIG. 7M) with a bottom cover detached, electrodes can be seen. The top surface of the bottom cover can include one or more flow channels (FIG. 7L). In the embodiment depicted, the electrodes can be solid electrodes (also referred to herein as pins). In the embodiment shown, wires (solid lines in FIGS. 7A-7D) can be used for electrical connectivity to an instrument, such as an OGM instrument. The cartridge depicted in FIGS. 7F, 7N, and 7O (compare these figures to FIGS. 7E, 7I, and 7J)) do not include electrodes and wires. In the embodiment depicted, the cartridge can include a seal, which can have an overmolded TPE material, such as an overmolded versaflex seal (which can have an oral shape as shown in FIGS. 7G, 7I, 7M, and 7N).

FIGS. 8A-8G illustrate non-limiting exemplary embodiments of a cartridge described herein (e.g., the embodiment of the cartridge depicted in FIGS. 7A-7O) and components of the cartridge.

FIGS. 9A-9B depict a non-limiting embodiment of a cartridge described herein (e.g., the embodiments of the cartridge depicted in FIGS. 7A-7O and/or FIGS. 8A-8G): top isomeric view and open configuration without a label (FIG. 9A) and top view and open configuration with a label (FIG. 9B).

FIGS. 10A-10H illustrates a non-limiting exemplary process of cartridge assembly (e.g., the embodiments of the cartridge depicted in FIGS. 7A-7O, FIGS. 8A-8G, and/or FIGS. 9A-9B).

FIGS. 11A-11C depict a non-limiting embodiment of a cartridge described herein (e.g., the embodiments of the cartridge depicted in FIGS. 7A-7O, FIGS. 8A-8G, FIGS. 9A-9B, and/or FIGS. 10A-10H): a close configuration (FIG. 11A) and closed configurations (FIGS. 11B-11C).

FIGS. 12A-12C depict a non-limiting embodiment of a cartridge described herein. Relative to the embodiments of the cartridge depicted in FIGS. 7A-7O, FIGS. 8A-8G, FIGS. 9A-9B, FIGS. 10A-10H, and/or FIGS. 11A-11C, the cartridge shown in FIGS. 12A-12C can include two extrusions (e.g., half-moon shaped extrusions). The two extrusions can be in contact with the wires and/or maintain the wires in contact with the base when the cartridge is in a closed configuration. A flow cell orientation key is shown in FIG. 12B.

FIG. 13 illustrates a non-limiting exemplary workflow of OGM.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented herein. It will be readily understood that the aspects of the present disclosure, as generally described herein, and illustrated in the Figures, can be arranged, substituted, combined, separated, and designed in a wide variety of different configurations, all of which are explicitly contemplated herein and made part of the disclosure herein.

All patents, published patent applications, other publications, and sequences from GenBank, and other databases referred to herein are incorporated by reference in their entirety with respect to the related technology.

As used herein, the term “about” means plus or minus 1%, 2%, 3%, 4%, 5%, 6%, 7%, 8%, 9%, or 10% of the provided value.

Disclosed herein include, for example, components (e.g., the consumable components) of an optical genome mapping system (including but not limited to Saphyr™, Stratys™ and Marvel systems for optical genome mapping system by Bionano Genomics). In some embodiments using an OGM system for analysis, a biological sample is loaded into a fluidic device, e.g., a container or a microfluidic cartridge having a fluidic chamber or a more complex fluidic network, and then at least a portion of the fluidic device is imaged by an imaging system to detect one or more analytes in the biological sample. The analytes can comprise nucleic acids, for example DNA (including but not limited to high molecular weight genomic DNA (gDNA)). In some embodiments, genome mapping in fluidic nanochannels is applied to interrogate genome structural variation (SV) in megabase length DNA molecules outside the detection range of next generation sequencing (NGS). These genome mapping in fluidic channel technologies, such as nick label repair stain chemistry (NLRS) or directly labeled (non-damaging) using the direct label and stain chemistry (DLS) (both from Bionano Genomics, San Diego, CA), are able to generate structurally accurate genome assemblies for large and complex plant and animal genomes.

Disclosed herein includes components, e.g., a cartridge, of the OGM systems. The cartridge can be configured, in some embodiments, host a liquid sample, for example in one or more flow cells in the cartridge. In some embodiments, the cartridge comprises a hermetic seal capable of preventing (or minimizing) evaporation of the liquid sample contained in the cartridge. In some embodiments, the hermetic seal is formed by contacting one or more parts of the cartridge with one or more components of the OGM system to prevent (or minimize) evaporation of the liquid sample contained in the cartridge. In some embodiments, the hermetic seal contacts with the cartridge to prevent (or minimize) evaporation of the liquid sample.

Disclosed herein include cartridges, such as cartridges for microscopy, such as fluorescent microscopy (e.g., optical genome mapping). In some embodiments, a cartridge comprises a hermetic seal capable of preventing (or minimizing) evaporation of a liquid sample.

Disclosed herein include cartridges, such as cartridges for microscopy, such as fluorescent microscopy (e.g., optical genome mapping). In some embodiments, a cartridge comprises: a caddy. The cartridge can comprise a flow cell. A caddy can comprise a base (or a body or a lower body or a bottom body) and a lid. The base can comprise a central region (or a central part or a central piece). The central region can comprise one or more loading ports. The central region can comprise one or more electrodes. The one or more electrodes can be fluidically connected (or in fluidic connection) to the flow cell when the cartridge is both in a closed configuration and an open configuration. For example, (a part of) an electrode can be present in the flow cell which allows (the part of) the electrode to contact the fluid that may be present in the flow cell when the cartridge is in use (or when the flow cell contains liquid). The lid can comprise a seal. The seal and the one or more loading ports can form a hermetic seal when the caddy is in a closed configuration. The seal and the one or more loading ports can be capable of forming a hermetic seal when the caddy is in a closed configuration. The cartridge can comprise a flow cell.

Disclosed herein include cartridges, such as cartridges for microscopy, such as fluorescent microscopy (e.g., optical genome mapping). In some embodiments, a cartridge comprises: a caddy. The caddy can comprise a base (or a body or a lower body or a bottom body) and a lid (or a top body). The base can comprise one or more loading ports. The base can comprise one or more electrodes. The lid can comprise a seal. The seal and the one or more loading ports can form a hermetic seal when the cartridge is in a closed configuration. The cartridge can comprise a flow cell. In some embodiments, the base comprises a central region (or a central part of a central piece) comprising the one or more loading ports and the one or more electrodes.

Disclosed herein include methods for performing microscopy, such as fluorescent microscopy (e.g., optical genome mapping). In some embodiments, a method of performing for microscopy, such as fluorescent microscopy (e.g., optical genome mapping) comprises using a cartridge disclosed herein. Disclosed herein include methods for performing optical genome mapping. In some embodiments, a method of performing optical genome mapping comprises using a cartridge disclosed herein.

### Example Cartridges

Disclosed herein include, for example, components (e.g., the consumable components) of an optical genome mapping system (including but not limited to Saphyr™, Stratys™ and Marvel systems for optical genome mapping system by Bionano Genomics). In some embodiments using an OGM system for analysis, a biological sample is loaded into a fluidic device, e.g., a container or a microfluidic cartridge having a fluidic chamber or a more complex fluidic network, and then at least a portion of the fluidic device is imaged by an imaging system to detect one or more analytes in the biological sample. The analytes can comprise nucleic acids, for example DNA (including but not limited to high molecular weight genomic DNA (gDNA)). In some embodiments, genome mapping in fluidic nanochannels is applied to interrogate genome structural variation (SV) in megabase length DNA molecules outside the detection range of next generation sequencing (NGS). These genome mapping in fluidic channel technologies, such as nick label repair stain chemistry (NLRS) or directly labeled (non-damaging) using the direct label and stain chemistry (DLS) (both from Bionano Genomics, San Diego, CA), are able to generate structurally accurate genome assemblies for large and complex plant and animal genomes.

Disclosed herein includes components, e.g., a cartridge, of the OGM systems. The cartridge can be configured, in some embodiments, host a liquid sample, for example in one or more flow cells in the cartridge. In some embodiments, the cartridge comprises a hermetic seal capable of preventing evaporation of the liquid sample contained in the cartridge. In some embodiments, the hermetic seal is formed by contacting one or more parts of the cartridge with one or more components of the OGM system to prevent evaporation of the liquid sample contained in the cartridge. In some embodiments, the hermetic seal contacts with the cartridge to prevent evaporation of the liquid sample.

The type or source of the liquid sample can vary. For example, the liquid sample can comprise a biological sample (e.g., a process biological sample). The biological sample can comprise one or more analytes (e.g., nucleic acid). In some embodiments, the liquid sample comprises DNA, for example high molecular weight DNA or ultrahigh molecular weight DNA. In some embodiments, the liquid sample comprises genomic DNA (gDNA), mitochondria DNA, or a combination thereof. The size of the DNA (e.g., gDNA) can vary, for example, at least or at least about, 100 kb, 200 kb, 500 kb, 1 Mb, 1.5 Mb, or 2 Mb in length. The DNA can be isolated from various of organisms, including but not limited to, animals (e.g., a mammal, or a human) and plants (e.g., corn, rice, potato).

The cartridge can be made of various materials, for example polymers. In some embodiments, the cartridge is plastic.

It is advantageous for the OGM system to be able to keep the liquid sample unchanged or with minimal changes (including minimizing or preventing the liquid sample from evaporation) for a long period of time. The OGM components described herein can, for example, result in the prevention of evaporation for at least, or at least about, 100 hours, 200 hours, 300 hours, 400 hours, 500 hours, 600 hours, or more. The evaporation rate of the liquid sample contained in the OGM cartridge described herein can be, for example, no more than 10%, no more than 20%, no more than 30%, no more than 40%, no more than 50%, no more than 60%, no more than 70%, or no more than 80% of the liquid content of the liquid sample, for 100 hours, 150 hours, 200 hours, 250 hours, 300 hours, 350 hours, 400 hours, 450 hours, 500 hours, 550 hours, 600 hours, or a number or a range between any two of these values.

In some embodiments, the cartridge comprises one or more flow cells and/or one or more electrodes (e.g., hollow electrodes). The one or more flow cells can, for example, be fluidically connected with each other, or each of the one or more flow cells is fluidically connected with at least one of the other flow cells. In some embodiments, at least one of the one or more flow cells is not fluidically connected with any of the other flow cells. In some embodiments, the one or more electrodes (e.g., hollow electrodes)are configured to be fluidically connected with at least one of the flow cells. The electrodes (e.g., hollow electrodes) can be configured to prevent evaporation and/or allow the liquid sample to be loaded into the flow cell. For example, at least one of the one or more electrodes (e.g., hollow electrodes) is configured as a loading port for the liquid sample.

How the one or more electrodes (e.g., hollow electrodes)are positioned in the cartridge can vary. For example, the electrodes (e.g., hollow electrodes)can be insert molded with an injection moldable material. In some embodiments, the one or more electrodes (e.g., hollow electrodes) are sealed off with a thermoplastic elastomer material (TPE). The seal off can prevent evaporation. In some embodiments, the hermetic seal is formed by contacting the cartridge, insert molding of electrodes and a TPE seal. The TPE seal can be, for example, an overmolding seal.

As described herein and illustrated in the accompanying drawings, non-exemplary components for an OGM system can include:
1. Cartridge—e.g., one piece
   a. BOM
      i. Polycarbonate
      ii. Silicon die (Flow Cell)
      iii. Overmolded Versaflex
      iv. Pre-formed wire leads
   b. Hermetic seal
      i. Versaflex seal for evaporation prevention
      ii. Silicon die and adhesive
   c. The use of titanium electrodes
      i. Deep drawn
      ii. Titanium wires (not suitable for automated manufacturing)
      iii. Micromachined hollow electrodes
   d. Pipette with and without guide funnels
      i. Sample loading options
   e. Twist motion lid
      i. In some embodiments, it is configured to allow for at least, or at least about, 140 hours of reliable operation
      ii. Reusable option
   f. Formed wire leads. In some embodiments, the formed wire leads are not suitable for automated assembly. In some embodiments, the wire leads are configured for automated assembly.
2. Flow Cell
   a. Footprint: in some embodiments, the flow cell (e.g., Alpha 7) is about 40% smaller than currently available flow cell (e.g., Alpha 5) used in an OGM system.
   b. Loading index: in some embodiment, it can be advantageous to require 2500 Gbp for the loading index.

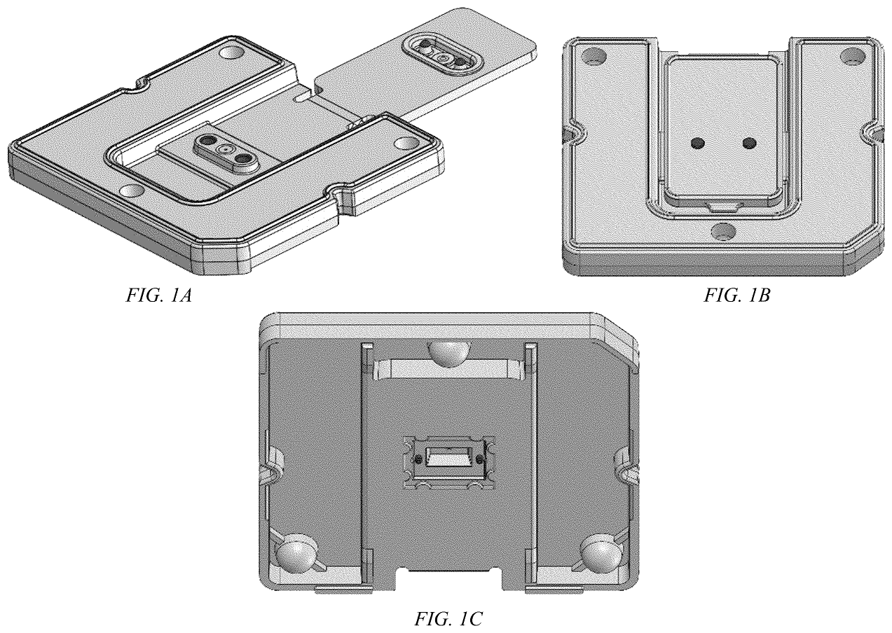

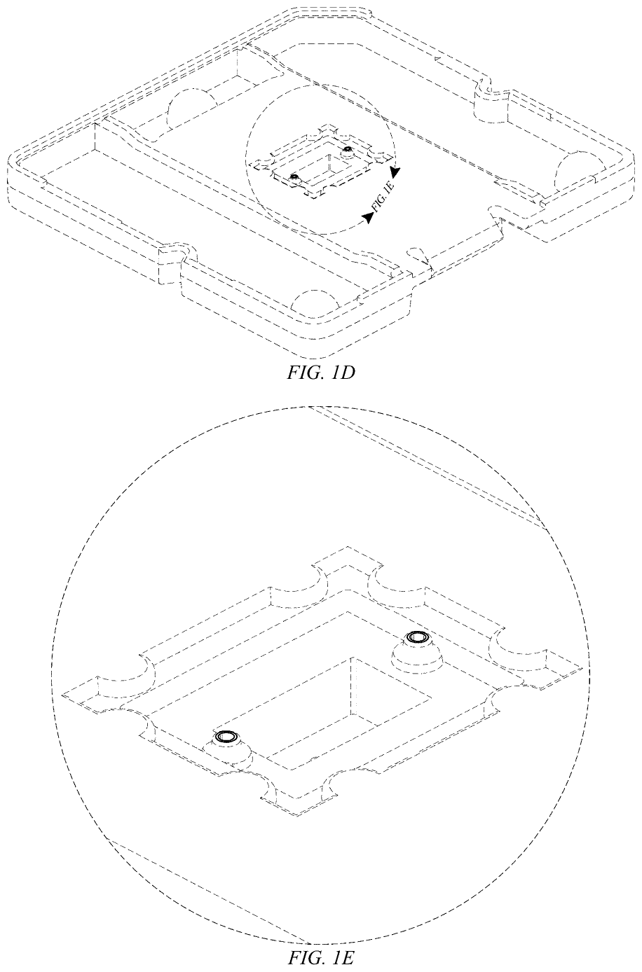

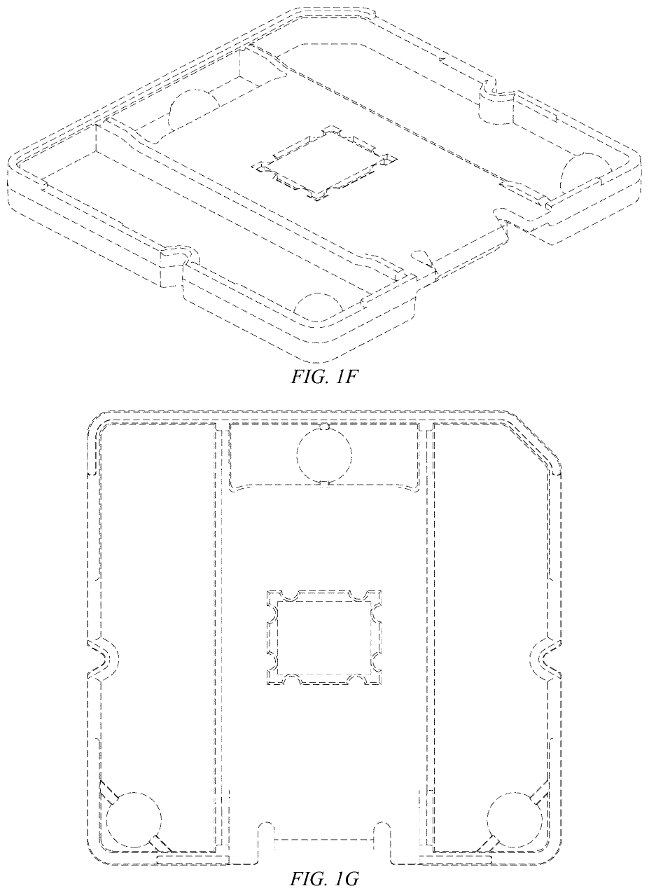

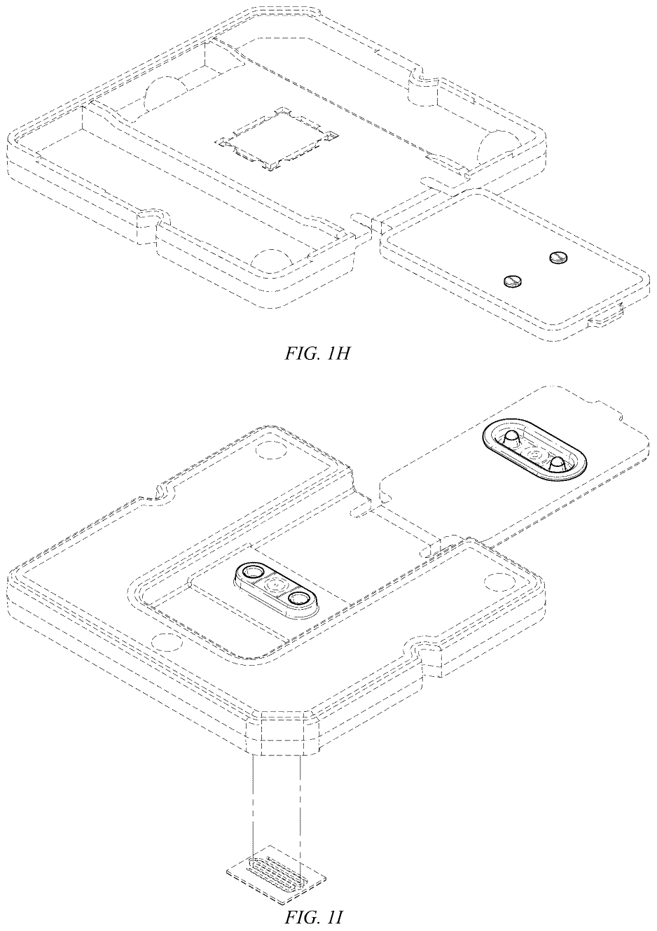

FIGS. 1A-1I depict a non-limiting embodiment of a cartridge (also referred to herein as a cartridge) with hollow electrodes (e.g., insert molded electrodes) and a seal (which can have an overmolded thermoplastic elastomers (TPE) material, e.g., an overmolded versaflex seal); an open configuration (FIGS. 1A, 1H, and 1I) and a closed configuration (FIGS. 1B-1G), bottom views showing electrodes (FIGS. 1C-1E), and bottom views showing a bottom cover attached to the cartridge forming a flow cell. When the bottom cover is attached to the cartridge (FIGS. 1F-1H), the electrodes are not seen. The top surface of the bottom cover can include one or more flow channels (FIG. 1I). In the embodiment shown, pins such as pogo pins can be used for electrical connectivity to an instrument, such as an OGM instrument. A cartridge disclosed herein can be used for microscopy, such as fluorescent microscopy (e.g., OGM).

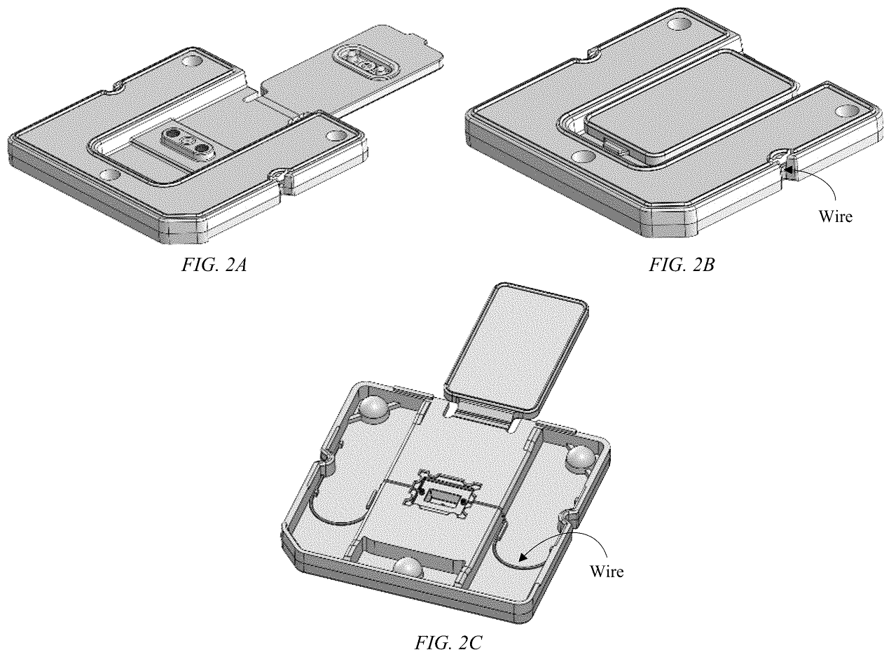

FIGS. 2A-2C depict a non-limiting embodiment of a cartridge with hollow electrodes (e.g., insert molded electrodes) and a seal (which can have an overmolded TPE material, e.g., an overmolded versaflex seal); an open configuration (FIGS. 2A and 2B) and a closed configuration (FIG. 2B), and bottom view showing electrodes (FIG. 2C). In the embodiment shown, wires can be used for electrical connectivity to an instrument, such as an OGM instrument (FIGS. 2B and 2C). A cartridge disclosed herein can be used for microscopy, such as fluorescent microscopy (e.g., OGM).

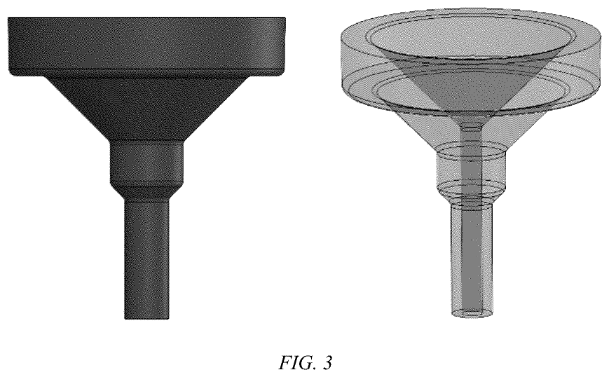

FIG. 3 depicts a non-limiting embodiment of a hollow electrode described herein. The electrode can be used in the embodiments of a cartridge described herein, such as the embodiments shown in FIGS. 1A-G and FIGS. 2A-2C. The electrode can have a funnel shape. The hollow electrode can be made of, for example, titanium. For example, the hollow electrode can be made of solid titanium.

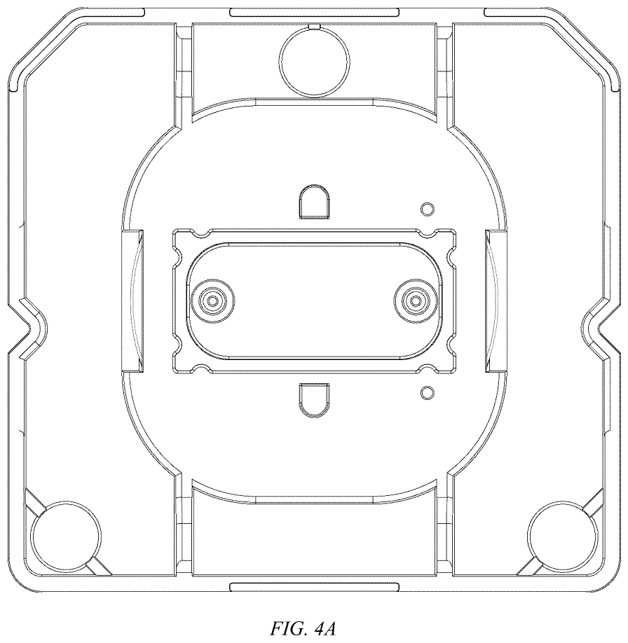

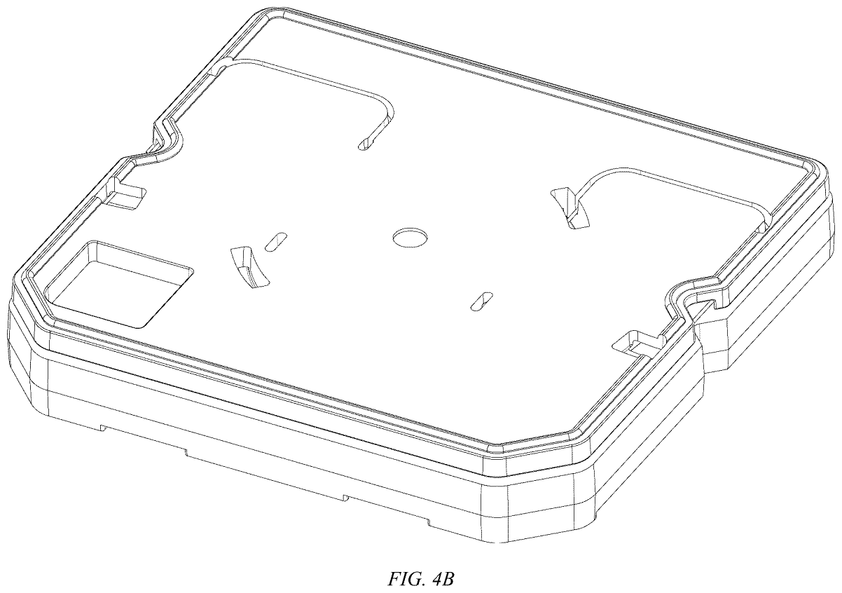

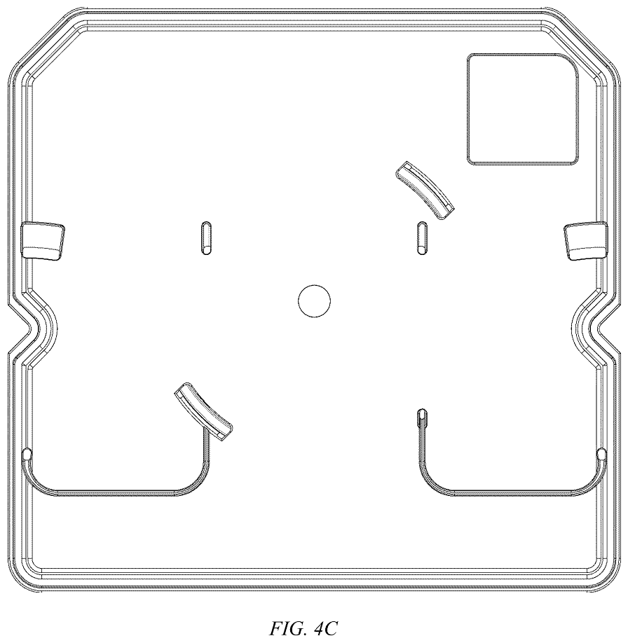

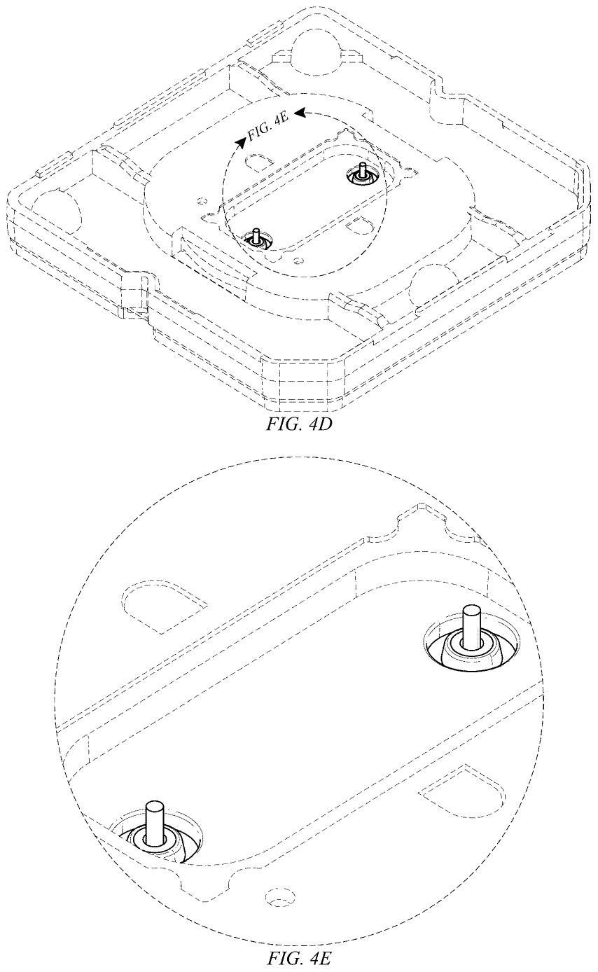

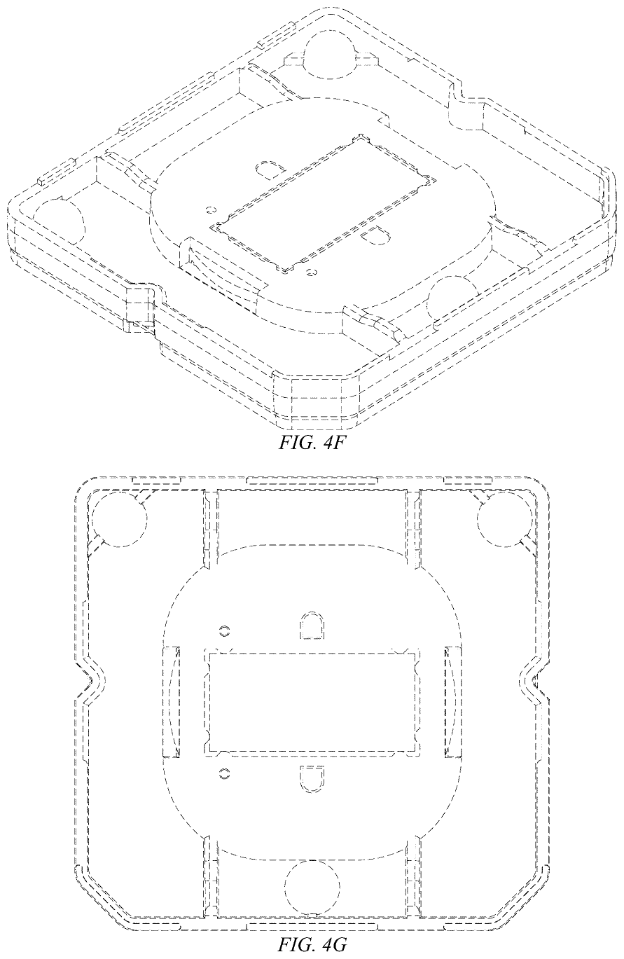

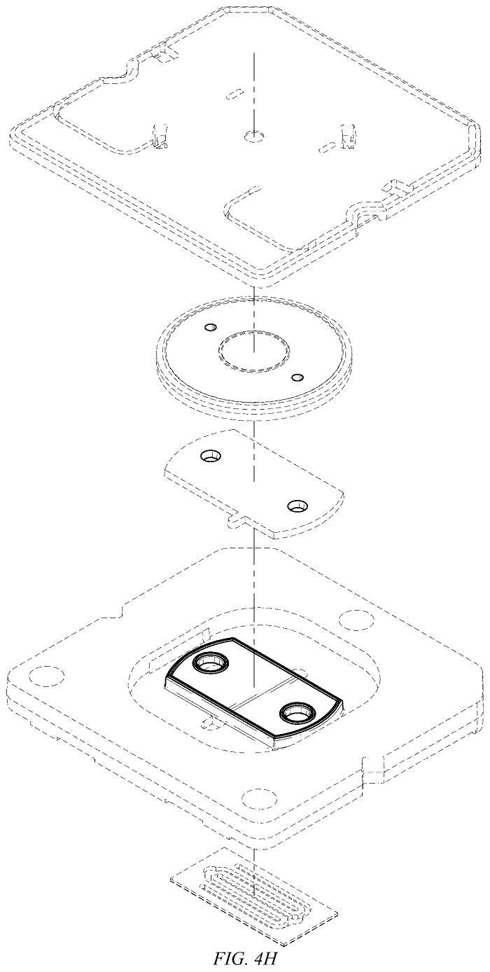

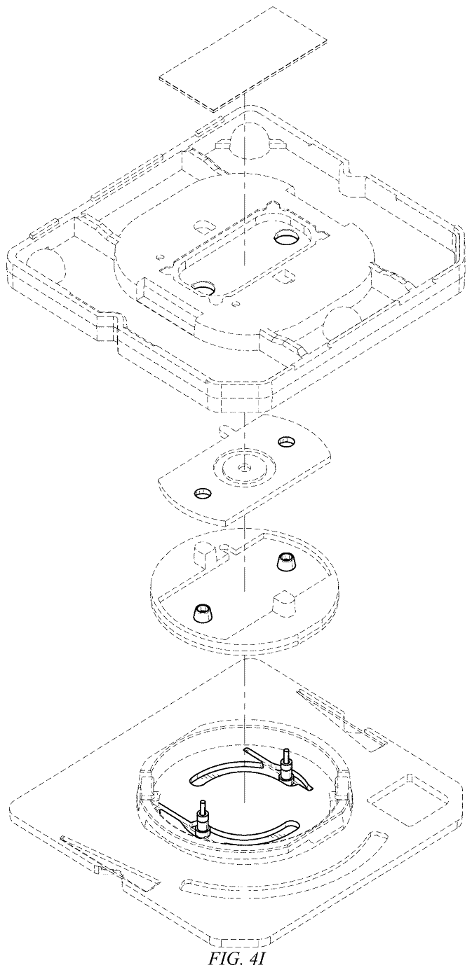

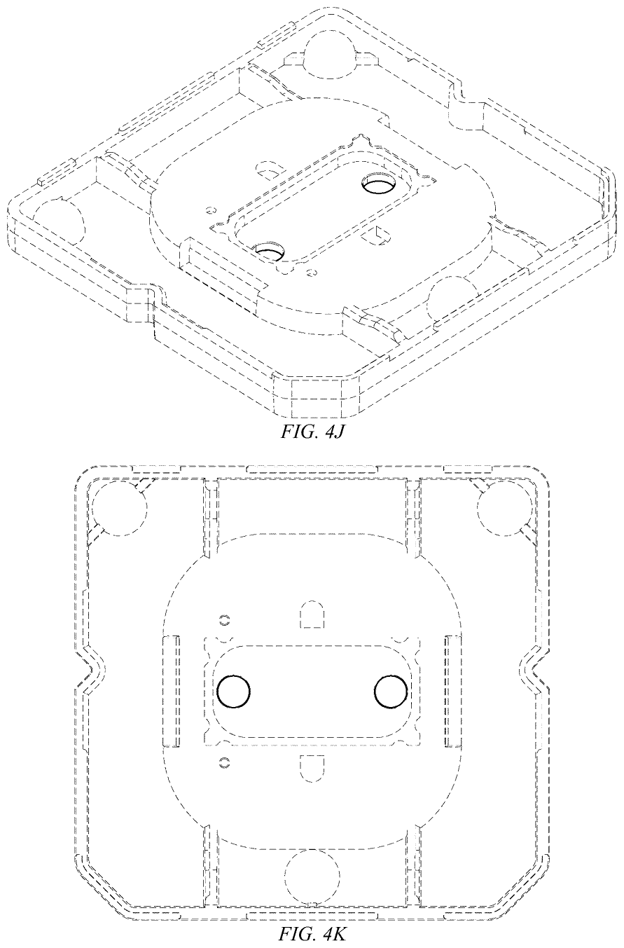

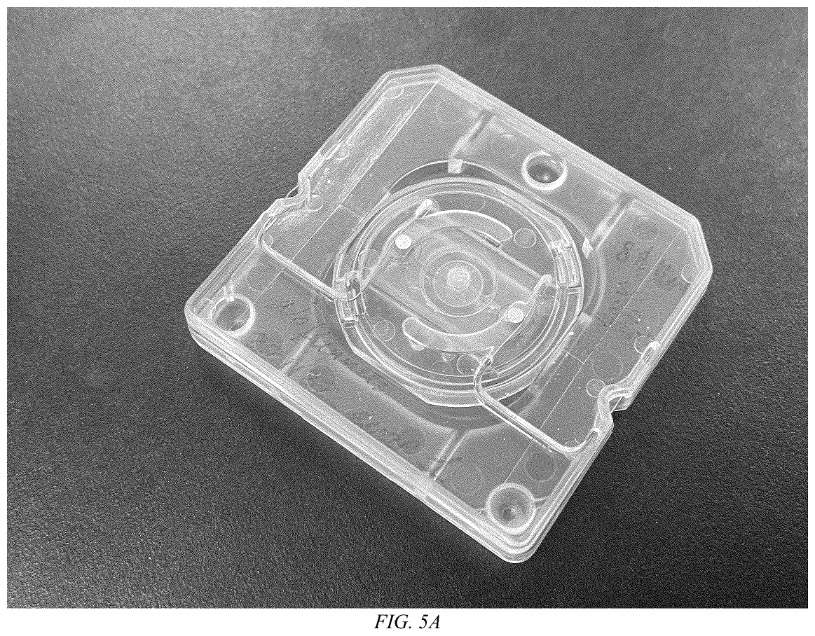

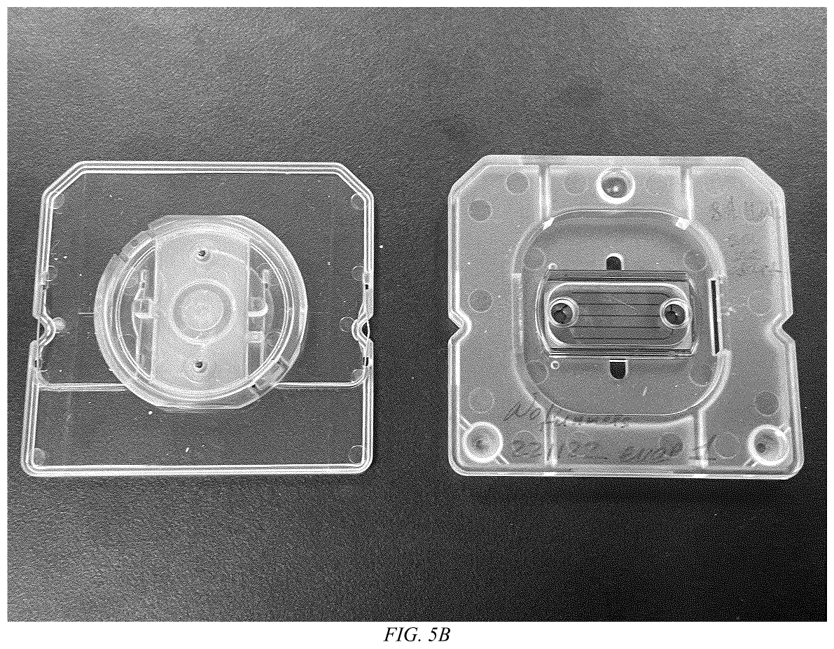

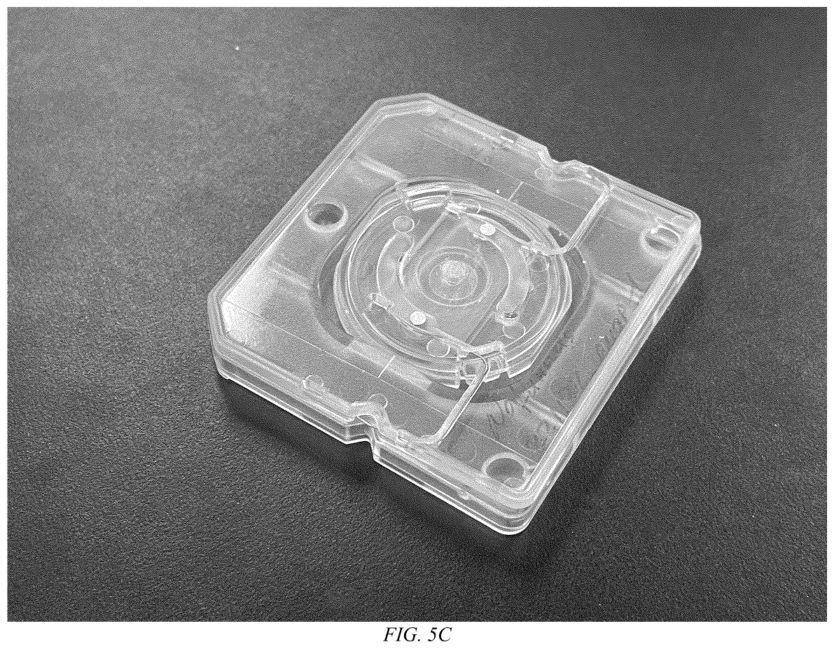

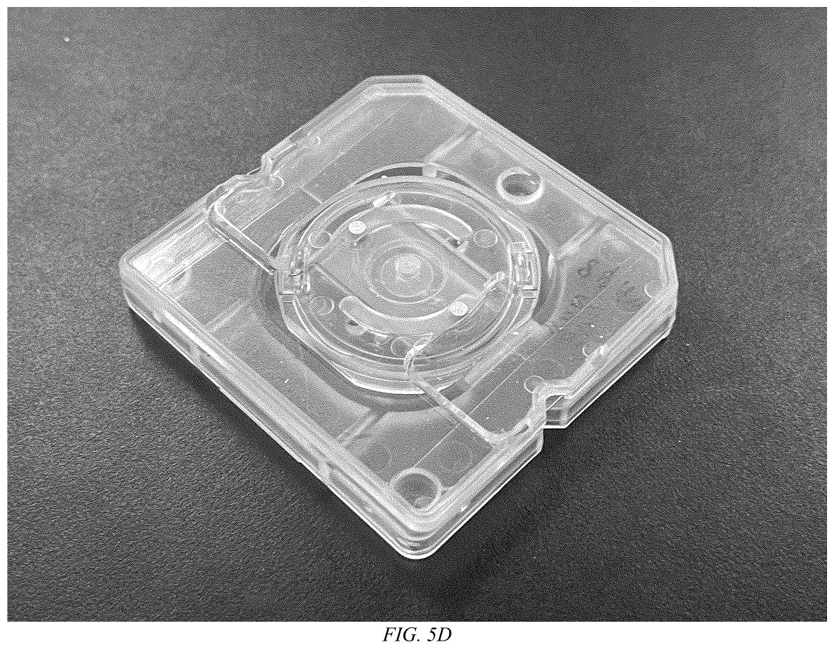

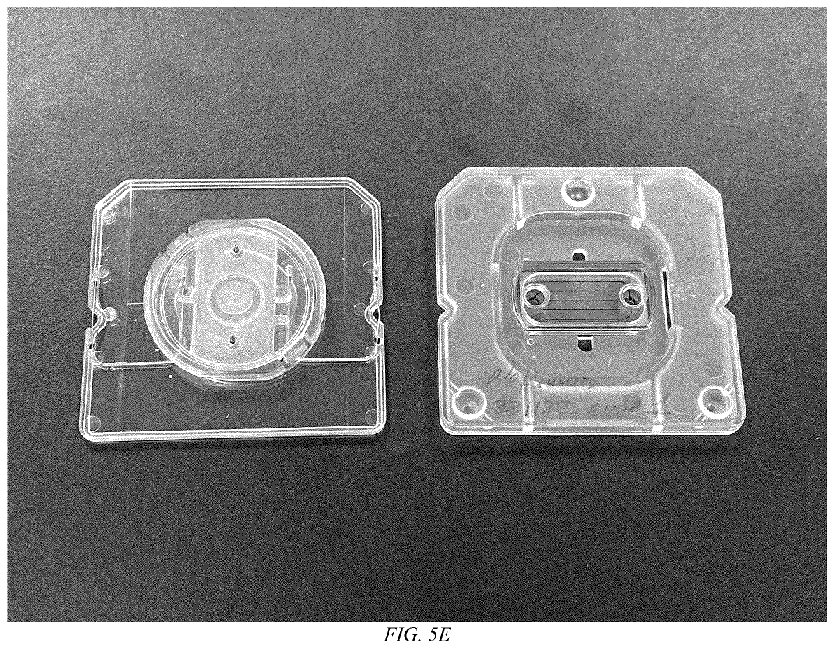

FIGS. 4A-4K depict bottom and bottom isomeric views (FIGS. 4A, 4D, 4E, 4F, 4G, 4J, and 4K), top and top isometric views (FIGS. 4B and 4C), and exploded top and bottom views (FIGS. 4H and 4I) of a non-limiting embodiment of a cartridge for microscopy, such as fluorescent microscopy (e.g., OGM). The cartridge shown is a multibody part cartridge. A bottom cover (electrodes shown in FIGS. 4F and 4G; electrodes covered by the bottom cover and not seen in FIGS. 4A, 4D, 4E, 4J, and 4K) when attached to the cartridge can form a flow cell. The top surface of the bottom cover can include one or more flow channels (FIG. 4H). In a closed configuration with the bottom cover detached, electrodes can be seen (FIGS. 4A, 4D and 4E); and in an open configuration with the bottom cover detached, electrodes are not seen (FIGS. 4J and 4K). In the embodiment depicted, the electrodes can be solid electrodes (also referred to herein as pins). The cartridge can include a seal, which can have an overmolded TPE material, such as an overmolded versaflex seal (the middle pieces in FIGS. 4H and 4I) FIGS. 5A-5E depict various views of a non-limiting embodiment of a cartridge described herein (such as the embodiment depicted in FIGS. 4A-4K). A cartridge disclosed herein can be used for microscopy, such as fluorescent microscopy (e.g., OGM).

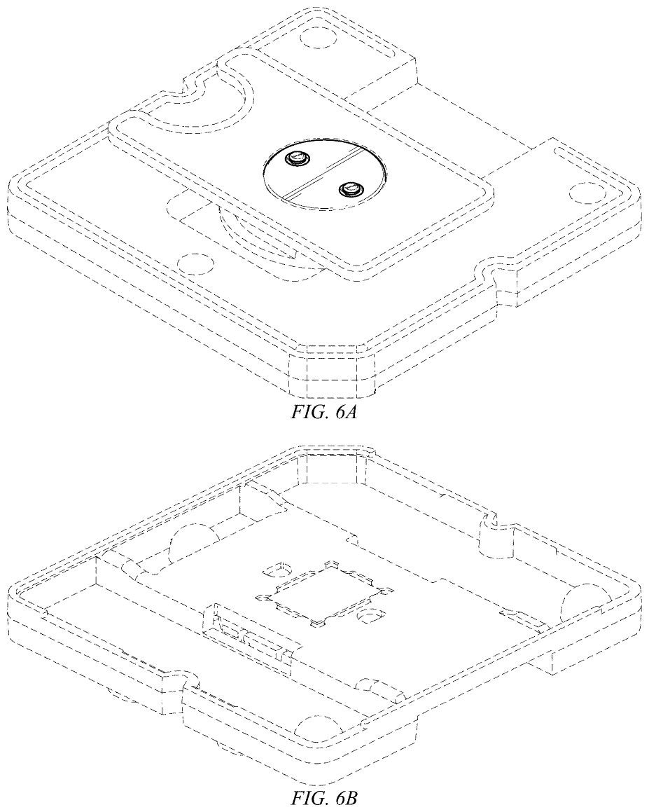

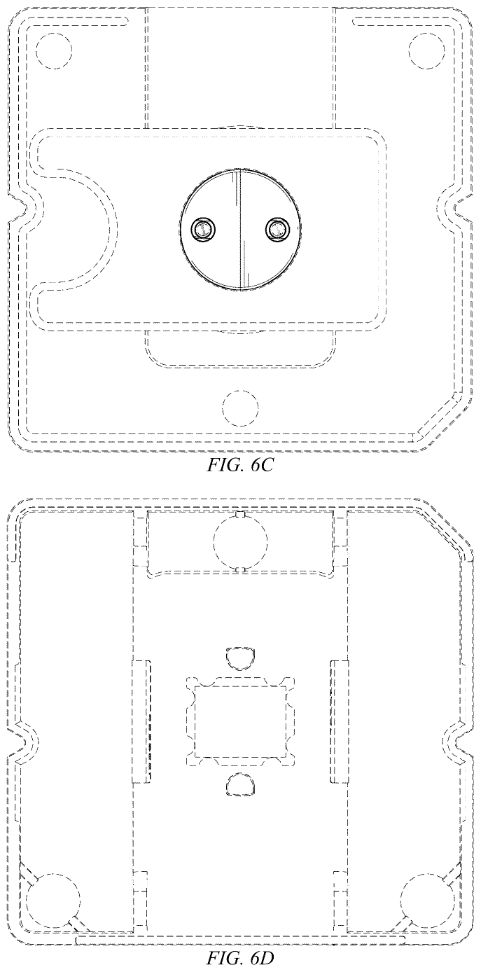

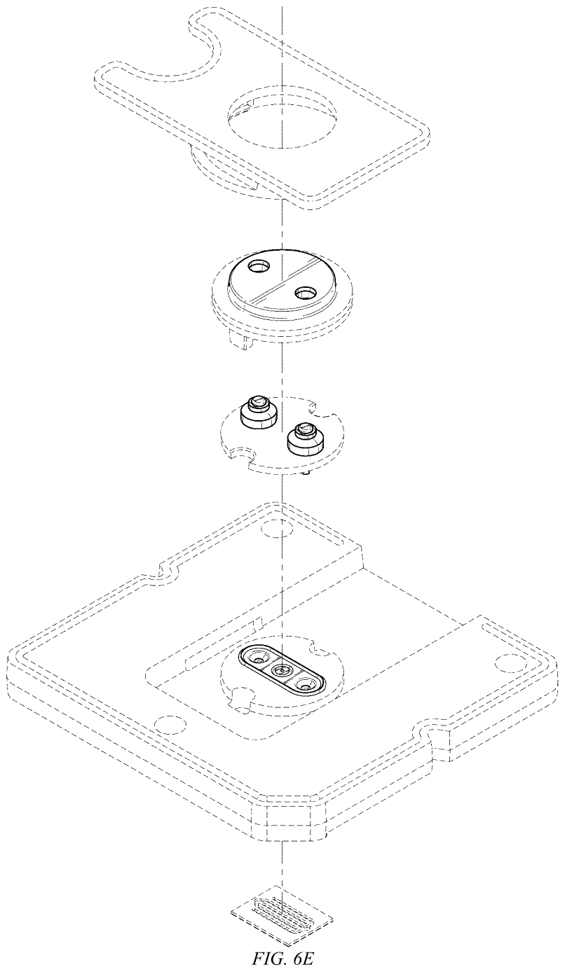

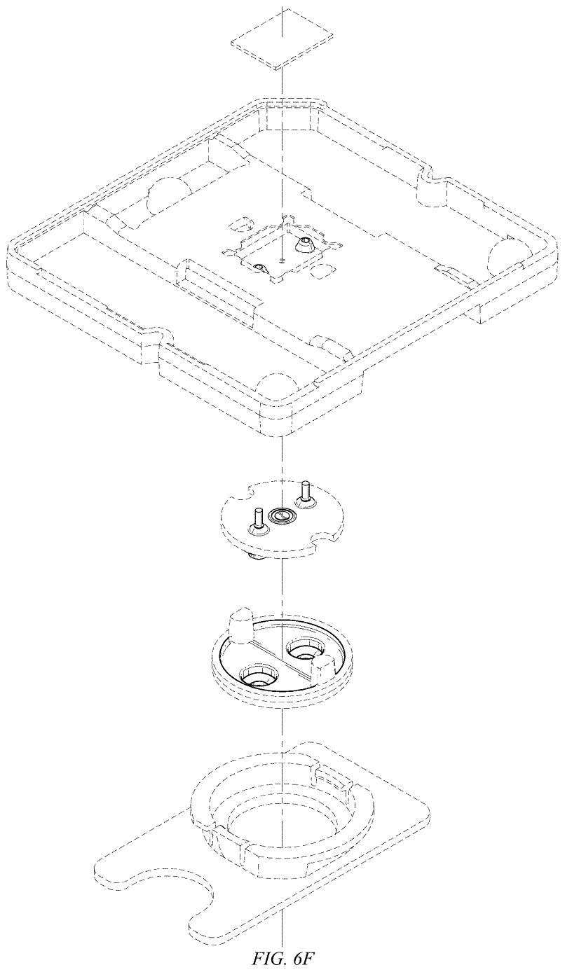

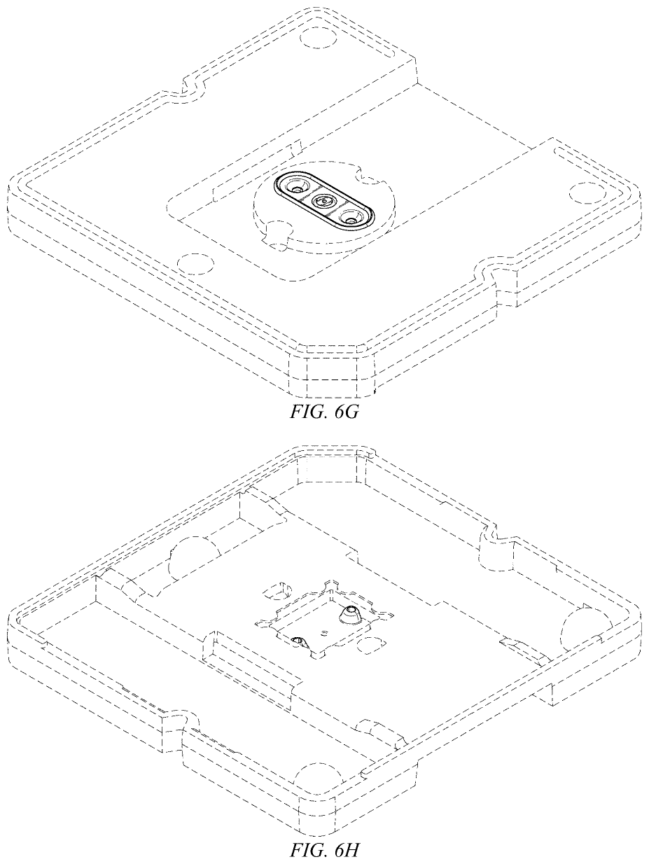

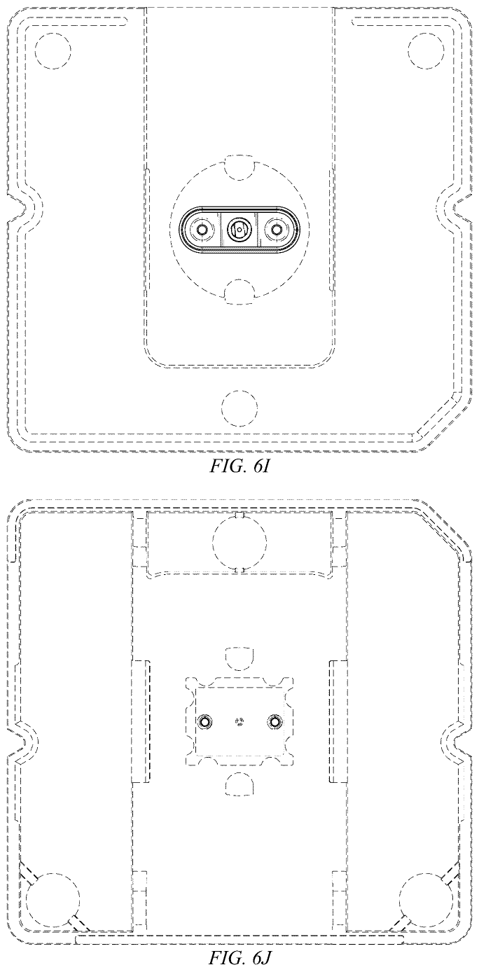

FIGS. 6A-6J show top and top isomeric views (FIGS. 6A, 6C, 6G, and 6I), bottom and bottom isomeric views (FIGS. 6B, 6D, 6H, and 6J), and exploded top and bottom views (FIGS. 6E and 6F) of a non-limiting embodiment of a cartridge for microscopy, such as fluorescent microscopy (e.g., OGM). In a closed configuration with a bottom cover detached (FIGS. 6H and 6J), electrodes can be seen. The top surface of the bottom cover can include one or more flow channels (FIG. 6E). In the embodiment depicted, the electrodes can be solid electrodes (also referred to herein as pins). In the embodiment depicted, the cartridge can include a seal, which can have an overmolded TPE material, such as an overmolded versaflex seal (the middle piece in FIG. 6E, which is shown with electrodes attached).

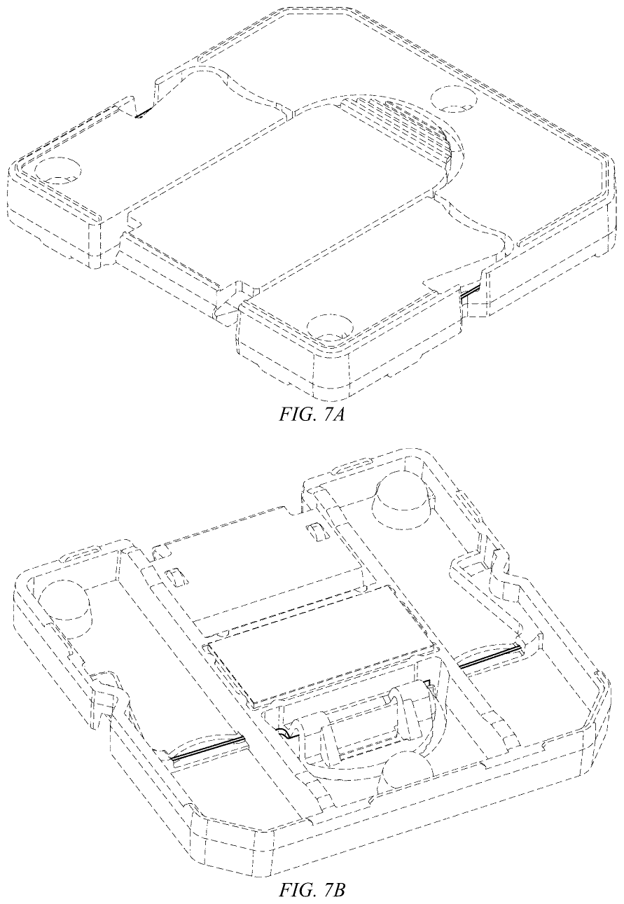

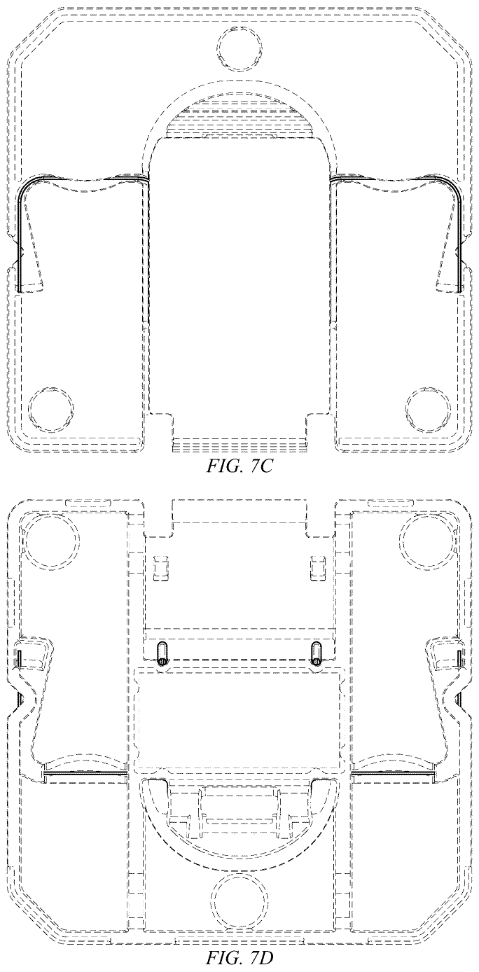

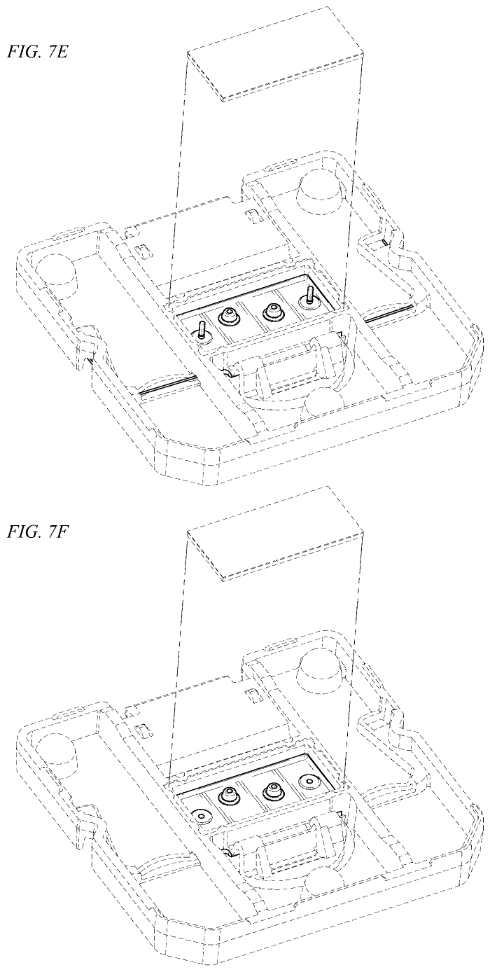

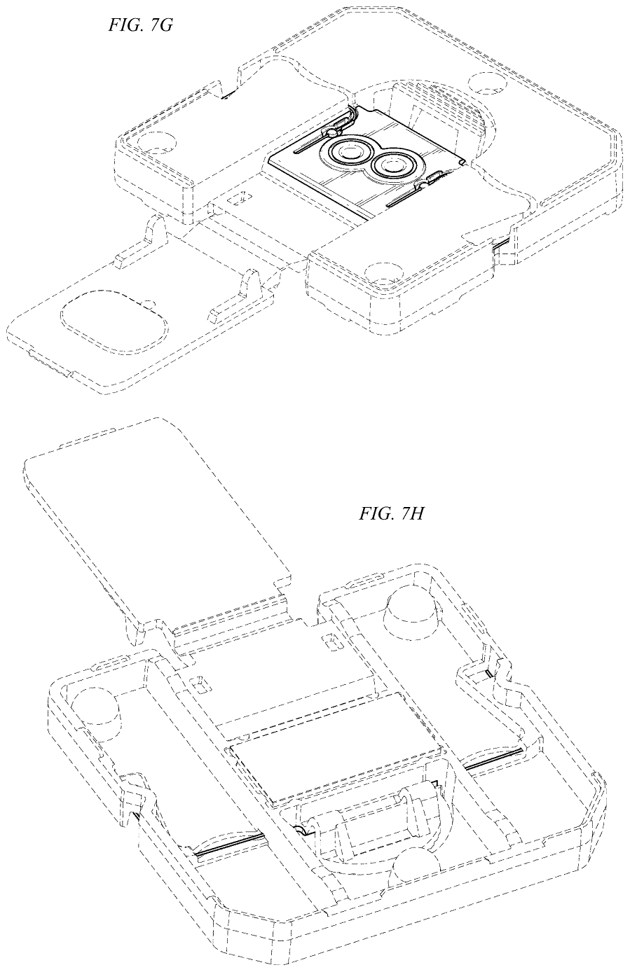

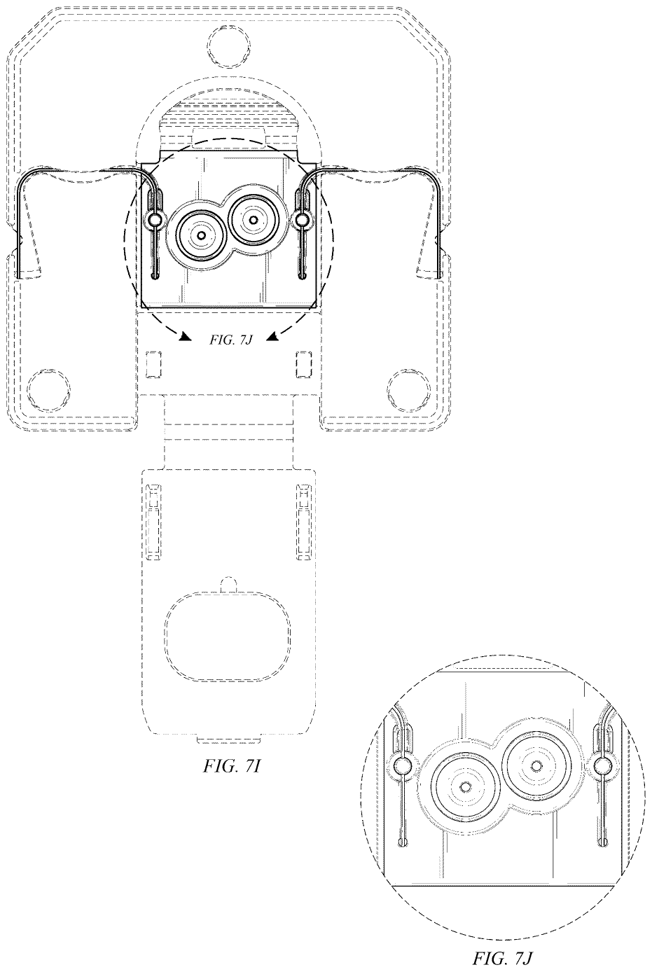

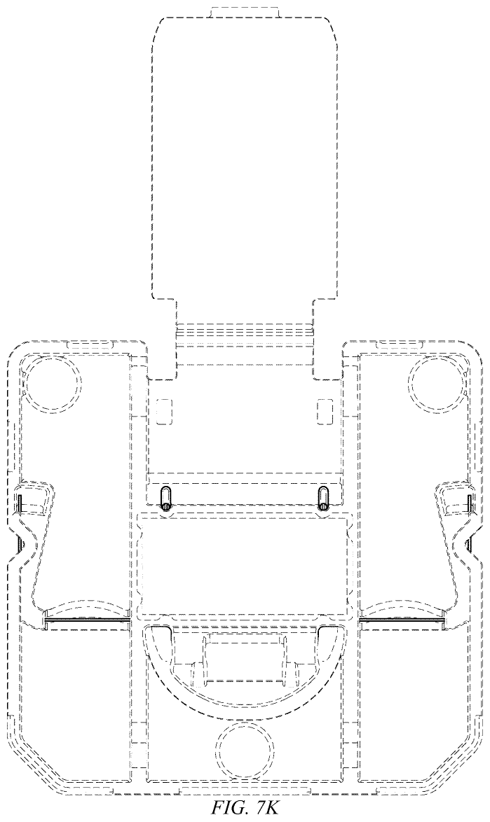

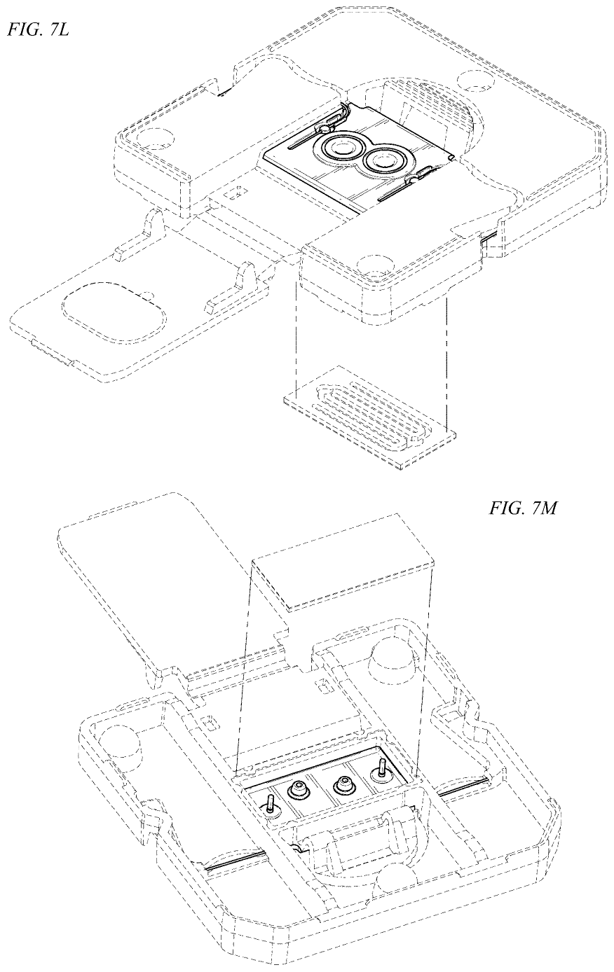

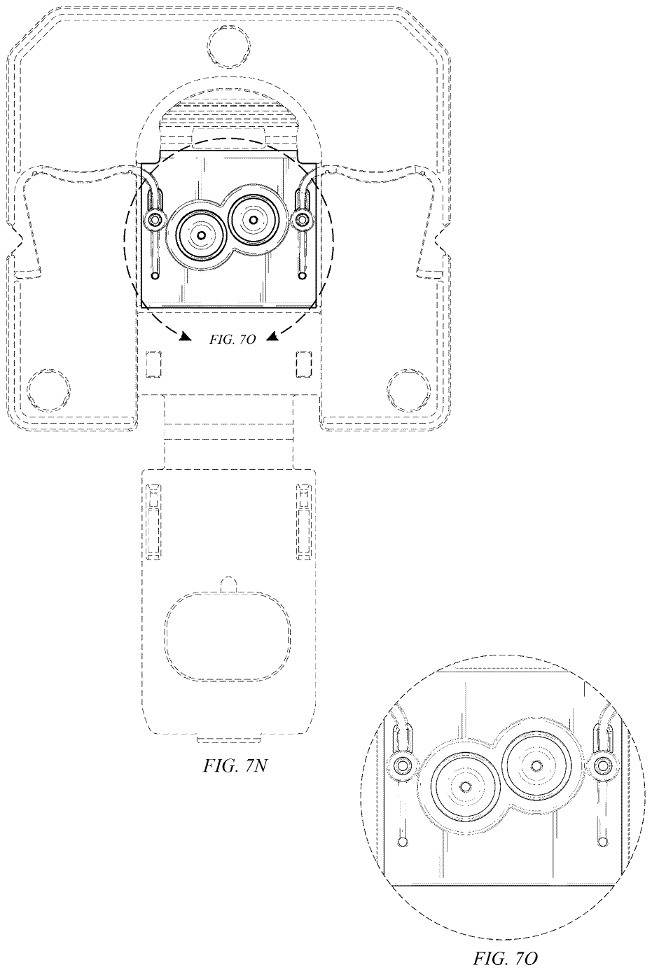

FIGS. 7A-7O show top and top isomeric views (FIGS. 7A, 7C, 7G, 7I, 7J, 7N, and 7O), bottom and bottom isomeric views (FIGS. 7B, 7D, 7H, and 7K), exploded top and bottom views (FIGS. 7E, 7F, 7L, and 7M), an open configuration (FIGS. 7G-7O), and a closed configuration (FIGS. 7A-7F) of a non-limiting embodiment of a cartridge for microscopy, such as fluorescent microscopy (e.g., OGM). In a closed configuration (FIG. 7E) and an open configuration (FIG. 7M) with a bottom cover detached, electrodes can be seen. The top surface of the bottom cover can include one or more flow channels (FIG. 7L). In the embodiment depicted, the electrodes can be solid electrodes (also referred to herein as pins). In the embodiment shown, wires (solid lines in FIGS. 7A-7D) can be used for electrical connectivity to an instrument, such as an OGM instrument. The cartridge depicted in FIGS. 7F, 7N, and 7O (compare these figures to FIGS. 7E, 7I, and 7J)) do not include electrodes and wires. In the embodiment depicted, the cartridge can include a seal, which can have an overmolded TPE material, such as an overmolded versaflex seal (which can have an oral shape as shown in FIGS. 7G, 7I, 7M, and 7N).

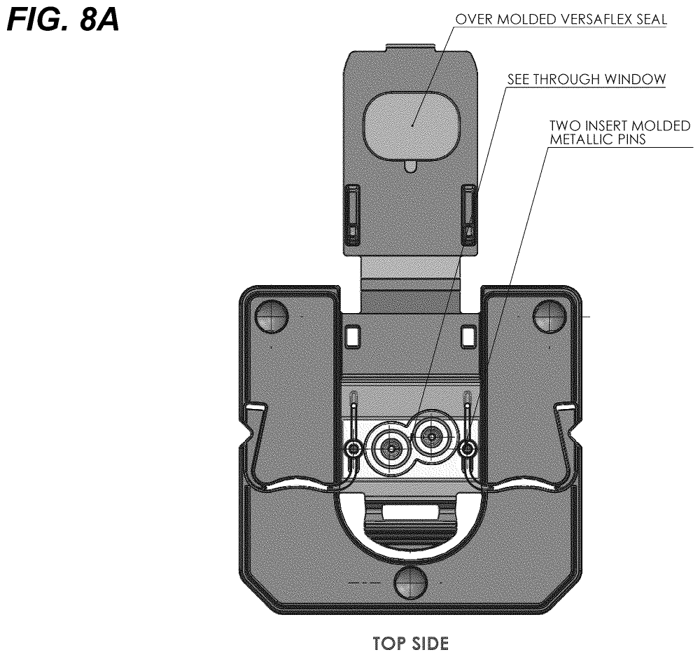

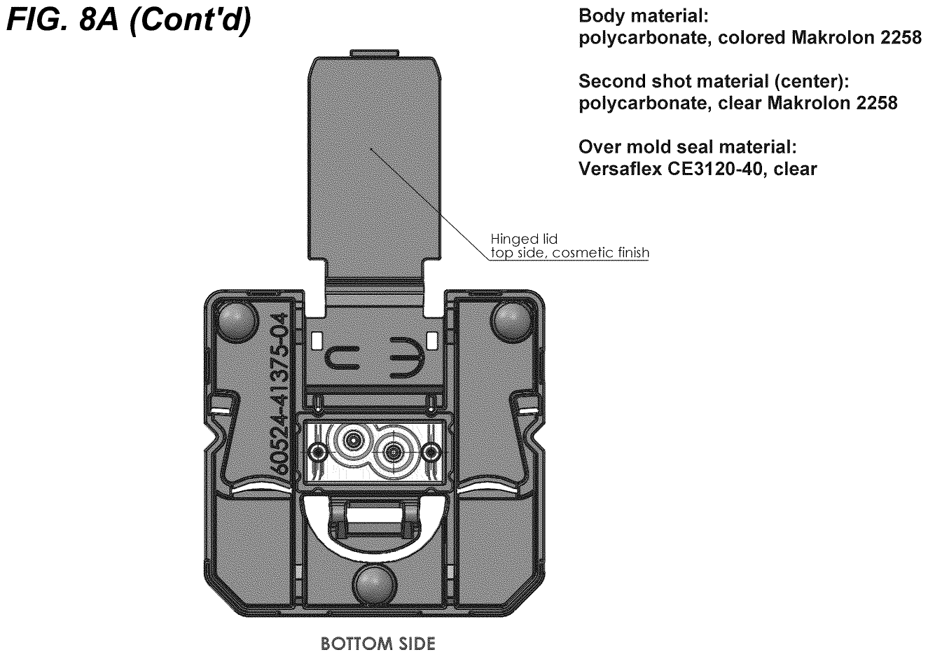

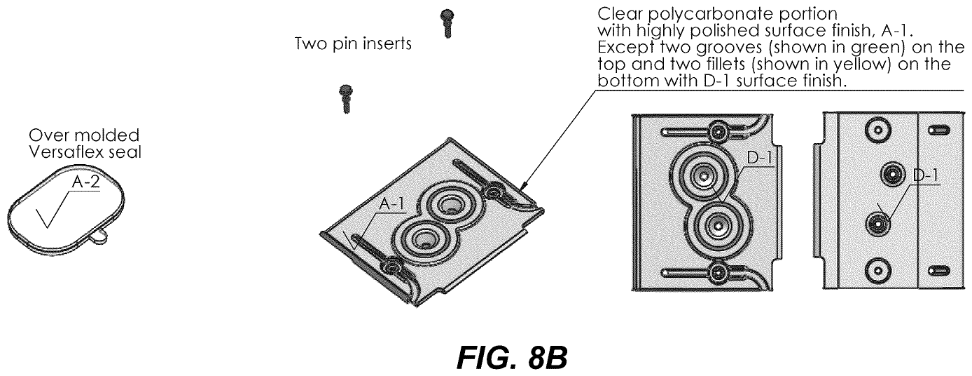

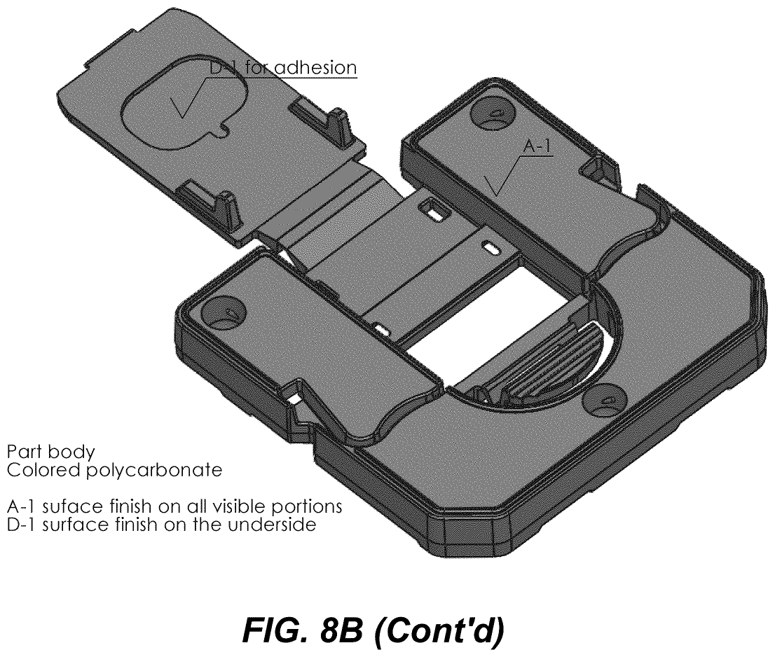

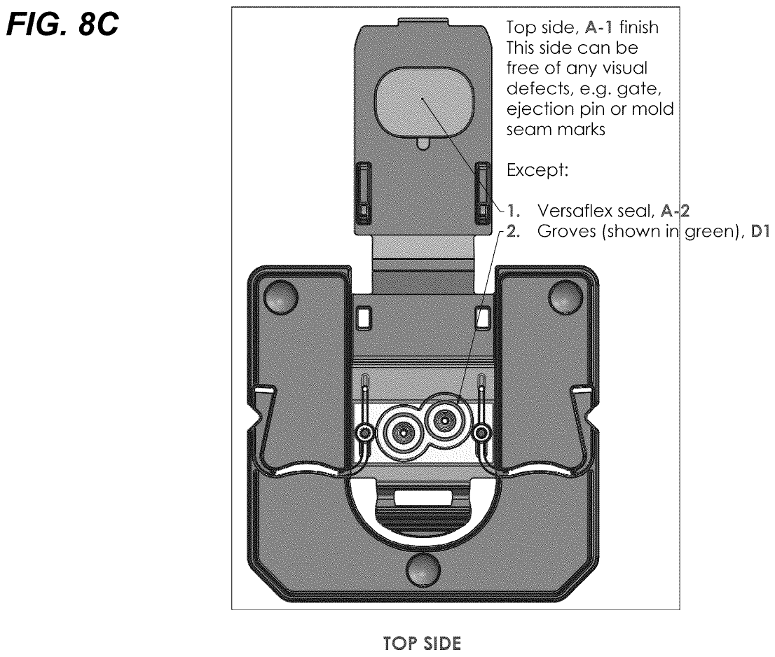

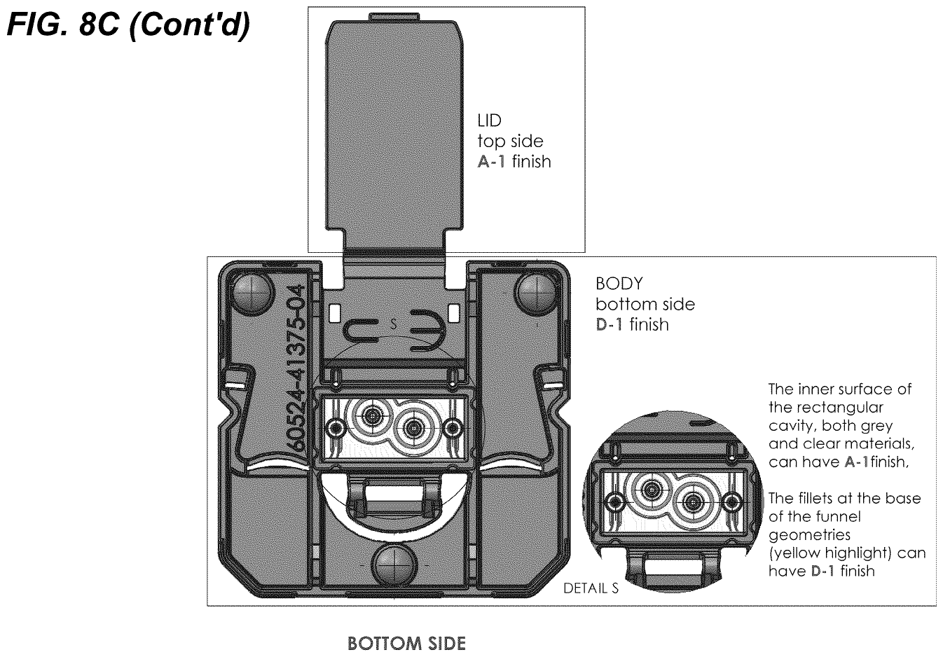

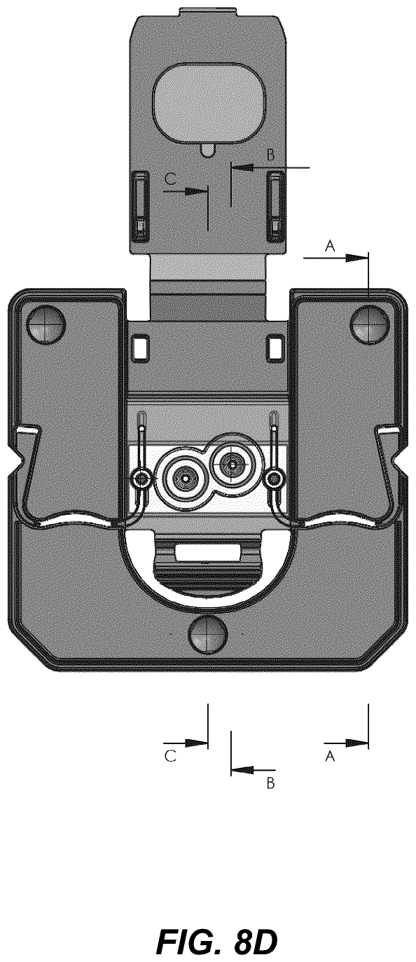

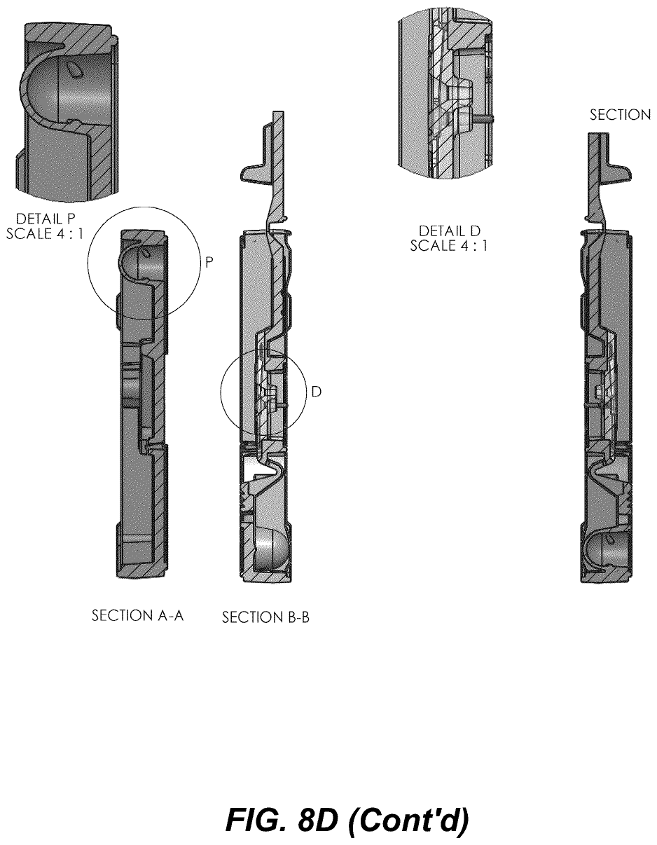

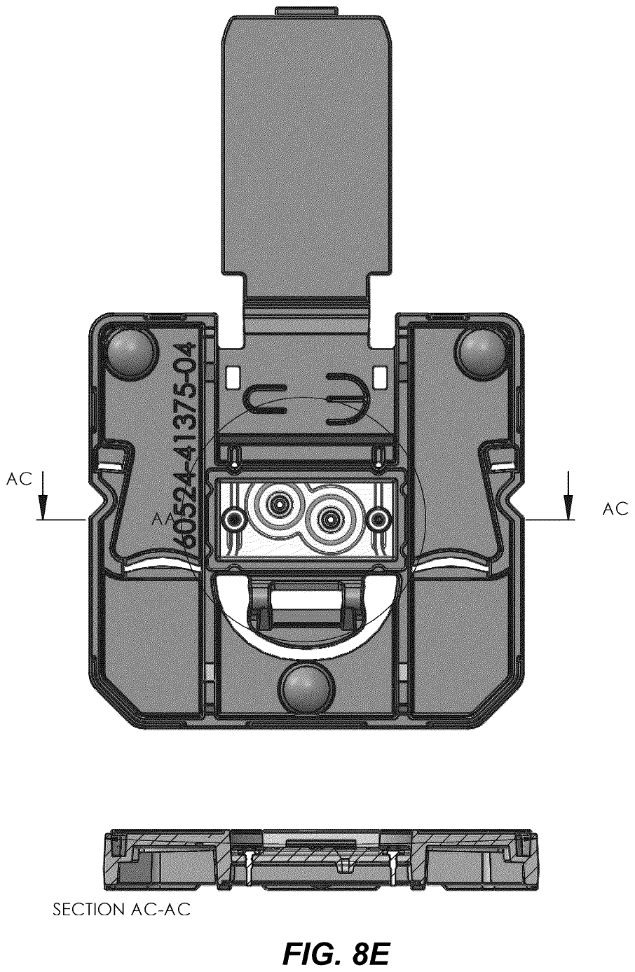

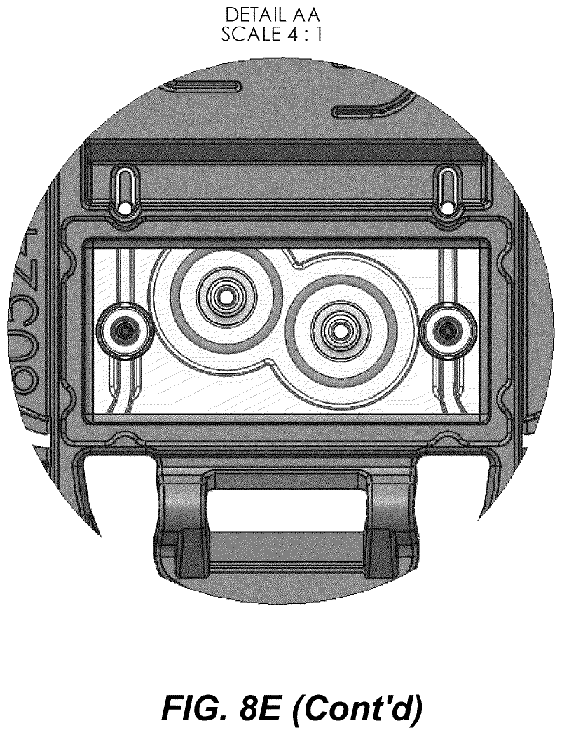

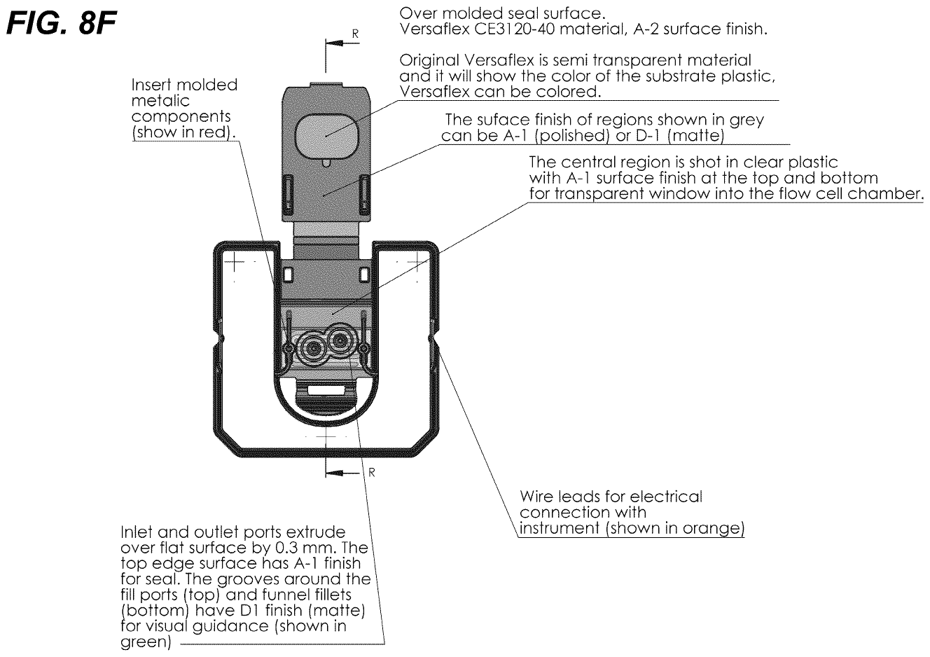

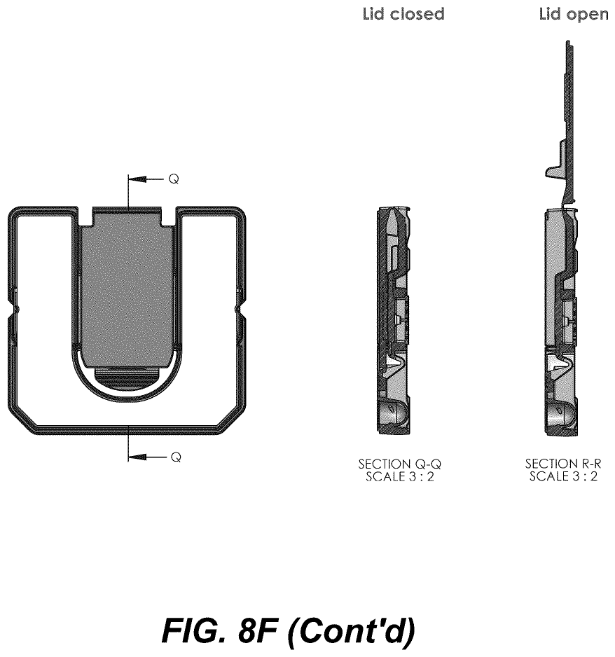

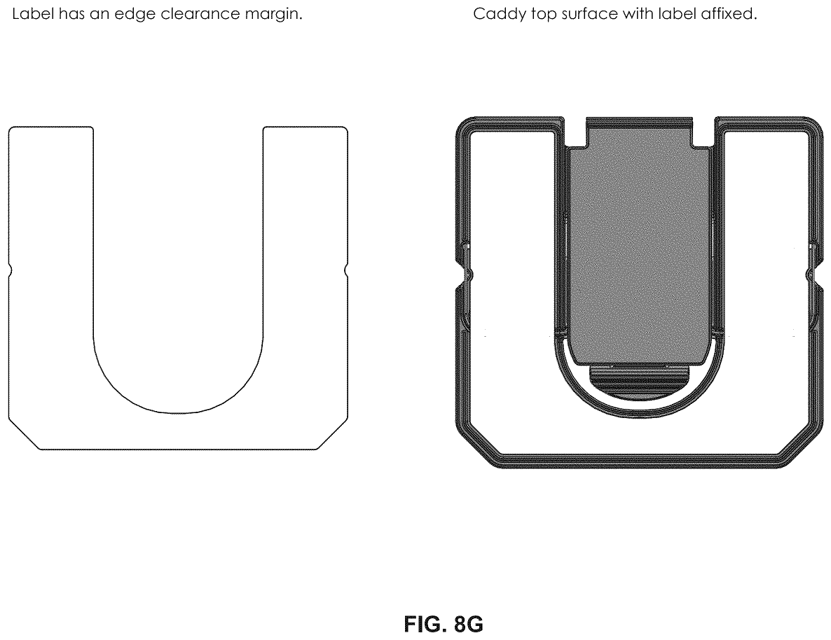

FIGS. 8A-8G illustrate non-limiting exemplary embodiments of a cartridge described herein (e.g., the embodiment of the cartridge depicted in FIGS. 7A-7O) and components of the cartridge.

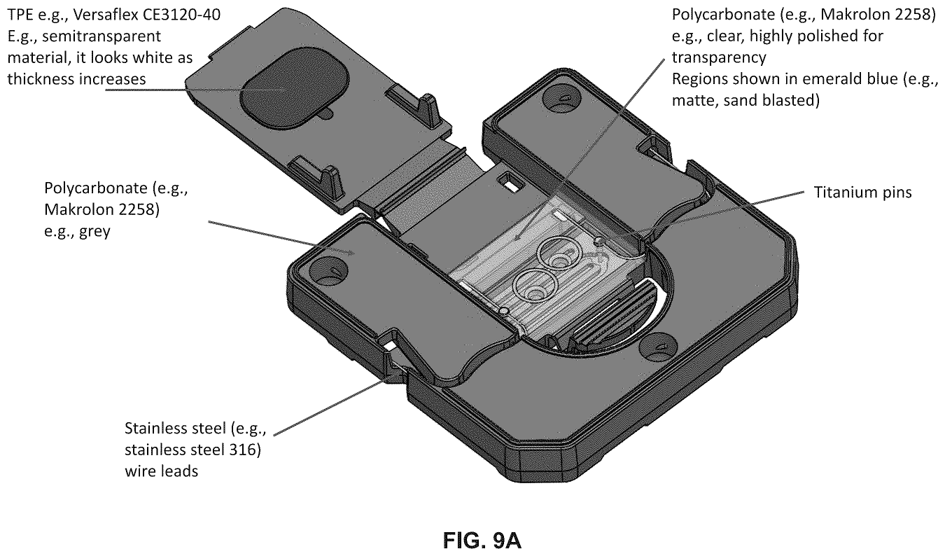

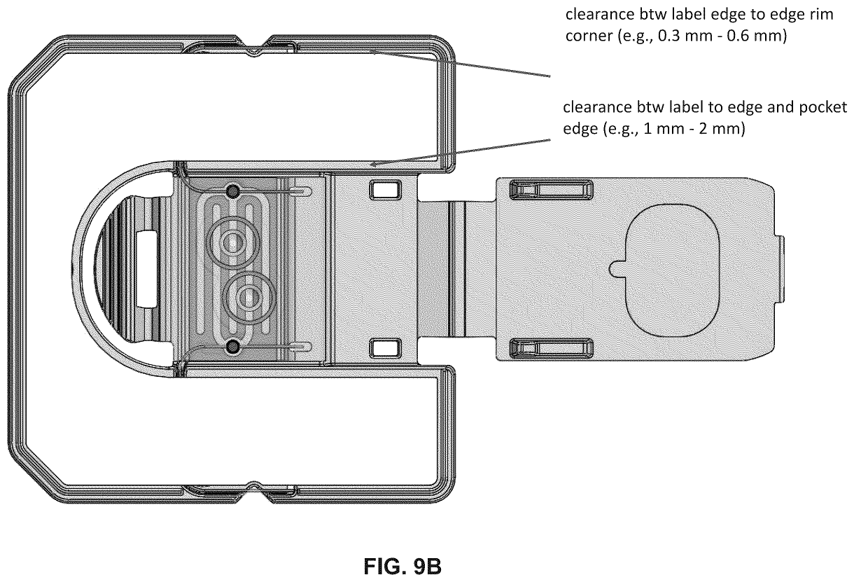

FIGS. 9A-9B depict a non-limiting embodiment of a cartridge described herein (e.g., the embodiments of the cartridge depicted in FIGS. 7A-7O and/or FIGS. 8A-8G): top isomeric view and open configuration without a label (FIG. 9A) and top view and open configuration with a label (FIG. 9B).

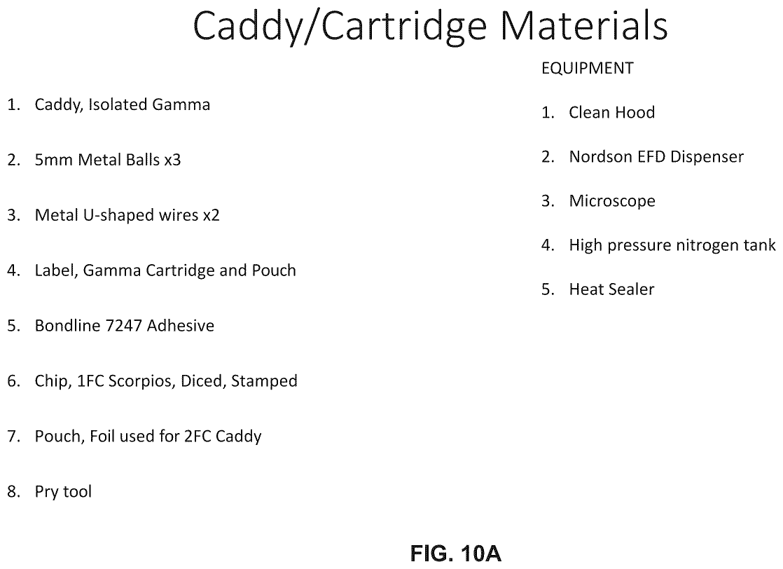

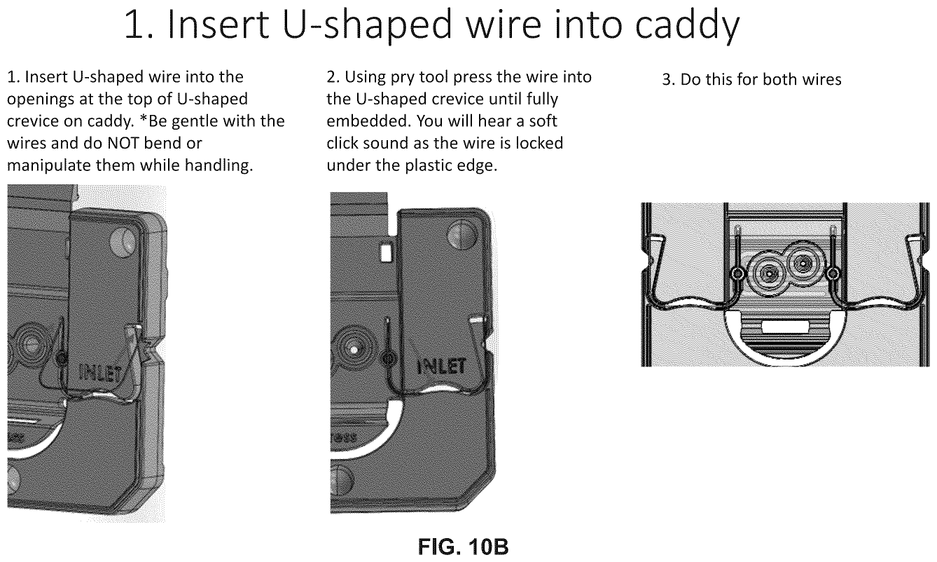

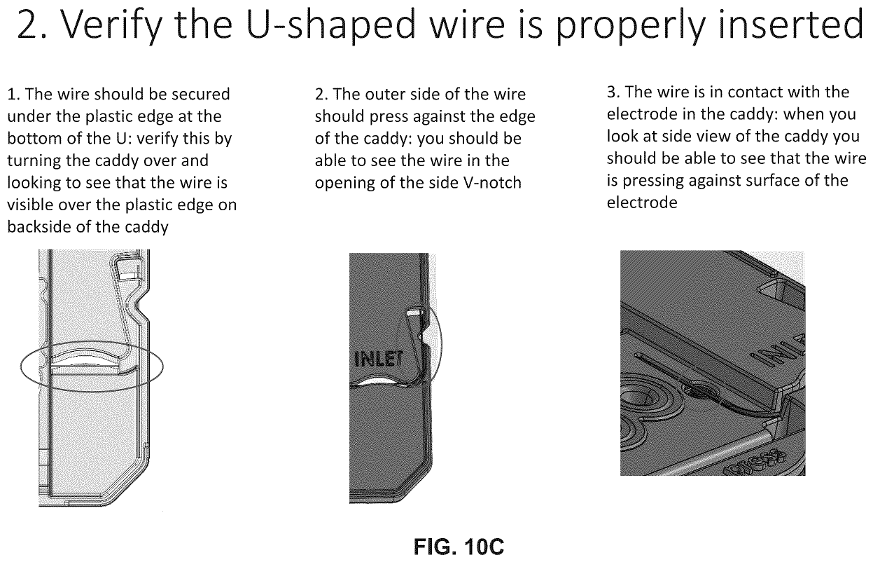

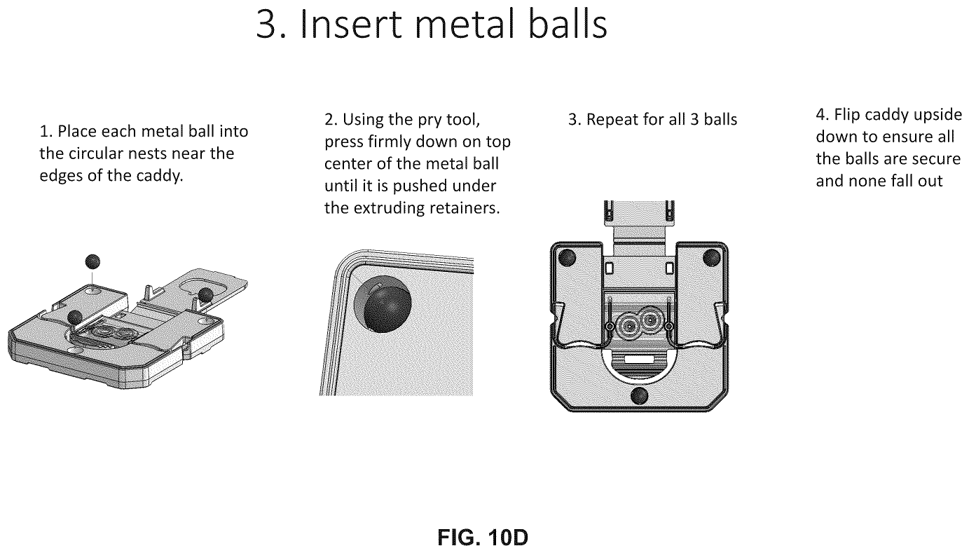

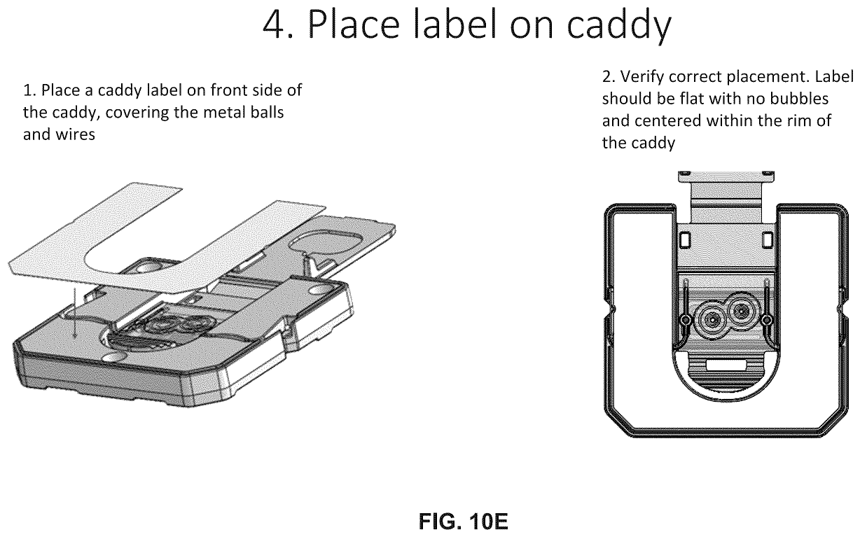

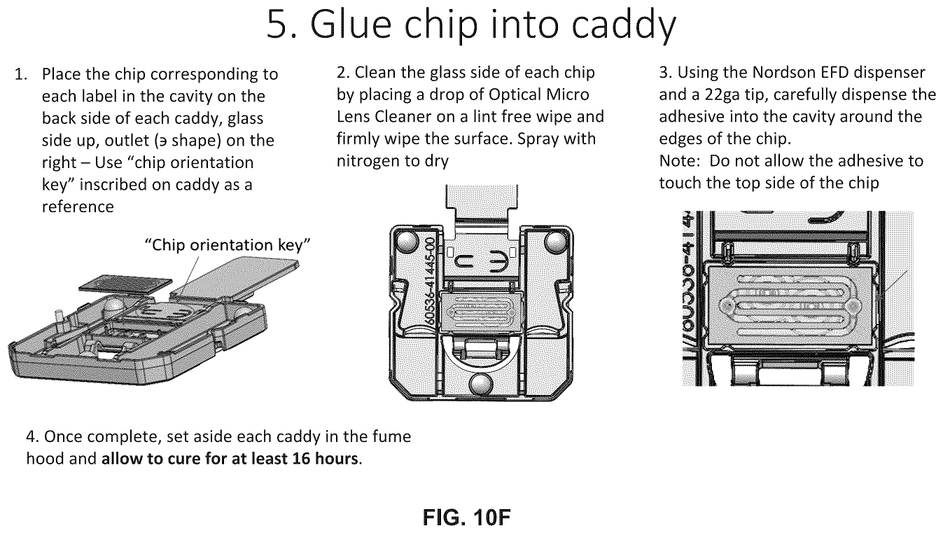

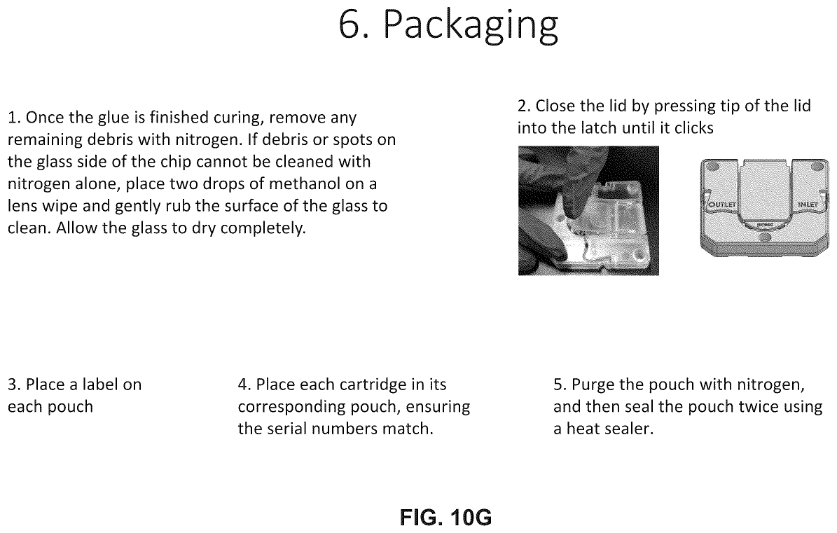

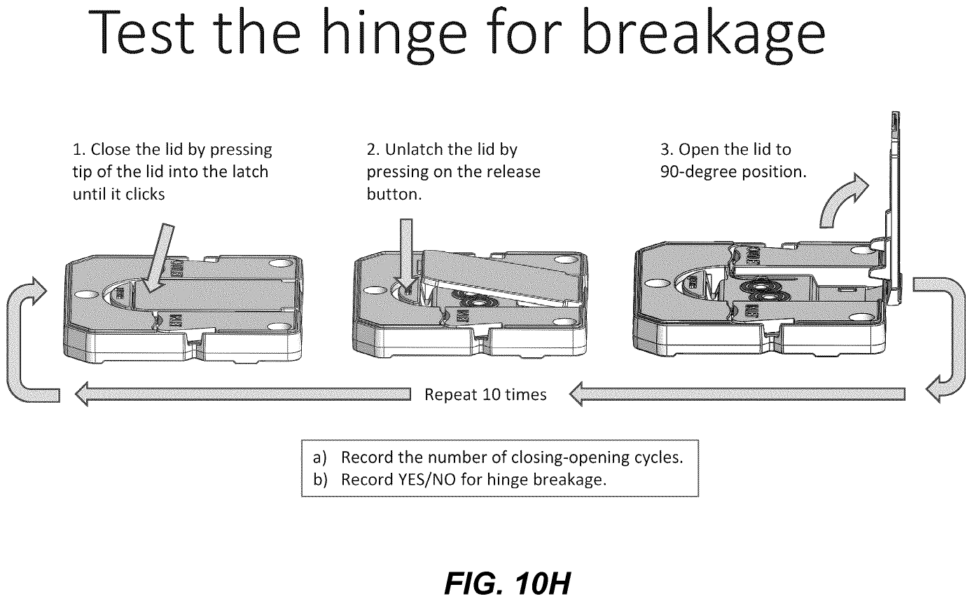

FIGS. 10A-10H illustrates a non-limiting exemplary process of cartridge assembly (e.g., the embodiments of the cartridge depicted in FIGS. 7A-7O, FIGS. 8A-8G, and/or FIGS. 9A-9B).

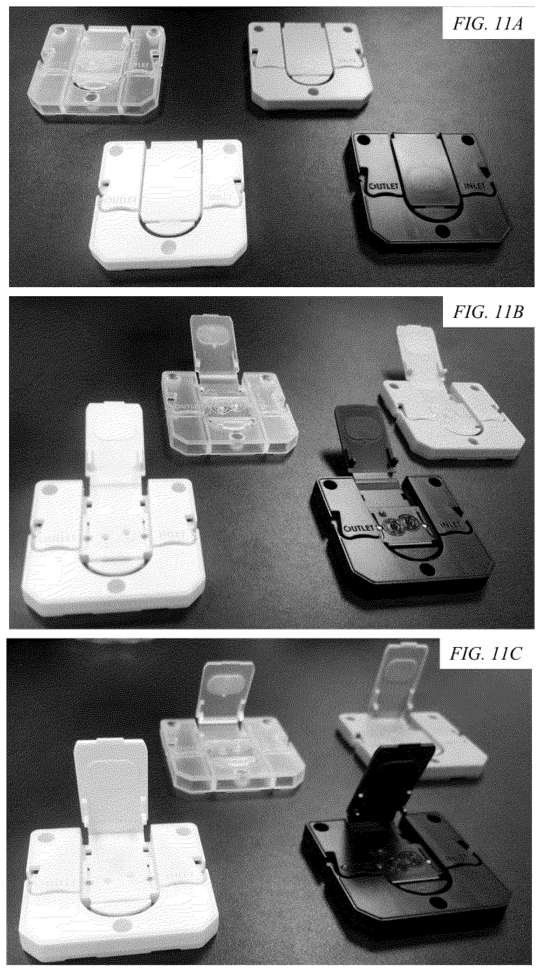

FIGS. 11A-11C depict a non-limiting embodiment of a cartridge described herein (e.g., the embodiments of the cartridge depicted in FIGS. 7A-7O, FIGS. 8A-8G, FIGS. 9A-9B, and/or FIGS. 10A-10H): a close configuration (FIG. 11A) and closed configurations (FIGS. 11B-11C).

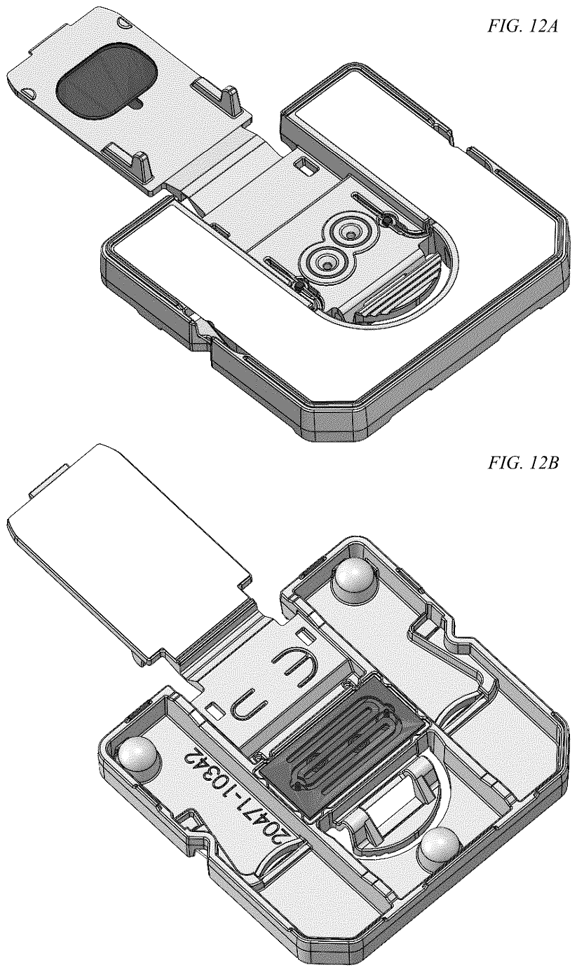

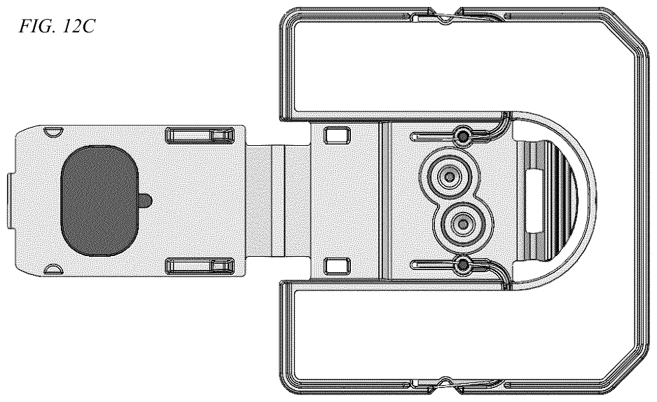

FIGS. 12A-12C depict a non-limiting embodiment of a cartridge described herein. Relative to the embodiments of the cartridge depicted in FIGS. 7A-7O, FIGS. 8A-8G, FIGS. 9A-9B, FIGS. 10A-10H, and/or FIGS. 11A-11C, the cartridge shown in FIGS. 12A-12C can include two extrusions (e.g., half-moon shaped extrusions). The two extrusions can be in contact with the wires and/or maintain the wires in contact with the base when the cartridge is in a closed configuration. A flow cell orientation key is shown in FIG. 12B.

### Cartridge Embodiments

Disclosed herein include cartridges, such as cartridges for microscopy, such as fluorescent microscopy (e.g., optical genome mapping). In some embodiments, a cartridge comprises a hermetic seal capable of preventing (or minimizing) evaporation of a liquid sample. In some embodiments, the prevention of evaporation can be at least or at least about 24 hours, 48 hours, 72 hours, 100 hours, 125 hours, 150 hours, 175 hours, 200 hours, 250 hours, 300 hours, 350 hours, 400 hours, 450 hours, 500 hours, 600 hours, 700 hours, 800 hours, 900 hours, 1000 hours. or more.

In some embodiments, the liquid sample comprises a biological sample. In some embodiments, the biological sample comprises one or more analytes. The analytes can comprise nucleic acid. The nucleic acid can be DNA. In some embodiments, the DNA is high molecular weight DNA, such as DNA that is at least 1 Mb, 1.25 Mb, 1.5 Mb, 1.75 Mb, or 2 Mb in length.

In some embodiments, the cartridge (or one or more components thereof, such as the base and the lid of the cartridge) comprises a polymer, a polycarbonate, a plastic, or a combination thereof. In some embodiments, the cartridge comprises a flow cell and one or more electrodes fluidically connected with the flow cell. For example, (a part of) an electrode can be present in the flow cell which allows (the part of) the electrode to contact the fluid that may be present in the flow cell when the cartridge is in use (or when the flow cell contains liquid). In some embodiments, the one or more electrodes comprise titanium and/or are titanium electrodes. In some embodiments, the one or more electrodes are insert molded.

In some embodiments, the one or more electrodes are fluidically connected (or in fluidic connection) to the flow cell when the cartridge is in a closed configuration. In some embodiments, the one or more electrodes are fluidically connected to the flow cell when the cartridge is in an open configuration. In some embodiments, the one or more electrodes are fluidically connected to the flow cell when the cartridge is both in a closed configuration and an open configuration. In some embodiments, the one or more electrodes are fluidically connected to the flow cell when the cartridge is in a closed configuration and not in an open configuration. In some embodiments, the one or more electrodes prevent (or minimize) evaporation.

In some embodiments, the one or more electrodes allow the liquid sample to be loaded into the flow cell. In some embodiments, the one or more electrodes comprise at least one hollow electrode. In some embodiments, the one or more electrodes are hollow electrodes. In some embodiments, the one or more electrodes are one or more loading ports for the liquid sample. In some embodiments, the one or more electrodes are for (or configured as) one or more loading ports for the liquid sample. In some embodiments, the one or more electrodes are sealed off with a thermoplastic elastomer (TPE) seal (e.g., a Versaflex seal) to prevent (or minimize) evaporation when the cartridge is in a closed configuration.

In some embodiments, the one or more electrodes comprise at least one solid electrode. In some embodiments, the one or more electrodes are solid electrodes. In some embodiments, the cartridge comprises one or more loading ports (which are not or are different from the one or more electrodes) for the liquid sample. In some embodiments, the one or more loading ports are sealed off with a thermoplastic elastomer (TPE) seal to prevent (or minimize) evaporation when the cartridge is in a closed configuration.

In some embodiments, the hermetic seal is formed by contacting the electrodes and a thermoplastic elastomer (TPE) seal. In some embodiments, the hermetic seal is formed by the loading ports and a thermoplastic elastomer (TPE) seal. The TPE seal can be an overmolded seal.

Disclosed herein include cartridges, such as cartridges for microscopy, such as fluorescent microscopy (e.g., optical genome mapping). In some embodiments, a cartridge comprises: a caddy (e.g., FIGS. 7A-7O, 8A-8G, 9A-9B, 10A-10H, 11A-11C, and 12A-12C). The cartridge can comprise a flow cell. A caddy can comprise a base (or a body or a lower body or a bottom body) and a lid. The base can comprise a central region (or a central part or a central piece; e.g., FIG. 8F). The central region can comprise one or more loading ports (e.g., two loading ports). The central region can comprise one or more electrodes (e.g., two electrodes). The one or more electrodes can be fluidically connected (or in fluidic connection) to the flow cell when the cartridge is both in a closed configuration and an open configuration. For example, (a part of) an electrode can be present in the flow cell which allows (the part of) the electrode to contact the fluid that may be present in the flow cell when the cartridge is in use (or when the flow cell contains liquid). The lid can comprise a seal. The seal and the one or more loading ports can form a hermetic seal when the caddy is in a closed configuration. The seal and the one or more loading ports can be capable of forming a hermetic seal when the caddy is in a closed configuration. The cartridge can comprise a flow cell.

Disclosed herein include cartridges, such as cartridges for microscopy, such as fluorescent microscopy (e.g., optical genome mapping). In some embodiments, a cartridge comprises: a caddy (e.g., FIGS. 1A-1I, 2A-2C, 4A-4K, 5A-5E, 6A-6J, 7A-7O, 8A-8G, 9A-9B, 10A-10H, 11A-11C, and 12A-12C). The caddy can comprise a base (or a body or a lower body or a bottom body) and a lid (or a top body). The base can comprise one or more loading ports (e.g., 2 loading ports). The base can comprise one or more electrodes (e.g., 2 eletrodes). The lid can comprise a seal. The seal and the one or more loading ports can form a hermetic seal when the cartridge is in a closed configuration. The cartridge can comprise a flow cell. In some embodiments, the base comprises a central region (or a central part of a central piece; e.g., FIG. 8F) comprising the one or more loading ports and the one or more electrodes.

In some embodiments, the lid is connected to the base. In some embodiments, the lid comprises a hinged lid connected to the base (e.g., FIGS. 1A-1I, 2A-2C, 7A-7O, 8A-8G, 9A-9B, 10A-10H, 11A-11C, and 12A-12C). In some embodiments, the lid is not connected to the base (e.g., FIGS. 4A-4K, 5A-5E, and 6A-6J,). In some embodiments, the lid is in contact with the base when the cartridge is in a closed configuration, not when the cartridge is in an open configuration. In some embodiments, the lid is in contact with the base when the cartridge is in a closed configuration and when the cartridge is in an open configuration.

In some embodiments, the one or more loading ports are for loading a liquid sample. In some embodiments, the seal and the one or more loading ports form a hermetic seal when the caddy is in a closed configuration. The seal and the one or more loading ports are capable of forming a hermetic seal when the caddy is in a closed configuration. The hermetic seal can prevent (or minimize) evaporation of a liquid sample loaded into the flow cell (or a sample loaded into the flow cell, or the content of the flow cell). The hermetic seal can be capable of preventing (or minimizing) evaporation of a liquid sample loaded into the flow cell (or a sample loaded into the flow cell, or the content of the flow cell). In some embodiments, the prevention (or minimization) of evaporation can be at least or at least about 24 hours, 48 hours, 72 hours, 100 hours, 125 hours, 150 hours, 175 hours, 200 hours, 250 hours, 300 hours, 350 hours, 400 hours, 450 hours, 500 hours, 600 hours, 700 hours, 800 hours, 900 hours, 1000 hours. or more.

In some embodiments, the liquid sample comprises a biological sample. In some embodiments, the biological sample comprises one or more analytes. The analytes can comprise nucleic acid. The nucleic acid can be DNA. In some embodiments, the DNA is high molecular weight DNA, such as DNA that is at least 1 Mb, 1.25 Mb, 1.5 Mb, 1.75 Mb, or 2 Mb in length.

In some embodiments, the base comprises two rounded edges (e.g., FIGS. 4A-4K, 5A-5E, 7A-7O, 8A-8G, 9A-9B, 10A-10H, 11A-11C, and 12A-12C). The number of round edges can be, for example, 1, 2, 3, or 4. The base can comprise two angled edges (e.g., FIGS. 4A-4K, 5A-5E, 7A-7O, 8A-8G, 9A-9B, 10A-10H, 11A-11C, and 12A-12C). The number of angled edges can be, for example, 1, 2, 3, or 4. The two rounded edges can be at a side of the base closer to the lid when the cartridge is in an open configuration. The two angled edges can be at a side of the base away from the lid when the cartridge is in an open configuration.

In some embodiments, the base comprises a polymer, a polycarbonate, a plastic, or a combination thereof. In some embodiments, the base other than the central region is not clear and/or not see through. In some embodiments, the base other than the central region is made in a first shot, and the central region is made in a second shot.

In some embodiments, the caddy comprises a polymer, a polycarbonate, a plastic, or a combination thereof. In some embodiments, the caddy other than the central region is not clear and/or not see through. In some embodiments, the caddy other than the central region and the seal is not clear and/or not see through. In some embodiments, the caddy other than the central region and the seal is made in a first shot, and the central region is made in a second shot.

In some embodiments, the central region comprises a polymer, a polycarbonate, a plastic, or a combination thereof. In some embodiments, the central region is clear and/or see through. In some embodiments, the central region comprises a groove corresponding to (or of or for) each of the one or more loading ports (e.g., FIGS. 8A and 8C). The groove can be on a top surface of the central region. The central region can comprises a fillet corresponding to (or of or for) each of the one or more loading ports (e.g., FIGS. 8A and 8C). The fillet can be on a bottom surface of the central region.

In some embodiments, the one or more loading ports comprise two loading ports. In some embodiments, the two loading ports (or all the loading ports) are identical in size and geometry. In some embodiments, a center of one of the one or more loading ports is on a line formed by the two of the one or more electrodes (on the top surface of the central region). In some embodiments, a center of one of the one or more loading ports (e.g., the inlet port) is not on a line formed by the two of the one or more electrodes (on the top surface of the central region) (e.g., FIG. 8A). In some embodiments, a center of one of the one or more loading ports (e.g., the outlet port) has an offset from a line formed by the two of the one or more electrodes (on the top surface of the central region) (e.g., FIG. 8A). In some embodiments, two (or each) of the one or more loading ports can be identical in shape (size and geometry).

In some embodiments, the one or more loading ports are funnel-shaped. In some embodiments, the one or more loading ports are sample funnels. In some embodiments, the one or more loading ports each has a size and a geometry to accept a pipette tip (e.g., a 5 μL, 10 μL, 15 μL, or 20 μL pipette tip). The one or more loading ports can have a shape to prevent (or minimize) introduction of air bubbles into the flow cell. In some embodiments, the one or more loading ports comprise an inlet port and an outlet port. In some embodiments, a loading port can be connected to a number of fingers, such as 2 or 3 fingers (e.g., FIGS. 4H, 5B, 5E, 6E, 7M, 8F, 9A, 9B, 10F, and 12B). For example, the inlet port can be connected to 2 fingers. For example, the outlet port can be connected to 3 fingers. In some embodiments, the one or more loading ports extrude over a top surface of the central region. The one or more loading ports can extrude over a top surface of the central region by, for example, (about) 0.1 mm, 0.15 mm, 0.2 mm, 0.25 mm, 0.3 mm, 0.35 mm, 0.4 mm, 0.45 mm, 0.5 mm, or a number or a range between any two of these values.

In some embodiments, the flow cell is formed by the base and a chip (or a flow cell chip). The chip can be inserted into to an opening at a bottom face of the base. The chip can be glued to the base. In some embodiments, the base comprises a chip orientation key on a bottom surface of the base (e.g., FIGS. 10F, 12B).

In some embodiments, the one or more electrodes comprise two electrodes. In some embodiments, the one or more electrodes comprise one or more pins. In some embodiments, the one or more electrodes do not extrude from a top surface of the central region (e.g., FIG. 10C). In some embodiments, the one or more electrodes comprise titanium and/or are titanium electrodes. In some embodiments, the one or more electrodes are insert molded.

In some embodiments, the one or more electrodes are fluidically connected (or in fluidic connection) to the flow cell when the cartridge is in a closed configuration. In some embodiments, the one or more electrodes are fluidically connected to the flow cell when the cartridge is in an open configuration. In some embodiments, the one or more electrodes are fluidically connected to the flow cell when the cartridge is both in a closed configuration and an open configuration. In some embodiments, the one or more electrodes are fluidically connected to the flow cell when the cartridge is in a closed configuration and not in an open configuration. In some embodiments, the one or more electrodes prevent (or minimize) evaporation.

In some embodiments, the one or more electrodes allow the liquid sample to be loaded into the flow cell. In some embodiments, the one or more electrodes comprise at least one hollow electrode (e.g., 2 hollow electrodes; e.g., FIGS. 1A-1G, 2A-2C, and 3). In some embodiments, the one or more electrodes are hollow electrodes. In some embodiments, the one or more electrodes are the one or more loading ports.

In some embodiments, the one or more electrodes comprises at least one solid electrode (e.g., 2 solid electrodes; e.g., FIGS. 4A-4K, 5A-5E, 7A-7O, 8A-8G, 9A-9B, 10A-10H, 11A-11C, and 12A-12C). In some embodiments, the one or more electrodes are solid electrodes.

In some embodiments, the seal comprises a thermoplastic elastomer (TPE) seal (e.g., a Versaflex seal). In some embodiments, the seal is overmolded. In some embodiments, the seal is oval in shape. The seal can be rectangular in shape. The seal can have rounded edges. The seal can have a tab (e.g., FIGS. 8A-8D, 8F, 9A, 9B, 11A-11C, 12A and 12C).

In some embodiments, the base, the lid, the seal, and the electrodes are one piece. For example, the seal can be overmolded. The electrodes can be insert molded. The base and the lid can be made by the first shot in an injection molding process, and the central region can be made by the second shot in the injection molding process.

In some embodiments, the lid comprises one or more electrical connections for contacting the one or more electrodes (e.g., FIGS. 1A-1I, 4A-4K, 5A-5E, and 6A-6J). The one or more electrical connections can extrude from a top surface of the lid. The one or more electrical connections may not extrude from a top surface of the lid. The one or more electrical connections may not be exposed at a top surface of the lid. For example, the one or more electrical connections cannot be contacted with electrically at a top surface of the lid. The one or more electrical connections can comprise one or more pins.

In some embodiments, when the cartridge is in an open configuration, the one or more electrical connections are not in contact with the corresponding one or more electrodes. When the cartridge is in a closed configuration, the one or more electrical connections can be in contact with the corresponding one or more electrodes. In some embodiments, when the cartridge is in both an open configuration and a closed configuration, the one or more electrical connections are in contact with the corresponding one or more electrodes. In some embodiments, the one or more electrical connections is each in contact with a wire. The wire can be on or in the lid. The wire can be U-shaped. In some embodiments, the cartridge comprises one or more wires in contact with the one or more electrodes at a bottom surface of the base.

In some embodiments, the cartridge comprises one or more wires in contact with the one or more electrodes. For each of the one or more electrodes, a wire of the cartridge can be in contact with the electrode. Each wire can be in contact with a top of the corresponding electrode (e.g., FIGS. 1B-10C). An end of the wire (or the wire towards one end) can be in contact with the corresponding electrode. The other end of the wire (or the wire towards the other end) can be for contacting an electrical source. The other end of the wire (or the wire towards the other end) can for contacting an electrical source at a notch of the base. In some embodiments, each wire is U-shaped. A (vertical) side of the U-shaped wire can be in contact with the corresponding electrode (e.g., FIGS. 9A-9B). The other (vertical) side of the U-shaped wire can be for contacting an electrical source, e.g., at a notch of the base (e.g., FIGS. 9A-9B). The base can comprise a crevice (e.g., FIGS. 8A-8G, and 9A-9B; e.g., a U-shaped crevice) for embedding the wire (e.g., a U-shaped wire). In some embodiments, the one or more wires comprise stainless steel and/or are stainless steel wires.

In some embodiments, the base comprises one or more notches. The one or more notches corresponding to the one or more wires (one notch per wire; e.g., FIGS. 4A-4K, 5A-5E, 7A-7O, 8A-8G, 9A-9B, 10A-10H, 11A-11C, and 12A-12C). The one or more notches can comprise V-notches (or be V-shaped). Each of the one or more notches can be at a different side of the base. Each of two of the one or more notches can be on the opposite sides of the base. The one or more wires can be exposed at the corresponding one or more notches. The one or more wires can be contacted (or contactable) at the corresponding one or more notches.

In some embodiments, the base comprises a latch (e.g., FIGS. 7A-7O, 8A-8G, 9A-9B, 10A-10H, 11A-11C, and 12A-12C). The base can comprise a release button (e.g., FIGS. 7A-7O, 8A-8G, 9A-9B, 10A-10H, 11A-11C, and 12A-12C). When the cartridge is in a closed configuration, a tip of the lid can be inserted into the latch to secure (or releasably secure) the lid to the base to form the hermetic seal. When the cartridge is in a closed configuration, a tip of the lid can released from the latch when the release button is depressed (or by depressing the release button). The cartridge can change from an open configuration to a closed configuration by inserting a tip of the lid into the latch to secure (or releasably secure) the lid to the base to form the hermetic seal.

In some embodiments, the lid comprises one or more extrusions (e.g., FIGS. 12A and 12B). An extrusion can be half-moon shaped (or oval shaped or rectangular shape or square shape). When the cartridge is in a closed configuration, an extrusion can be in contact with a wire to maintain contact of the wire with the base.

In some embodiments, the base comprises at least three nests (e.g., FIGS. 1A-1I, 2A-2C, 4A-4K, 5A-5E, 6A-6J, 7A-7O, 8A-8G, 9A-9B, 10A-10H, 11A-11C, and 12A-12C). The nests can comprise circular nests. Each of the three nests can comprise at least one extruding retainer (e.g., 1, 2, 3, or more, extruding retainers). In some embodiments, the cartridge comprises a metal ball inserted into each of the nest (e.g., FIG. 10D). In some embodiments, the base comprises a label on a top surface of the base. The label can cover the at least three nests.

In some embodiments, the base is, is about, is at least, is at least about, is at most, or is at most about, 35 mm, 36 mm, 37 mm, 38 mm, 39 mm, 40 mm, 41 mm, 42 mm, 43 mm, 44 mm, 45 mm, 46 mm, 47 mm, 48 mm, 49 mm, 50 mm, 51 mm, 52 mm, 53 mm, 54 mm, 55 mm, 56 mm, 57 mm, 58 mm, 59 mm, 60 mm, 61 mm, 62 mm, 63 mm, 64 mm, 65 mm, 66 mm, 67 mm, 68 mm, 69 mm, 70 mm, 71 mm, 72 mm, 73 mm, 74 mm, 75 mm, or a number or a range between any two of these values, in width. The base can be, be about, be at least, be at least about, be at most, or be at most about, 35 mm, 36 mm, 37 mm, 38 mm, 39 mm, 40 mm, 41 mm, 42 mm, 43 mm, 44 mm, 45 mm, 46 mm, 47 mm, 48 mm, 49 mm, 50 mm, 51 mm, 52 mm, 53 mm, 54 mm, 55 mm, 56 mm, 57 mm, 58 mm, 59 mm, 60 mm, 61 mm, 62 mm, 63 mm, 64 mm, 65 mm, 66 mm, 67 mm, 68 mm, 69 mm, 70 mm, 71 mm, 72 mm, 73 mm, 74 mm, 75 mm, or a number or a range between any two of these values, in length. The base can be, be about, be at least, be at least about, be at most, or be at most about, 4 mm, 4.1 mm, 4.2 mm, 4.3 mm, 4.4 mm, 4.5 mm, 4.6 mm, 4.7 mm, 4.8 mm, 4.9 mm, 5 mm, 5.1 mm, 5.2 mm, 5.3 mm, 5.4 mm, 5.5 mm, 5.6 mm, 5.7 mm, 5.8 mm, 5.9 mm, 6 mm, 6.1 mm, 6.2 mm, 6.3 mm, 6.4 mm, 6.5 mm, 6.6 mm, 6.7 mm, 6.8 mm, 6.9 mm, 7 mm, 7.1 mm, 7.2 mm, 7.3 mm, 7.4 mm, 7.5 mm, 7.6 mm, 7.7 mm, 7.8 mm, 7.9 mm, 8 mm, or a number or a range between any two of these values, in thickness (e.g., thickest part).

In some embodiments, the lid is, is about, is at least, is at least about, is at most, or is at most about, 10 mm, 11 mm, 12 mm, 13 mm, 14 mm, 15 mm, 16 mm, 17 mm, 18 mm, 19 mm, 20 mm, 21 mm, 22 mm, 23 mm, 24 mm, 25 mm, 26 mm, 27 mm, 28 mm, 29 mm, 30 mm, or a number or a range between any two of these values, in width. The lid can be, be about, be at least, be at least about, be at most, or be at most about, 15 mm, 16 mm, 17 mm, 18 mm, 19 mm, 20 mm, 21 mm, 22 mm, 23 mm, 24 mm, 25 mm, 26 mm, 27 mm, 28 mm, 29 mm, 30 mm, 31 mm, 32 mm, 33 mm, 34 mm, 35 mm, 36 mm, 37 mm, 38 mm, 39 mm, 40 mm, 41 mm, 42 mm, 43 mm, 44 mm, 45 mm, 46 mm, 47 mm, 48 mm, 49 mm, 50 mm, 51 mm, 52 mm, 53 mm, 54 mm, 55 mm, or a number or a range between any two of these values, in length. The lid can be, be about, be at least, be at least about, be at most, or be at most about, 1.5 mm, 1.6 mm, 1.7 mm, 1.8 mm, 1.9 mm, 2 mm, 2.1 mm, 2.2 mm, 2.3 mm, 2.4 mm, 2.5 mm, 2.6 mm, 2.7 mm, 2.8 mm, 2.9 mm, 3 mm, 3.1 mm, 3.2 mm, 3.3 mm, 3.4 mm, 3.5 mm, 3.6 mm, 3.7 mm, 3.8 mm, 3.9 mm, 4 mm, 4.1 mm, 4.2 mm, 4.3 mm, 4.4 mm, 4.5 mm, 4.6 mm, 4.7 mm, 4.8 mm, 4.9 mm, 5 mm, 5.1 mm, 5.2 mm, 5.3 mm, 5.4 mm, 5.5 mm, or a number or a range between any two of these values in thickness (e.g., thickest part).

In some embodiments, the seal is, is about, is at least, is at least about, is at most, or is at most about, 5 mm, 6 mm, 7 mm, 8 mm, 9 mm, 10 mm, 11 mm, 12 mm, 13 mm, 14 mm, 15 mm, 16 mm, 17 mm, 18 mm, 19 mm, 20 mm, 21 mm, 22 mm, 23 mm, 24 mm, 25 mm, 26 mm, 27 mm, 28 mm, 29 mm, 30 mm, 31 mm, 32 mm, 33 mm, 34 mm, 35 mm, 36 mm, 37 mm, 38 mm, 39 mm, 40 mm, or a number or a range between any two of these values, in width. The seal can be, be about, be at least, be at least about, be at most, or be at most about, 5 mm, 6 mm, 7 mm, 8 mm, 9 mm, 10 mm, 11 mm, 12 mm, 13 mm, 14 mm, 15 mm, 16 mm, 17 mm, 18 mm, 19 mm, 20 mm, 21 mm, 22 mm, 23 mm, 24 mm, 25 mm, 26 mm, 27 mm, 28 mm, 29 mm, 30 mm, 31 mm, 32 mm, 33 mm, 34 mm, 35 mm, 36 mm, 37 mm, 38 mm, 39 mm, 40 mm, or a number or a range between any two of these values, in length. The seal can be, be about, be at least, be at least about, be at most, or be at most about, 1 mm, 1.1 mm, 1.2 mm, 1.3 mm, 1.4 mm, 1.5 mm, 1.6 mm, 1.7 mm, 1.8 mm, 1.9 mm, 2 mm, 2.1 mm, 2.2 mm, 2.3 mm, 2.4 mm, 2.5 mm, 2.6 mm, 2.7 mm, 2.8 mm, 2.9 mm, 3 mm, 3.1 mm, 3.2 mm, 3.3 mm, 3.4 mm, 3.5 mm, 3.6 mm, 3.7 mm, 3.8 mm, 3.9 mm, 4 mm, 4.1 mm, 4.2 mm, 4.3 mm, 4.4 mm, 4.5 mm, 4.6 mm, 4.7 mm, 4.8 mm, 4.9 mm, 5 mm, or a number or a range between any two of these values, in thickness.

In some embodiments, the hinge is, is about, is at least, is at least about, is at most, or is at most about, 5 mm, 6 mm, 7 mm, 8 mm, 9 mm, 10 mm, 11 mm, 12 mm, 13 mm, 14 mm, 15 mm, 16 mm, 17 mm, 18 mm, 19 mm, 20 mm, 21 mm, 22 mm, 23 mm, 24 mm, 25 mm, 26 mm, 27 mm, 28 mm, 29 mm, 30 mm, 31 mm, 32 mm, 33 mm, 34 mm, 35 mm, 36 mm, 37 mm, 38 mm, 39 mm, 40 mm, or a number or a range between any two of these values, in width. The hinge can be, be about, be at least, be at least about, be at most, or be at most about, 1 mm, 1.1 mm, 1.2 mm, 1.3 mm, 1.4 mm, 1.5 mm, 1.6 mm, 1.7 mm, 1.8 mm, 1.9 mm, 2 mm, 2.1 mm, 2.2 mm, 2.3 mm, 2.4 mm, 2.5 mm, 2.6 mm, 2.7 mm, 2.8 mm, 2.9 mm, 3 mm, 3.1 mm, 3.2 mm, 3.3 mm, 3.4 mm, 3.5 mm, 3.6 mm, 3.7 mm, 3.8 mm, 3.9 mm, 4 mm, 4.1 mm, 4.2 mm, 4.3 mm, 4.4 mm, 4.5 mm, 4.6 mm, 4.7 mm, 4.8 mm, 4.9 mm, 5 mm, or a number or a range between any two of these values, in length, The hinge can be, be about, be at least, be at least about, be at most, or be at most about, *, or a number or a range between any two of these values, 0.2 mm, 0.3 mm, 0.4 mm, 0.5 mm, 0.6 mm, 0.7 mm, 0.8 mm, 0.9 mm, 1 mm, or a number or a range between any two of these values, in thickness (e.g., thickest part).

In some embodiments, the tip inserted into the latch is, is about, is at least, is at least about, is at most, or is at most about, 5 mm, 6 mm, 7 mm, 8 mm, 9 mm, 10 mm, 11 mm, 12 mm, 13 mm, 14 mm, 15 mm, 16 mm, 17 mm, 18 mm, 19 mm, 20 mm, 21 mm, 22 mm, 23 mm, 24 mm, 25 mm, 26 mm, 27 mm, 28 mm, 29 mm, 30 mm, 31 mm, 32 mm, 33 mm, 34 mm, 35 mm, 36 mm, 37 mm, 38 mm, 39 mm, 40 mm, or a number or a range between any two of these values, in width. The tip inserted into the latch can be, be about, be at least, be at least about, be at most, or be at most about, 0.5 mm, 0.6 mm, 0.7 mm, 0.8 mm, 0.9 mm, 1 mm, 1.1 mm, 1.2 mm, 1.3 mm, 1.4 mm, 1.5 mm, 1.6 mm, 1.7 mm, 1.8 mm, 1.9 mm, 2 mm, 3 mm, 4 mm, 5 mm, or a number or a range between any two of these values, in length.

In some embodiments, the latch is, is about, is at least, is at least about, is at most, or is at most about, 5 mm, 6 mm, 7 mm, 8 mm, 9 mm, 10 mm, 11 mm, 12 mm, 13 mm, 14 mm, 15 mm, 16 mm, 17 mm, 18 mm, 19 mm, 20 mm, 21 mm, 22 mm, 23 mm, 24 mm, 25 mm, 26 mm, 27 mm, 28 mm, 29 mm, 30 mm, 31 mm, 32 mm, 33 mm, 34 mm, 35 mm, 36 mm, 37 mm, 38 mm, 39 mm, 40 mm, or a number or a range between any two of these values, in width. The latch can be, be about, be at least, be at least about, be at most, or be at most about, 2.5 mm, 3 mm, 3.5 mm, 4 mm, 4.5 mm, 5 mm, 5.5 mm, 6 mm, 6.5 mm, 7 mm, 7.5 mm, 8 mm, 8.5 mm, 9 mm, 9.5 mm, 10 mm, or a number or a range between any two of these values, in length.

In some embodiments, the nest is, is about, is at least, is at least about, is at most, or is at most about, 2.5 mm, 3 mm, 3.5 mm, 4 mm, 4.5 mm, 5 mm, 5.5 mm, 6 mm, 6.5 mm, 7 mm, 7.5 mm, 8 mm, 8.5 mm, 9 mm, 9.5 mm, 10 mm, or a number or a range between any two of these values, in diameter (or radius). The nest can be, be about, be at least, be at least about, be at most, or be at most about, 2.5 mm, 3 mm, 3.5 mm, 4 mm, 4.5 mm, 5 mm, 5.5 mm, 6 mm, 6.5 mm, 7 mm, 7.5 mm, 8 mm, 8.5 mm, 9 mm, 9.5 mm, 10 mm, 10.5 mm, 11 mm, 11.5 mm, 12 mm, or a number or a range between any two of these values, in depth.

In some embodiments, the offset (from a center of one loading port and a line formed by two electrodes) is, is about, is at least, is at least about, is at most, or is at most about, 1 mm, 1.1 mm, 1.2 mm, 1.3 mm, 1.4 mm, 1.5 mm, 1.6 mm, 1.7 mm, 1.8 mm, 1.9 mm, 2 mm, 2.1 mm, 2.2 mm, 2.3 mm, 2.4 mm, 2.5 mm, 2.6 mm, 2.7 mm, 2.8 mm, 2.9 mm, 3 mm, 3.1 mm, 3.2 mm, 3.3 mm, 3.4 mm, 3.5 mm, 3.6 mm, 3.7 mm, 3.8 mm, 3.9 mm, 4 mm, 4.1 mm, 4.2 mm, 4.3 mm, 4.4 mm, 4.5 mm, 4.6 mm, 4.7 mm, 4.8 mm, 4.9 mm, 5 mm, or a number or a range between any two of these values. Two loading ports can be separated from each other by, by about, by at least, by at least about, by at most, or by at most about, 4 mm, 4.5 mm, 5 mm, 5.5 mm, 6 mm, 6.5 mm, 7 mm, 7.5 mm, 8 mm, 8.5 mm, 9 mm, 9.5 mm, 10 mm, 10.5 mm, 11 mm, 11.5 mm, 12 mm, 12.5 mm, 13 mm, 13.5 mm, 14 mm, 14.5 mm, 15 mm, or a number or a range between any two of these values.

In some embodiments, the groove is, is about, is at least, is at least about, is at most, or is at most about, 3 mm, 3.5 mm, 4 mm, 4.5 mm, 5 mm, 5.5 mm, 6 mm, 6.5 mm, 7 mm, 7.5 mm, 8 mm, 8.5 mm, 9 mm, 9.5 mm, 10 mm, 10.5 mm, 11 mm, 11.5 mm, 12 mm, or a number or a range between any two of these values, in diameter (or radius). The fillet can be, be about, be at least, be at least about, be at most, or be at most about, 1 mm, 1.5 mm, 2 mm, 2.5 mm, 3 mm, 3.5 mm, 4 mm, 4.5 mm, 5 mm, 5.5 mm, 6 mm, 6.5 mm, 7 mm, 7.5 mm, 8 mm, 8.5 mm, 9 mm, or a number or a range between any two of these values, in diameter (or radius) In some embodiments, two electrodes are separated from each other by, by about, by at least, by at least about, by at most, or by at most about, 10 mm, 10.5 mm, 11 mm, 11.5 mm, 12 mm, 12.5 mm, 13 mm, 13.5 mm, 14 mm, 14.5 mm, 15 mm, 15.5 mm, 16 mm, 16.5 mm, 17 mm, 17.5 mm, 18 mm, 18.5 mm, 19 mm, 19.5 mm, 20 mm, 20.5 mm, 21 mm, 21.5 mm, 22 mm, 22.5 mm, 23 mm, 23.5 mm, 24 mm, 24.5 mm, 25 mm, 25.5 mm, 26 mm, 26.5 mm, 27 mm, 27.5 mm, 28 mm, 28.5 mm, 29 mm, 29.5 mm, 30 mm, or a number or a range between any two of these values.

In some embodiments, the chip is, is about, is at least, is at least about, is at most, or is at most about, 10 mm, 11 mm, 12 mm, 13 mm, 14 mm, 15 mm, 16 mm, 17 mm, 18 mm, 19 mm, 20 mm, 21 mm, 22 mm, 23 mm, 24 mm, 25 mm, 26 mm, 27 mm, 28 mm, 29 mm, 30 mm, 31 mm, 32 mm, 33 mm, 34 mm, 35 mm, 36 mm, 37 mm, 38 mm, 39 mm, 40 mm, 41 mm, 42 mm, 43 mm, 44 mm, 45 mm, 46 mm, 47 mm, 48 mm, 49 mm, 50 mm, or a number or a range between any two of these values, in width. The chip can be, be about, be at least, be at least about, be at most, or be at most about, 5 mm, 5.5 mm, 6 mm, 6.5 mm, 7 mm, 7.5 mm, 8 mm, 8.5 mm, 9 mm, 9.5 mm, 10 mm, 10.5 mm, 11 mm, 11.5 mm, 12 mm, 12.5 mm, 13 mm, 13.5 mm, 14 mm, 14.5 mm, 15 mm, 15.5 mm, 16 mm, 16.5 mm, 17 mm, 17.5 mm, 18 mm, 18.5 mm, 19 mm, 19.5 mm, 20 mm, 20.5 mm, 21 mm, 21.5 mm, 22 mm, 22.5 mm, 23 mm, 23.5 mm, 24 mm, 24.5 mm, 25 mm, or a number or a range between any two of these values, in length.

In some embodiments, the opening to which the chip is inserted or glued to is, is about, is at least, is at least about, is at most, or is at most about, 10 mm, 11 mm, 12 mm, 13 mm, 14 mm, 15 mm, 16 mm, 17 mm, 18 mm, 19 mm, 20 mm, 21 mm, 22 mm, 23 mm, 24 mm, 25 mm, 26 mm, 27 mm, 28 mm, 29 mm, 30 mm, 31 mm, 32 mm, 33 mm, 34 mm, 35 mm, 36 mm, 37 mm, 38 mm, 39 mm, 40 mm, 41 mm, 42 mm, 43 mm, 44 mm, 45 mm, 46 mm, 47 mm, 48 mm, 49 mm, 50 mm, or a number or a range between any two of these values, in width. The opening to which the chip is inserted or glued to can be, be about, be at least, be at least about, be at most, or be at most about, 5 mm, 5.5 mm, 6 mm, 6.5 mm, 7 mm, 7.5 mm, 8 mm, 8.5 mm, 9 mm, 9.5 mm, 10 mm, 10.5 mm, 11 mm, 11.5 mm, 12 mm, 12.5 mm, 13 mm, 13.5 mm, 14 mm, 14.5 mm, 15 mm, 15.5 mm, 16 mm, 16.5 mm, 17 mm, 17.5 mm, 18 mm, 18.5 mm, 19 mm, 19.5 mm, 20 mm, 20.5 mm, 21 mm, 21.5 mm, 22 mm, 22.5 mm, 23 mm, 23.5 mm, 24 mm, 24.5 mm, 25 mm, or a number or a range between any two of these values, in length.

In some embodiments, an electrode is, is about, is at least, is at least about, is at most, or is at most about, 2 mm, 2.1 mm, 2.2 mm, 2.3 mm, 2.4 mm, 2.5 mm, 2.6 mm, 2.7 mm, 2.8 mm, 2.9 mm, 3 mm, 3.1 mm, 3.2 mm, 3.3 mm, 3.4 mm, 3.5 mm, 3.6 mm, 3.7 mm, 3.8 mm, 3.9 mm, 4 mm, 4.1 mm, 4.2 mm, 4.3 mm, 4.4 mm, 4.5 mm, 4.6 mm, 4.7 mm, 4.8 mm, 4.9 mm, 5 mm, 5.1 mm, 5.2 mm, 5.3 mm, 5.4 mm, 5.5 mm, 5.6 mm, 5.7 mm, 5.8 mm, 5.9 mm, 6 mm, 6.5 mm, 7 mm, 7.5 mm, 8 mm, 8.5 mm, 9 mm, 9.5 mm, 10 mm, or a number or a range between any two of these values, in length. An electrode can extrude into the flow cell by, by about, by at least, by at least about, by at most, or by at most about, 0.5 mm, 0.6 mm, 0.7 mm, 0.8 mm, 0.9 mm, 1 mm, 1.1 mm, 1.2 mm, 1.3 mm, 1.4 mm, 1.5 mm, 1.6 mm, 1.7 mm, 1.8 mm, 1.9 mm, 2 mm, 2.1 mm, 2.2 mm, 2.3 mm, 2.4 mm, 2.5 mm, 2.6 mm, 2.7 mm, 2.8 mm, 2.9 mm, 3 mm, 3.1 mm, 3.2 mm, 3.3 mm, 3.4 mm, 3.5 mm, 3.6 mm, 3.7 mm, 3.8 mm, 3.9 mm, 4 mm, 4.1 mm, 4.2 mm, 4.3 mm, 4.4 mm, 4.5 mm, or a number or a range between any two of these values.

Disclosed herein include methods for performing microscopy, such as fluorescent microscopy (e.g., optical genome mapping). In some embodiments, a method of performing for microscopy, such as fluorescent microscopy (e.g., optical genome mapping) comprises using a cartridge disclosed herein. Disclosed herein include methods for performing optical genome mapping. In some embodiments, a method of performing optical genome mapping comprises using a cartridge disclosed herein.

### Optical Genome Mapping

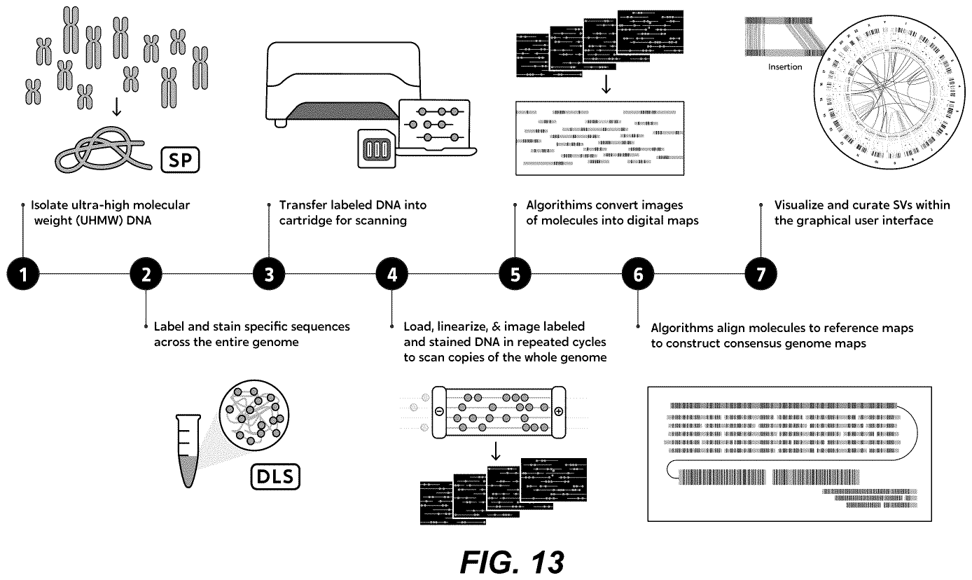

FIG. 13 illustrates a non-limiting exemplary workflow of optical genome mapping (OGM). The OGM workflow can start with mega-base size DNA isolation, e.g., 150 kbp or longer. A single enzymatic reaction can label the genome at a specific sequence motif occurring, e.g., approximately 15 times per 100 kbp in the human genome. The long, labeled DNA molecules can be linearized in nanochannel arrays (e.g., provided by a cartridge or chip, such as a cartridge described herein) and imaged in an automated manner by an OGM instrument (e.g., Saphyr® System and Stratys™ System, Bionano Genomics, Inc. (San Diego, CA)). The molecules can be assembled into local maps or whole genome maps. Changes in patterning or spacing of the labels can be detected, genome-wide, to call structural variants.

Optical Genome Mapping (OGM) is an imaging technology which evaluates the fluorescent labeling pattern of individual DNA molecules to perform an unbiased assessment of genome-wide structural variants down to, e.g., 500 base pairs (bp) in size, a resolution that far exceeds conventional cytogenetic approaches. OGM can rely on a specifically designed extraction protocol facilitating the isolation of high molecular weight (HMW) or ultra-high molecular weight (UHMW) DNA ultra-high molecular weight (UHMW) DNA. This protocol can, in some embodiments, utilize a paramagnetic disk purposed with trapping DNA for wash steps thereby reducing sheering forces present in standard column-based extraction methods. The result can be DNA fragments (or molecules) of about 150 kilobases (kbp) to megabases (Mbp) in size, about 5-10× longer than the average fragment size from conventional DNA isolations techniques. Referring to FIG. 13, DNA can be fluorescently labeled via covalent modification at a motif (which can be 4, 5, 6, 7, 8, 9, 10, or more nucleotides in length), such as a hexamer motif (e.g., the CTTAAG hexamer motif), generating genome-wide density of a number of labels per 100 kb in sequence specific patterns (e.g., approximately 14-17 labels per 100 kb, or 10, 11, 12, 13, 14, 15, 16, 17, 18, 19, 20, or more or fewer labels per 100 kb). Labeled DNA can be loaded on chips (e.g., silicon chips) composed of hundreds of thousands of parallel nanochannels where individual DNA molecules are linearized, imaged, and digitized. The specific labeling profile of individual DNA molecules, including spacing and pattern of hexamers labels, can be subsequently grouped based on similarity, producing about 500 kbp (or longer or shorter, such as 300 kbp, 400 kbp, 500 kbp, 600 kbp, 700 kbp, 800 kbp, 900 kbp, 1000 kbp) to megabase-sized consensus maps, which can be compared in silico to the expected labeling pattern of a reference genome (FIG. 13). This imaging technology converts DNA into a “barcode” whose labeling profile and characteristics can sensitively and specifically resolve copy number and structural variation without the need for sequence level data (FIG. 13). The quality of the DNA, including both size and labeling characteristics, as well as the number of images captured can influence genome-wide coverage. For example, each flow cell, which can accommodate a single specimen, can generate, for example, up to 5000 Gigabase pairs (Gbp) of raw data (or 3000 Gbp, 4000 Gbp, 5000 Gbp, 6000 Gbp, 7000 Gbp, 8000 Gbp, 9000 Gbp, 10000 Gbp, or more or less, of raw data), achieving a maximum theoretical genome-wide coverage of about 1250× (or 500×, 750×, 1000×, 1250×, 1500×, 1750×, 2000×, or more or less). Bioinformatics analyses can be performed. Example bioinformatics analysis can include: de novo structural variant analysis for typical germline assessments (e.g., greater than about 80×-coverage; requiring greater than about 400 Gbp data collection) or ‘Rare Variant Analysis (RVP)’ for somatic assessment down to a ~5% variant allele fraction (e.g., greater than about 340x coverage; requiring greater than about 1500 Gbp data). Both algorithms facilitate the detection of a wide array of structural variants; from copy number gains/losses to balanced/unbalanced translocations and insertions to inversions.

Optical genome mapping (OGM) can be used to analyze large eukaryotic genomes and their structural features at a high resolution. OGM uses linearized strands of high molecular weight (HMW) or ultra-high molecular weight (UHMW) DNA that are far longer than the DNA sequences analyzed in current second-and third-generation sequencing methods, achieving average read lengths in excess of 200 kbp. The usage of long molecules in OGM can allow repetitive regions and other regions that are complicated to map to be spanned more easily than with short molecules. This leads to the creation of maps that may cover the whole arm of a chromosome and yet allow the detection of insertions and deletions as small as 500 bp (or longer or shorter, such as 300 kbp, 400 kbp, 500 kbp, 600 kbp, 700 kbp, 800 kbp, 900 kbp, 1000 kbp) other SVs may need to be 30 kbp (or 10 kbp, 20 k kbp, 30 kbp, 40 kbp, or 50 kbp)) or larger to be detectable. OGM can be used to, for example, detect the breakpoints of chromosomal translocations, for the diagnosis of facioscapulohumeral muscular dystrophy (FSHD). OGM may be used as a cytogenomic tool for prenatal diagnostics

Extraction/Isolation. UHMW DNA can be extracted for OGM, for example. UHMW DNA extraction can be done using isolation kits, such as kits from Bionano Genomics, Inc. (San Diego, CA). In some embodiments, DNA from approximately 1.5×10⁶ cells (or 1×10⁵, 1.5×10⁵, 2.5×10⁵, 5×10⁵, 7.5×10⁵, 1×10⁶, 1.5×10⁶, 2.5×10⁶, 5×10⁶, 7.5×10⁶, 1×10⁷ or more or fewer cells) can be extracted. The extraction can include immobilizing cells in agarose plugs and lysing the immunized cells by proteinase K; thereafter. The extraction can include washing, recovering, and quantifying the genomic DNA. Alternatively or additionally, the genomic DNA can be bound to a magnetic disk. Subsequently, the DNA can be washed, recovered, and quantified.

Labeling and Processing. A sufficient quantity of UHMW DNA (e.g., 250 ng, 500 ng, 750 ng, 1000 ng, 1250 ng, 1500 ng, 1750 ng, 2000 ng, or more UHMW DNA) can be labeled with a fluorophore. Such labeling can be done using a methyltransferase, such as the methyltransferase direct labeling enzyme (DLE-1) at the recognition motif of the methyltransferase, such as CTTAAG. This can generate a number of labels per 100 kbp (e.g., approximately 14-15 labels per 100 kbp, or 10, 11, 12, 13, 14, 15, 16, 17, 18, 19, 20, or more or less labels per kbp) when labeling human genomic DNA. In some embodiments, such labeling can be done using another enzyme (e.g., an endonuclease) at the recognition motif of the enzyme (e.g., GCTCTTCN of endonuclease Nt.BspQI).

Thereafter, the DNA can be dialyzed, its backbone stained, and finally the prepared DNA can be applied to flow cells (e.g., G1.2 flow cells from Bionano Genomics, Inc.) The flow cell can then be inserted into an OGM instrument, such as the Saphyr® instrument and Stratys™ instrument from Bionano Genomics, Inc. In the instrument, the DNA can be fed by electrophoresis into the nanochannels of the flow cell for linearization. DNA-filled nanochannels can be scanned using, for example, a fluorescence microscope. The captured images can be converted to electronic representations of the DNA molecules. The virtual DNA strands can then filtered and de novo assembled into maps (FIG. 13).

OGM Data Assembly. The data acquired with the OGM instrument can be processed. For example, the raw data can be filtered for a minimum length of 150 kbp (or 100 kbp, 125 kbp, 150 kbp, 175 kbp, 200 kbp, or more) and minimum of nine labels (or 5, 6, 7, 8, 9, 10, 11, 12, 13, 14, 15, or more labels) per molecule (or fragment). The filtered molecules can be assembled, e.g., with de novo assembly. The consensus maps of the molecules can be aligned to a reference genome sequence, such as the human reference genome GRCh38. Variants can be detected. Variants detection can be performed using, for example, a SV pipeline, comparing the maps to the aligned reference genome. There, patterns of markers from the maps deviating from the reference become apparent. Variants detections can be performed using, for example, a CNV pipeline,” which quantifies the mapped molecules and hence is able to detect gains and losses of several hundred kbp in size.

The results of the SV pipeline can then be augmented by, for example, a variant annotation pipeline, which adds quality metrics for the called variants and supplies their estimated frequency in the human population based on an internal database. The optional step of filtering based on the frequency of the SVs in the internal database may (or may not) be used in some implementations. The SVs can be detected or called. Automatic calling can be based on the confidence scores and sizes of the SVs (insertions and deletions: confidence>0, size>500 bp; inversions: confidence>0.7, size>30 kbp; duplications: confidence=−1, size>30 kbp; intrachromosomal translocations: confidence>0.3; interchromosomal translocations: confidence>0.65; CNV confidence>0.99, size>500 kbp). Additionally, each called SV can be required to be spanned by >5 strands of DNA.

The total amount of unfiltered DNA scanned by the OGM system can be, or be about, 750 Gbp, 800 Gbp, 850 Gbp, 900 Gbp, 916 Gbp, 925 Gbp, 950 Gbp, 1000 Gbp, 1250 Gbp, or more, per sample on average. An effective coverage of the reference can be, or can be greater than, 40×, 50×, 60×, 70×, 80×, 90×, or more, per sample. The effective coverage of the reference can be defined as the total length of filtered (≥150 kbp) and aligned molecules divided by the length of the reference genome after de novo assembly Further details regarding various aspects of OGM can be found in U.S. Pat. Nos. 11,359,244; 11,292,713; 11,291,999; 10,995,364; 10,844,424; 10,676,352; 10,669,586; 10,654,715; 10,435,739; 10,247,700; 10,000,804; 10,000,803; 9,845,238; 9,809,855; 9,804,122; 9,725,315; 9,536,041; 9,533,879; 9,310,376; 9,181,578; 9,061,901; 8,722,327; and 8,628,919; as well as published PCT Application Publication Nos. WO2020/005846; WO2016/036647; WO2015/134785; WO2015/130696; WO2015/126840; WO2015/017801; WO2014/200926; WO2014/130589; WO2014/123822; WO2013/036860; WO2012/054735; WO2011/050147; WO2011/038327 and WO2010/13532; the content of each of which is incorporated herein by reference in its entirety.

### Additional Considerations

In at least some of the previously described embodiments, one or more elements used in an embodiment can interchangeably be used in another embodiment unless such a replacement is not technically feasible. It will be appreciated by those skilled in the art that various other omissions, additions and modifications may be made to the methods and structures described above without departing from the scope of the claimed subject matter. All such modifications and changes are intended to fall within the scope of the subject matter, as defined by the appended claims.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity. As used in this specification and the appended claims, the singular forms “a,” “an,” and “the” include plural references unless the context clearly dictates otherwise. Any reference to “or” herein is intended to encompass “and/or” unless otherwise stated.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, such as in terms of providing a written description, all ranges disclosed herein also encompass any and all possible sub-ranges and combinations of sub-ranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into sub-ranges as discussed above. Finally, as will be understood by one skilled in the art, a range includes each individual member. Thus, for example, a group having 1-3 articles refers to groups having 1, 2, or 3 articles. Similarly, a group having 1-5 articles refers to groups having 1, 2, 3, 4, or 5 articles, and so forth.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A cartridge, comprising a hermetic seal capable of preventing evaporation of a liquid sample.

2. The cartridge of claim 1, wherein the liquid sample comprises a biological sample.

3. The cartridge of claim 2, wherein the biological sample comprises one or more analytes, optionally the analytes comprise nucleic acid, and further optionally the nucleic acid is DNA.

4. The cartridge of claim 3, wherein the DNA is high molecular weight DNA, and optionally the DNA is at least 1 Mb, 1.5 Mb, or 2 Mb in length.

5. The cartridge of any one of claims 1-4, wherein the prevention of evaporation can be at least or at least about 24 hours, 48 hours, 72 hours, 100 hours, 150 hours, 200 hours, 300hours, 400 hours, 500 hours, 600 hours, or more.

6. The cartridge of any one of claims 1-5, wherein the cartridge comprises a polymer, a polycarbonate, a plastic, or a combination thereof.

7. The cartridge of any one of claims 1-6, comprising a flow cell and one or more electrodes fluidically connected with the flow cell.

8. The cartridge of claim 7, wherein the one or more electrodes comprise titanium and/or are titanium electrodes.

9. The cartridge of any one of claims 7-8, wherein the one or more electrodes are fluidically connected to the flow cell when the cartridge is in a closed configuration, wherein the one or more electrodes are fluidically connected to the flow cell when the cartridge is in an open configuration, wherein the one or more electrodes are fluidically connected to the flow cell when the cartridge is both in a closed configuration and an open configuration, and/or wherein the one or more electrodes are fluidically connected to the flow cell when the cartridge is in a closed configuration and not in an open configuration.

10. The cartridge of any one of claims 7-9, wherein the one or more electrodes prevent evaporation.

11. The cartridge of any one of claims 7-10, wherein the one or more electrodes allow the liquid sample to be loaded into the flow cell.

12. The cartridge of any one of claims 7-11, wherein the one or more electrodes comprise at least one hollow electrode.

13. The cartridge of any one of claims 7-12, wherein the one or more electrodes are hollow electrodes.

14. The cartridge of any one of claims 7-13, wherein the one or more electrodes are one or more loading ports for the liquid sample.

15. The cartridge of any one of claims 7-14, wherein the one or more electrodes are sealed off with a thermoplastic elastomer (TPE) seal to prevent evaporation when the cartridge is in a closed configuration.

16. The cartridge of any one of claims 7-9, wherein the one or more electrodes comprise at least one solid electrode.

17. The cartridge of claim 16, wherein the one or more electrodes are solid electrodes.

18. The cartridge of any one of claims 16-17, wherein the cartridge comprises one or more loading ports for the liquid sample.

19. The cartridge of claim 18, wherein the one or more loading are sealed off with a thermoplastic elastomer (TPE) seal to prevent evaporation when the cartridge is in a closed configuration.

20. The cartridge of any one of claims 7-19, wherein the one or more electrodes are insert molded.

21. The cartridge of any one of claims 1-20, wherein the hermetic seal is formed by contacting the electrodes, or the loading ports, and a thermoplastic elastomer (TPE) seal, and optionally the TPE seal is an overmolded seal.

22. A cartridge, comprising:
a caddy; and
a flow cell,
wherein the caddy comprises a base and a lid,
wherein the base comprises a central region, wherein the central region comprises one or more loading ports and one or more electrodes, wherein the one or more electrodes are fluidically connected to the flow cell when the cartridge is both in a closed configuration and an open configuration,
wherein the lid comprises a seal,
wherein the seal and the one or more loading ports form a hermetic seal when the caddy is in a closed configuration.

23. A cartridge, comprising:
a caddy comprising a base and a lid,
wherein the base comprises one or more loading ports and one or more electrodes,
wherein the lid comprises a seal,
wherein the seal and the one or more loading ports form a hermetic seal
when the cartridge is in a closed configuration; and
a flow cell.

24. The cartridge of claim 23, wherein the base comprises a central region comprising the one or more loading ports and the one or more electrodes.

25. The cartridge of any one of claims 22-24, wherein the lid is connected to the base.

26. The cartridge of any one of claims 22-25, wherein the lid comprises a hinged lid connected to the base.

27. The cartridge of any one of claims 22-26, wherein the one or more loading ports are for loading a liquid sample.

28. The cartridge of any one of claims 22-27, wherein the seal and the one or more loading ports form a hermetic seal, preventing evaporation of a liquid sample loaded into the flow cell, when the caddy is in a closed configuration.

29. The cartridge of any one of claims 27-28, wherein the liquid sample comprises a biological sample.

30. The cartridge of claim 29, wherein the biological sample comprises one or more analytes, optionally the analytes comprise nucleic acid, and further optionally the nucleic acid is DNA.

31. The cartridge of claim 30, wherein the DNA is high molecular weight DNA, and optionally the DNA is at least 1 Mb, 1.5 Mb, or 2 Mb in length.

32. The cartridge of any one of claims 22-31, wherein the prevention of evaporation can be at least or at least about 24 hours, 48 hours, 72 hours, 100 hours, 150 hours, 200 hours, 300 hours, 400 hours, 500 hours, 600 hours, or more.

33. The cartridge of any one of claims 22-32, wherein the base comprises two rounded edges, wherein the base comprises two angled edges, and/or wherein the two rounded edges are at a side of the base closer to the lid when the cartridge is in an open configuration.

34. The cartridge of any one of claims 22-33, wherein the base comprises a polymer, a polycarbonate, a plastic, or a combination thereof.

35. The cartridge of any one of claims 22-34, wherein the base other than the central region is not clear and/or not see through.

36. The cartridge of any one of claims 22-35, wherein the base other than the central region is made in a first shot, and wherein the central region is made in a second shot.

37. The cartridge of any one of claims 22-36, wherein the caddy comprises a polymer, a polycarbonate, a plastic, or a combination thereof.

38. The cartridge of any one of claims 22-37, wherein the caddy other than the central region and the seal is not clear and/or not see through.

39. The cartridge of any one of claims 22-38, wherein the base other than the central region and the seal is made in a first shot, and wherein the central region is made in a second shot.

40. The cartridge of any one of claims 22-39, wherein the central region comprises a polymer, a polycarbonate, a plastic, or a combination thereof.

41. The cartridge of any one of claims 22-40, wherein the central region is clear and/or see through.

42. The cartridge of any one of claims 22-41, wherein the central region comprises a groove corresponding to each of the one or more loading ports on a top surface of the central region, wherein the central region comprises a fillet corresponding to each of the one or more loading ports on a bottom surface of the central region.

43. The cartridge of any one of claims 22-42, wherein the one or more loading ports comprise two loading ports.

44. The cartridge of any one of claims 22-43, wherein the two loading ports are identical in size and geometry.

45. The cartridge of any one of claims 22-44, wherein a center of one of the one or more loading ports is on a line formed by the two of the one or more electrodes.

46. The cartridge of any one of claims 22-45, wherein a center of one of the one or more loading ports is not on or has an offset from a line formed by the two of the one or more electrodes.

47. The cartridge of any one of claims 22-46, wherein the one or more loading ports are sample funnels.

48. The cartridge of any one of claims 22-47, wherein the one or more loading ports each has a size and a geometry to accept a pipette tip.

49. The cartridge of any one of claims 22-48, wherein the one or more loading ports comprise an inlet port and an outlet port.

50. The cartridge of any one of claims 22-49, wherein the one or more loading ports extrude over a top surface of the central region, optionally wherein the one or more loading ports extrude over a top surface of the central region by 0.3 mm.

51. The cartridge of any one of claims 22-50, wherein the flow cell is formed by the base and a chip, optionally wherein the chip is inserted into to an opening at a bottom face of the base, optionally wherein the chip is glued to the base.

52. The cartridge of any one of claims 22-51, wherein the base comprises a chip orientation key on a bottom surface of the base.

53. The cartridge of any one of claims 22-52, wherein the one or more electrodes comprise two electrodes.

54. The cartridge of any one of claims 22-53, wherein the one or more electrodes comprise one or more pins.

55. The cartridge of any one of claims 22-54, wherein the one or more electrodes do not extrude from a top surface of the central region.

56. The cartridge of any one of claims 22-55, wherein the one or more electrodes comprise titanium and/or are titanium electrodes.

57. The cartridge of any one of claims 22-56, wherein the one or more electrodes are insert molded.

58. The cartridge of any one of claims 22-57, wherein the one or more electrodes are fluidically connected to the flow cell when the cartridge is in a closed configuration, wherein the one or more electrodes are fluidically connected to the flow cell when the cartridge is in an open configuration, wherein the one or more electrodes are fluidically connected to the flow cell when the cartridge is both in a closed configuration and an open configuration, and/or wherein the one or more electrodes are fluidically connected to the flow cell when the cartridge is in a closed configuration and not in an open configuration.

59. The cartridge of any one of claims 22-58, wherein the one or more electrodes prevent evaporation.

60. The cartridge of any one of claims 22-59, wherein the one or more electrodes allow the liquid sample to be loaded into the flow cell.

61. The cartridge of any one of claims 22-60, wherein the one or more electrodes comprise at least one hollow electrode.

62. The cartridge of any one of claims 22-61, wherein the one or more electrodes are hollow electrodes.

63. The cartridge of any one of claims 22-62, wherein the one or more electrodes are the one or more loading ports.

64. The cartridge of any one of claims 22-59, wherein the one or more electrodes comprise at least one solid electrode.

65. The cartridge of any one of claims 22-59, wherein the one or more electrodes are solid electrodes.

66. The cartridge of any one of claims 22-65, wherein the seal comprises a thermoplastic elastomer (TPE) seal.

67. The cartridge of any one of claims 22-66, wherein the seal is overmolded.

68. The cartridge of any one of claims 22-67, wherein the seal is oval in shape, wherein the seal is rectangular in shape with rounded edges, and/or wherein the seal has a tab.

69. The cartridge of any one of claims 22-68, wherein the base, the lid, the seal, and the electrodes are one piece.

70. The cartridge of any one of claims 22-69, wherein the lid comprises one or more electrical connections for contacting the one or more electrodes, optionally wherein the one or more electrical connections extrude from a top surface of the lid, optionally wherein the one or more electrical connections do not extrude from a top surface of the lid, optionally wherein the one or more electrical connections are not exposed at a top surface of the lid, optionally wherein the one or more electrical connections comprise one or more pins.

71. The cartridge of claim 70, wherein when the cartridge is in an open configuration, the one or more electrical connections are not in contact with the corresponding one or more electrodes, and wherein when the cartridge is in a closed configuration, the one or more electrical connections are in contact with the corresponding one or more electrodes.

72. The cartridge of any one of claims 70-71, wherein when the cartridge is in both an open configuration and a closed configuration, the one or more electrical connections are in contact with the corresponding one or more electrodes.

73. The cartridge of any one of claims 70-72, wherein the one or more electrical connections is each in contact with a wire, optionally wherein the wire is on or in the lid, optionally wherein the wire is U-shaped.

74. The cartridge of any one of claims 70-73, wherein the cartridge comprises one or more wires in contact with the one or more electrodes at a bottom surface of the base.

75. The cartridge of any one of claims 22-69, wherein the cartridge comprises one or more wires in contact with the one or more electrodes, optionally wherein each wire is in contact with a top of the corresponding electrode.

76. The cartridge of claim 75, wherein each wire is U-shaped, optionally wherein a side of the U-shaped wire is in contact with the corresponding electrode, optionally wherein a side of the U-shaped wire is for contacting an electrical source, optionally wherein the other side of the U-shaped wire is for contacting an electrical source at a notch of the base, optionally wherein the base comprises a U-shaped crevice for embedding the U-shaped wire.

77. The cartridge of any one of claims 75-76, wherein the one or more wires comprise stainless steel and/or are stainless steel wires.

78. The cartridge of any one of claims 22-77, wherein the base comprises one or more notches corresponding to the one or more wires, optionally wherein the one or more notches comprise V-notches, optionally wherein each of the one or more notches is at a different side of the base, optionally wherein each of two of the one or more notches are on the opposite sides of the base, optionally wherein the one or more wires are exposed at the corresponding one or more notches, optionally wherein the one or more wires are contactable at the corresponding one or more notches.

79. The cartridge of any one of claims 22-78, wherein the base comprises a latch and a release button, wherein when the cartridge is in a closed configuration, a tip of the lid is inserted into the latch to secure the lid to the base to form the hermetic seal, and/or wherein when the cartridge is in a closed configuration, a tip of the lid is released from the latch when the release button is depressed.

80. The cartridge of any one of claims 22-79, wherein the lid comprises one or more extrusions, optionally wherein the one or more extrusions is half-moon shaped, optionally when the cartridge is in a closed configuration, each of the one or more extrusions is in contact with a wire to maintain contact of the wire with the base.

81. The cartridge of any one of claims 22-80, wherein the base comprises at least three nests, optionally wherein the nests comprise circular nests, optionally wherein each of the three nests comprises at least one extruding retainer.

82. The cartridge of claim 81, wherein the cartridge comprises a metal ball inserted into each of the nest.

83. The cartridge of any one of claims 22-82, wherein the base comprises a label on a top surface of the base, optionally wherein the label covers the at least three nests.

84. The cartridge of any one of claims 22-83, wherein the base is about 55 mm in width, wherein the base is about 55 mm in length, wherein the base is about 6 mm in thickness, wherein the lid is about 20 mm in width, wherein the lid is about 35 mm in length, wherein the lid is about 3 mm in thickness, wherein the seal is about 15 mm in width, wherein the seal is about 11 mm in length, wherein the seal is about 2 mm in thickness, wherein the hinge is about 15 mm in width, wherein the hinge is about 2 mm in length, wherein the hinge is about 0.5 mm in thickness, wherein the tip inserted into the latch is about 10 mm in width, wherein the tip inserted into the latch is about 1 mm in length, wherein the latch is about 10 mm in width, wherein the latch is about 5 mm in length, wherein the nest is about 6 mm in diameter, wherein the nest is about 6 mm in depth, wherein the offset is about 2 mm, wherein two of the one or more loading ports are separated from each other by about 7 mm, wherein the groove is about 6 mm in diameter, wherein the fillet is about 3 mm in diameter, wherein two of the one or more electrodes are separated from each other by about 17 mm, wherein the chip is about 25 mm in width, wherein the chip is about 13 mm in length, wherein the opening to which the chip is inserted or glued to is about 25 mm in width, wherein the opening to which the chip is inserted or glued to is about 13 mm in length, wherein the one or more electrodes is each 4 mm in length, and/or wherein the one or more electrodes each extrudes into the flow cell by about 1 mm.

85. A method of performing optical genome mapping using a cartridge of any one of claims 1-84.
